(19) United States
(12) Patent Application Publication
(10) Pub. No.: US 2004/0075822 A1
(43) Pub. Date: Apr. 22, 2004

(54) Exposure apparatus and its making method, substrate carrying method, device manufacturing method and device

(75) Inventor: Ken Hattori, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Nikon Corporation, Chiyoda-ku (JP)

(21) Appl. No.: 10/683,236

(22) Filed: Oct. 14, 2003

Related U.S. Application Data
(63) Continuation of application No. 09/720,810, filed on Jan. 3, 2001, now abandoned.
Application No. 09/720,810 is a 371 of international application No. PCT/JP99/03565, filed on Jul. 2, 1999.

(30) Foreign Application Priority Data
Jul. 3, 1998 (JP) 10-204444
Oct. 6, 1998 (JP) 10-283172

(51) Int. Cl. G03B 27/58

(52) U.S. Cl. 355/72; 396/611; 355/53; 355/27

(57) ABSTRACT

The apparatus comprises a substrate stage (WST) to mount a substrate (W) and a substrate carriage system (100) to carry a substrate to the substrate stage. The substrate carriage system includes a rotation table (42) that holds and moves the substrate in the X direction and a control system that detects the positional deviation of the substrate W rotating together with the rotation table (42) by using sensors (48) while moving in the X direction. Since the detection of the positional deviation of the substrate overlaps with the time the substrate is being carried, it improves the throughput, as well as improves the space efficiency since exclusive space for detection of the positional deviation is not required. Accordingly, this can reduce the manufacturing cost of devices such as semiconductor devices.

### TECHNICAL FIELD

The present invention relates to an exposure apparatus and its making method, a substrate carrying method, a device manufacturing method and a device. More particularly, the present invention relates to an exposure apparatus comprising a substrate carriage system and the method of making the apparatus, a substrate carriage method using the substrate carriage system, a device manufacturing method using the exposure apparatus and a device manufactured by the device manufacturing method.

### BACKGROUND ART

In the lithographic process to manufacture devices such as semiconductors, exposure apparatus such as a so-called stepper or a so-called scanning stepper is used. With these types of exposure apparatus, in order to transfer a pattern formed on a reticle as a mask onto one lot of wafers, the wafers need to be loaded onto, or unloaded from the wafer stage, therefore, a wafer carriage system serving as a substrate carriage system is arranged.

FIG. 34 shows a schematic plan sectional view of the conventional exposure apparatus 300, focusing mainly on the wafer carriage system. The exposure apparatus 300 can be inline connected and suitably used with a coater developer (Coater/Developer: hereinafter referred to as “C/D”, as appropriate) not shown in Figs. In FIG. 34, the portion other than the air conditioning system and the wafer stage WST of the main body of the exposure apparatus is omitted.

This exposure apparatus 300 comprises a first chamber 202 and a second chamber 204, arranged alongside in the Y direction. Within the first chamber 202 most of the wafer carriage system is housed. Meanwhile, in the second chamber 204, the main body of the exposure apparatus (portions other than the wafer stage WST is omitted in FIG. 34) that transfers the pattern formed on the reticle not shown in the drawing onto the wafer W mounted on the wafer stage WST is housed.

The wafer carriage system comprises an X guide 206 extending in the X direction (the left and right direction in FIG. 34), and a Y guide 208 located above the X guide (near the surface of FIG. 34 in the depth of field) and extending in the Y direction, serving as carriage guides. The Y guide 208 is arranged in a state where it penetrates the first chamber 202 and the second chamber 204. Also, within the first chamber 202, on both sides of the X direction in on the −Y side of the X guide 206, carrier mounts 210A and 210B are arranged. On these carrier mounts 210A and 210B, open carriers (Open Carrier: hereinafter abbreviated as “OC” as appropriate) capable of housing a plurality of slices of wafers, 212A and 212B, are respectively arranged.

On the X guide 206, a horizontal jointed arm robot (a scalar robot) 214 that moves along the X guide 206 and is driven by a driving unit not shown in the drawing is arranged. Also, on the Y guide, a wafer load arm 216 and a wafer unload arm 218 that move along the Y guide and are driven by a driving unit not shown in the drawing are arranged.

In addition, on the end of the −Y direction on the −X side of the Y guide 208 within the first chamber 202, a turntable (rotary table) 220 capable of being finely driven in the XY two-dimensional direction is arranged. And at a position that is predetermined distance apart in the −Y direction from this turntable 220, a wafer edge sensor 222 is arranged.

Although it is omitted in the drawing, the wafer stage WST moves two-dimensionally in the XY direction on the supporting bed held by vibration isolation pads, and the pattern formed on the reticle is transferred onto the wafer W held by the wafer stage WST.

Also, on the −X side outside the first chamber 202, an inline interface portion with the C/D (not shown in Fig.) (hereinafter abbreviated as inline I/F portion) is arranged.

The operation sequence of the exposure apparatus 300 in FIG. 34 is next described. As a premise, the wafer having completed the resist coating process by the C/D (not shown in Fig.) is passed from the robot arm on the C/D side (also not shown in Fig.) to the robot arm on the inline I/F side (also not shown in Fig.). The wafer is then to be handed over to the inline delivering portion by this robot arm.

First, the horizontal jointed arm robot 214 moves along to the left end portion of the X guide 206, reaches out its arm toward the inline delivering portion through the opening in the chamber 202, and receives the wafer W from the inline delivering portion. The arm of the robot 214 then carries the wafer W to the position referred to as W20 in FIG. 34. This carriage is performed, with the arm of the robot 214 rotating and extending (and in some cases, moving vertically).

The horizontal jointed arm robot 214, next moves along the X guide 206 to the right until it is located facing the turntable 220. Then, the arm reaches out and carries the wafer W to the position referred to as W21. And, at this position, the wafer W is delivered onto the turntable 220 by the arm of the robot 214. This delivery is performed, by lowering the arm of the robot 214 or by lifting up the turntable 220.

After the delivery, the turntable 200 is rotatably driven by a driving system not shown in the drawing, and thus the wafer W held by the turntable 220 is rotated. During the rotation of the wafer W, the wafer edge sensor 222 detects the wafer edge. And in accordance with the detection signals, the controller (not shown in Fig.) obtains information on the direction of the notch of the wafer W and the eccentricity (direction and amount) between the center of the wafer W and the center of the turntable 220. The main controller then rotates the turntable 220 to set the notch portion of the wafer in a predetermined direction. It also finely drives the turntable 220 in the X direction and the Y direction, in accordance with the X direction component and Y direction component of the eccentricity between the center of the wafer W and the center of the turntable 220. By this operation, corrections are made on the direction of the notch of the wafer W and its central position.

At this stage, the load arm 216 is at the predetermined wafer receiving position, and by the correction on the central position made above, the center of the wafer W coincides with the center of the load arm at the wafer receiving position. As for the Y direction component of the eccentricity between the center of the wafer W, it may be corrected at the standstill position of the load arm 216.

The load arm 216 then receives the wafer W from the turntable 220, moves along the Y guide 208, and carries the wafer W so that it is positioned above the wafer stage WST, which is waiting at a predetermined loading position. The wafer W is then loaded onto the wafer stage WST, and then exposure is performed on the wafer W.

When exposure is completed, the unload arm 218 carries the wafer W which has been exposed so that it comes to a position above the X guide 206, where the arm of the robot 214 is waiting. The wafer W, is then handed over to the arm of the robot 214, and is finally delivered to the inline delivering portion by the arm of the robot 214.

In addition, with the exposure apparatus, the strokes of the arm of the robot 214 in the Z direction were strokes of an extent that covered the delivery of the wafer between the turntable 220, and the like. And when the arm of the robot 214 had access to the wafer within the OC 212A or 212B, the carrier mount 210A or 210B moved vertically, so as to adjust the height of the wafer to be accessed to the height of the arm of the robot 214.

As described above, with the conventional exposure apparatus, when making an inline connection with the C/D, the inline I/F portion had to be independently arranged in between the exposure apparatus and the C/D. Therefore, space for the inline I/F portion had to be secured in the clean room where the exposure apparatus was set, increasing the equipment cost of the clean room.

Also, with the conventional exposure apparatus, the overall positioning of the wafer was performed on the turntable 220 that can be finely driven in the XY two-dimensional direction. So, time for overall positioning was necessary, in addition to carriage time of the wafer. Furthermore, space was necessary solely for the overall positioning; therefore, the utility efficiency (space efficiency) of the space within the chamber 202 was not sufficient enough.

In short, with the conventional exposure apparatus, there were a lot of problems to be improved, such as the time required in the wafer carriage process, space efficiency within the chamber and the clean room. Therefore, the emergence of a new technology to improve the time required in the wafer carriage process, space efficiency was awaited.

Also, as described earlier, with the conventional exposure apparatus, the access to the wafer inside the OC was possible due to the vertical movement of the carrier mount. This was because in order to have access to the wafer, the robot 214 or the vertical mechanism of the arm integral with the robot 214 needed to move along the X guide. And if the vertical mechanism were to be incorporated in the robot arm side, th vertical strokes necessary for access from the topmost wafer to the bottom wafer had to be at least 240 mm, which is a long stroke. This also results in the vertical mechanism being large, therefore the vertical mechanism were incorporated on the carrier mount side instead of the robot arm side with the conventional exposure apparatus.

With the exposure apparatus handling the 12 inch size wafer, other than by the inline connection with the C/D and the open carrier, the wafer can be housed and carried by an open/close type container called a Front Opening Unified Pod (hereinafter referred to as “FOUP” as appropriate). In the case the exposure apparatus employs the FOUP, however, in order to maintain the degree of cleanliness inside the FOUP (to prevent dust from entering) when opening the door of the FOUP, the FOUP needs to be pushed against the external wall of the first chamber 202. Therefore, the mount where the FOUP is placed cannot be vertically moved; each time access to the wafer is made.

Also, when the FOUP was employed, a robot arm for wafer access and open/close mechanism for the front door of the FOUP, and the like needed to be arranged. As a consequence, this led to a larger size compared with when employing the OC since the front side of the first chamber 202 further extended toward the front of the apparatus.

Furthermore, with the conventional exposure apparatus, when delivering the wafer during the carriage process, the OC arranged was set at a height near the delivering height of the wafer to the wafer stage WST. By this arrangement, the vertical moving distance of the robot arm or the turntable and the like was shortened, thus the wafer carriage time reduced. The height of the wafer stage WST above the floor was around 600 mm since the total height needed to be maintained as low as possible, and the delivering height of the wafer from the robot arm to the turntable was also set around 600 mm above the floor. The height around 600 mm was permissible since the size of conventional wafers were mainly 8 inches and under. However, due to the fact that the majority of wafers will be 12 inches in size, this height may not be the most appropriate height to arrange the OC or the FOUP. That is, with wafers having the 12-inch size, the height around 900 mm above the floor is necessary due to restrictions from the human engineering point of view. Therefore, when access to the wafer inside the OC is to be made with the robot arm so that the carriage system is in common with the apparatus employing the FOUP, since the accessing height of the topmost wafer in the OC is around 1170 (900+270) mm above the floor and the wafer delivering height to the turntable is around 600 mm above the floor, the strokes of the robot arm in the Z direction becomes extremely large, resulting in 570 mm. This increases the size of the driving mechanism in the Z direction, as well as require more space in the vertical movement of the robot arm, and in addition to the inconvenience reduces the throughput due to increasing wafer carriage time.

Also, other than the operation of delivering the wafer by the inline connection with the C/D, a so-called stand-alone operation in which the exposure apparatus is separated from the wafer processing unit such as the C/D is available. In this case, a container mount to place the carriage container where the wafer is housed and carried by lot is arranged within the chamber. And the wafer is delivered between the container placed on the container mount and the wafer stage by the wafer carriage system.

In the case of the stand-alone operation described above, an open type container such as the OC was conventionally used as the carriage container. With recent exposure apparatus handling wafers of the 12-inch size, however, the trend is to use the open/close type container such as the FOUP to house and carry the wafers before and after exposure, in order to house the wafers in a cleaner environment.

In the case of employing the FOUP as the carriage container, however, it is difficult to use the conventional structure of the exposure apparatus with the OC without any modification. Following are the reasons.

Since the clean room where the exposure apparatus is arranged is very costly in general, it is preferable to keep the floor area small. Therefore, it is required to effectively arrange as much units of exposure apparatus as possible within the limited space. Meanwhile, when considering the workability of the worker and the system efficiency of the AGV (Automatic Guided Vehicle) due to the automation of the clean room, the path is most preferably arranged on the side of the front surface of the exposure apparatus. So, in this case, the best layout would be to arrange the exposure apparatus on both sides of the path, and facing one another with the path in between. To employ such a layout and also improve the space efficiency of the clean room as much as possible, the depth of the exposure apparatus needs to be maintained as small as possible when considering the fact that the size of the exposure apparatus increases with the improvement in performance.

However, in the case of the exposure apparatus employing the FOUP, due to the nature of the FOUP, the open/close unit of the door needs to be arranged at the position facing the container mount. As a consequence, the open/close unit and the robot which loads/unloads the wafers housed in the FOUP need to be arranged in a direction in the depth of the apparatus. And the front side of the chamber is thus further extended compared with when employing the OC, which results in a larger size. Therefore, it would be difficult to satisfy the requirements described above, of employing the best layout and at the same time improve the space efficiency of the clean room.

Also, simply adding the open/close operation of the door of the FOUP to the wafer carriage sequence of the conventional exposure apparatus employing the OC leads to a decrease in throughput. This is because the open/close operation of the door of the FOUP and the operation to access the wafer by the robot arm are out of sequence. And, in making access to any wafer housed in the FOUP, in order to ensure that accidents such as the robot arm coming into contact with the door of the FOUP do not occur, and to suppress the decrease in throughput due to the open/close operation of the door, it is preferable for the door of the FOUP to be fully opened, so that the robot arm begins access to the wafer with the interior of the FOUP fully exposed. For these reasons, it is not so easy as it seems to add the opening operation and the closing operation of the door of the FOUP to the wafer carriage sequence of the conventional exposure apparatus.

As is described above, with the conventional exposure apparatus, many problems such as the time required in the wafer carriage process, space efficiency within the chamber and the clean room, which consequently led to the increase in the manufacturing cost when manufacturing a device such as a semiconductor, needed to be solved.

The present invention was made under such circumstances, and has as its first object to provide an exposure apparatus, the method of making the apparatus, and a substrate carriage method, that contribute to reducing the manufacturing cost when manufacturing a device such as a semiconductor.

It is the second object of the present invention to provide a device manufacturing method that can manufacture a device such as a semiconductor at a lower cost and a device manufactured by this method.

### DISCLOSURE OF INVENTION

According to the first aspect of the present invention, there is provided a first exposure apparatus that is inline connected with a substrate processing unit (200), the exposure apparatus comprising in its interior a substrate delivering portion which performs delivery of a substrate between the substrate processing unit.

With this apparatus, since the apparatus comprises a substrate delivering portion which performs delivery of a substrate between the substrate processing unit in its interior, the inline interface portion which was arranged independently with the conventional apparatus, does not have to be arranged independently. Therefore, the space necessary to arrange the inline interface portion in the clean room can be reduced, which improves the space efficiency, and can reduces the equipment cost of the clean room, which in turn results in reducing the manufacturing cost to manufacture devices such as semiconductors.

With the first exposure apparatus according to the present invention, the substrate delivering portion can perform delivery of the substrate between a substrate carriage arm of the substrate processing unit. In such a case, the delivery of the substrate is performed between a substrate carriage arm arranged on the substrate processing unit side, therefore, compared with the conventional case of performing delivery via the inline interface portion, the number of delivery of the substrate can be reduced. Thus, dust being generated can be reduced, and the production cost can be further reduced due to the improvement in the yield of the device.

With the first exposure apparatus according to the present invention, the substrate delivering portion can include at least an inline interface load arm (30) which performs delivery of the substrate to be exposed between the substrate carriage arm. In such a case, the delivery of the substrate to be exposed between the carriage arm on the substrate processing unit side is performed with the inline interface load arm. And because the number of delivery is reduced, the dust that is generated can be reduced. In addition, the substrate delivering portion may further include an inline interface unload arm which performs delivery of the substrate having completed exposure between the substrate carriage arm. In such a case, the carriage sequence of the load side (receiving the substrate from the substrate processing unit) of the substrate prior to exposure and the carriage sequence of the unload side (returning the substrate to the substrate processing unit) of the substrate which has completed exposure can be performed independently. With this arrangement, such a situation can be avoided, where the following loading side carriage sequence cannot be executed due to the reason that the substrate which has completed exposure has not been collected by the substrate processing unit side.

With the first exposure apparatus according to the present invention, in the case the substrate delivering portion includes the inline interface load arm and the inline interface unload arm, the inline interface unload arm is preferably arranged almost directly below the inline interface load arm. In such a case, both arms are arranged vertically, in a structure one above the other, therefore, compared with the case of arranging both arms side by side, the arrangement space can be greatly saved, and the neighboring space can be efficiently used.

With the first exposure apparatus according to the present invention, in the case the exposure apparatus further comprises: a substrate stage (WST) on which a substrate subject to exposure is mounted; and a substrate carriage system (100) which carries the substrate in respect to the substrate stage, the substrate delivering portion can be arranged within a chamber (12) where a connecting portion of the substrate processing unit in the substrate carriage system is housed. In such a case, the inline interface portion, which was arranged independently with the conventional apparatus, does not have to be arranged independently. Therefore, the space necessary to arrange the inline interface portion in the clean room can be reduced, which improves the space efficiency, and can reduces the equipment cost of the clean room, which in turn results in reducing the manufacturing cost to manufacture devices such as semiconductors. In this case, the substrate delivering portion can be structured by a robot arranged in a cornered portion of the chamber on a side where the substrate processing unit is to be connected, and comprises an arm that rotates and extends/folds freely. In such a case, the arrangement of the substrate carriage system and the substrate delivering portion does not have to be modified, even if the substrate processing unit is connected at the front side of the chamber or on either side of the chamber. Also, in this case, if the inline interface portion were to be arranged, the arrangement of the substrate carriage system and the substrate delivering portion does not have to be modified, even if the inline interface portion is connected at the front side of the chamber or on either side of the chamber.

According to the second aspect of the present invention, there is provided a second exposure apparatus that is inline connected with a substrate processing unit (200), the exposure apparatus comprising: a substrate stage (WST) on which a substrate subject to exposure is mounted; a substrate carriage system (100) which carries the substrate in respect to the substrate stage; and a container mount arranged on an opposite side of the substrate processing unit in a chamber (12) where a connecting portion of the substrate processing unit to the substrate carriage system is housed, the container mount being a mount to place a substrate container which houses the substrate.

With this apparatus, a container mount is arranged on the opposite side of the substrate processing unit in the chamber where the connecting portion of the substrate processing unit in the substrate carriage system in housed. So by setting the length of the carriage course (carriage guide) of the substrate carriage system at an appropriate length, the space in front of the container mount can be used effectively, and can arrange a robot arm and the like in the space. The improvement in space efficiency within the chamber allows in all cases such as the inline connection with the substrate processing unit (for example, the C/D), the OC, and the FOUP, to share the arrangement of the substrate carriage system and the carriage sequence, without hardly increasing the footprint. Accordingly, with the present invention, it since the space efficiency within the chamber (improve the space efficiency within the clean room) is improved and the substrate carriage system and carriage sequence are shared, the equipment cost, such as the clean room and exposure apparatus cost, can be reduced. And as a consequence, the production cost to manufacture devices such as semiconductors can be reduced.

With the second exposure apparatus according to the present invention, in the case the substrate carriage system (100) includes a first carriage guide, that is, the carriage guide on the load side (18) which guides the substrate to be exposed respectively from the substrate processing unit (200) and the container placed on the container mount toward the substrate stage (WST), and a second carriage guide, that is, the carriage guide on the unload side (16) which guides the substrate having completed exposure respectively to the substrate processing unit and the container, an edge of the first carriage guide and the second carriage guide is preferably arranged on a side of the container mount, out of reach to the front area of the container mount. In such a case, when using a container without a cover such as an open carrier (OC) or a container with a cover such as a FOUP as the container to place on the container mount, in either cases, a robot arm and the like can be arranged in front of the container mount.

With the second exposure apparatus according to the present invention, the container mount may be a mount (22B) to place an open type container (24B), or alternatively, the container mount may be a mount (104) to place an open/close type container (106) which houses a plurality of substrates having a predetermined interval in a vertical direction, the open/close type container in which an opening is formed only in front comprising a cover (108) to open/close the opening. In the latter case, the container mount to place the open/close type container is arranged on the opposite side of the substrate processing unit in the chamber which houses the connecting portion of the substrate carriage system to the substrate processing unit. Therefore, an open/close mechanism can to open and close the front door of the open/close type container can be arranged in front of the container mount. Accordingly, it becomes possible to use the FOUP within the same space inside the chamber as in the case of using a container without a cover such as the open carrier.

With the second exposure apparatus according to the present invention, the exposure apparatus may further comprise a rotation unit that rotatably drives the container mount. In such a case, the container mount to place the substrate container can be rotatably driven by the rotation unit. So, the loading/unloading direction of the substrate container in respect to the container mount can be decided in accordance with the open space outside the chamber the clean room where the exposure apparatus is arranged, and also with the work efficiency of the loading/unloading of the substrate container. Accordingly, the space efficiency of the clean room and the work efficiency of loading/unloading the substrate container can both be improved at the same time. Also, in this case, the substrate processing system can be arranged on the front side or on the side of the chamber via the inline interface portion, or without going through the inline interface portion.

With the first and second exposure apparatus according to the present invention, the substrate processing unit may be a coater (a resist processing equipment) or a developer, however it is preferable for the substrate processing unit to be a coater developer. In such a case, a series of processing such as resist coating, exposure, and developing performed in a lithographic process with the exposure apparatus and the substrate processing unit can be performed efficiently in an environment where dust and the like is substantially shut out from the apparatus. Thus, the productivity can be improved, and as a result the production cost for manufacturing the device can be reduced.

According to the third aspect of the present invention, there is provided a third exposure apparatus that transfers a predetermined pattern onto a substrate, the exposure apparatus comprising: a substrate stage (WST) on which a substrate (W) subject to exposure is mounted; and a rotation table (42) which rotatably holds the substrate and moves in a predetermined direction, the rotation table making up a part of a substrate carriage system (100) which carries the substrate in respect to the substrate stage.

With this apparatus, the rotation table makes up a part of the substrate carriage system that carries the substrate in respect to the substrate stage, and rotatably holds the substrate and moves in a predetermined direction. This arrangement makes it possible to rotate the substrate while carrying the substrate by the rotation table. So, for example, by detecting the rotation error of the substrate in advance, it becomes possible to correct the rotational error of the substrate while the substrate is being carried toward the substrate stage. Accordingly, a part of the rotational positioning time of the substrate can overlap the substrate carriage time, which improves the throughput, resulting in an improvement in productivity and a reduction in production cost of manufacturing devices such as semiconductors.

In this case, the exposure apparatus may further comprise a positional deviation detection unit (48, 90) which detects a positional deviation of the substrate rotating on the rotation table (42) when moving in the predetermined direction. In such a case, positional deviation detection of the substrate can be performed during the carriage of the substrate; thus, the positional deviation detection time of the substrate can completely overlap the substrate carriage time, and can further increase the throughput. In addition, in this case, exclusive space to detect positional deviation for overall positioning is not necessary, and space efficiency is improved. Accordingly, due to the improvement in productivity and the reduction of the production equipment cost, a further reduction in production cost of manufacturing devices such as semiconductors can be achieved.

With the third exposure apparatus according to the present invention, the exposure apparatus can further comprise a peripheral exposure unit (51) which is integrally arranged movable in the predetermined direction with the rotation table, the peripheral exposure unit exposing a peripheral of the substrate rotating on the rotation table. In such a case, since the apparatus further comprises a peripheral exposure unit integrally arranged movable in the predetermined direction with the rotation table that exposes a peripheral of the substrate rotating on the rotation table, peripheral exposure on the substrate can be performed while the substrate is being carried. Therefore, the time required for peripheral exposure of the substrate can partially overlap the substrate carriage time, and can increase the throughput as well as reduce the dust generated by the resist coating coming off. Accordingly, due to the improvement of the productivity and yield, the production cost of manufacturing devices such as semiconductors can be reduced.

In this case, the peripheral exposure unit can perform peripheral exposure at a predetermined position on the substrate carriage path, however the peripheral exposure unit may expose the peripheral of the substrate rotating on the rotation table when moving in the predetermined direction.

With the third exposure apparatus according to the present invention, in the case of comprising the peripheral unit, the peripheral exposure unit may include a positional deviation detection function that detects a positional deviation of the substrate. In such a case, by adjusting the positional deviation of a substrate such as a wafer based on the result of the positional deviation detection, the whole circumference of the wafer can be exposed in almost the same width with the peripheral unit.

With the third exposure apparatus according to the present invention, the substrate carriage system (100) may further comprise a position correction system, which corrects the positional deviation of the substrate detected while the substrate is being carried. In such a case, since the positional deviation of the substrate is corrected with he position correction system while the substrate is being carried, a decrease in throughput due to the correction can be avoided.

In this case, the substrate carriage system (100) may comprise a substrate carriage arm (50) which receives the substrate from the rotation table (42) and moves in a direction perpendicular to a moving direction of the rotation table, the moving direction being the predetermined direction, and the position correction system may correct the positional deviation of the substrate in a two dimensional direction, by correcting a position of the rotation table and by correcting a position of the substrate carriage arm. In addition, in this case, the position correction system may correct the positional deviation of the substrate in a rotational direction by rotating the rotation table.

According to the fourth aspect of the present invention, there is provided a fourth exposure apparatus comprising: a substrate stage (WST) on which a substrate (W) subject to exposure is mounted; a substrate carriage system (100) which carries the substrate in respect to the substrate stage; a container mount ((22A, 22B) or 104) on which a container ((24A, 24B) or 106) housing the substrate is placed; and a driving unit ((90, 94) or (90, 114)) which drives the container mount downward from a first position to a second position prior to starting an exposure process on the substrate housed in the container.

With this apparatus, the driving unit drives the container mount downward from the first position to the second position prior to starting the exposure process on the substrates housed in the container. So the height of the first position is set at an appropriate height for placing the container on the container mount, for example, in the case of a 12 inch sized wafer, the height is set around 900 mm above the floor from the human engineering point of view. And the height of the second position is set at the height of the carriage path of the substrate carriage system, for example, around 600 mm above the floor, which is the arrangement height of the substrate stage. The substrate housed in the container is, carried by the substrate carriage system and exposure process performed after the container is lowered to the second position, therefore the movement stroke in the height direction of the substrate carriage member such as the substrate carriage arm having access to the substrate inside the wafer can be shortened. In addition, the lowering of the container mount from the first position to the second position is required only once, prior to starting the exposure process on the substrate housed in the container. Accordingly, even if the size of the substrate increases, the throughput of the substrate carriage can be improved. As a consequence, the productivity of devices such as semiconductor increases, and the production cost of the devices can be reduced.

In this case, it is preferable for the exposure apparatus to further comprise a carriage arm which moves in a vertical direction in respect to the container mount so as to make access to the substrate housed in the container after the container mount is lowered to the second position.

In addition, to detect the availability of substrates within the container without the throughput hardly reduced, the exposure apparatus may further comprise a substrate detection unit that detects the substrate housed within the container when the container mount is being lowered. In the case the sensor portion of this substrate detection unit is structured of photosensors, when the container is an open type container, both the transmittance type and reflection type is used. However, in the case the container is an open/close type container, the reflection type photosensors are used in general. In the case the open/close type container is made of a light transparent material, however, it is possible to use the transmittance type photosensors.

According to the fifth aspect of the present invention, there is provided a fifth exposure apparatus comprising: a substrate stage (WST) on which a substrate (W) subject to exposure is mounted; a container mount on which a container housing the substrate is placed; a substrate carriage system (100) which carries the substrate between the substrate stage and the container; and a substrate detection unit which relatively moves in respect to the container mount and detects the substrate housed within the container during a carriage sequence of the substrate by the substrate carriage system.

With this apparatus, the substrate detection unit detects the substrate housed within the container by moving relatively in respect to the container mount while the carriage sequence of the substrate is performed by the substrate carriage system. That is, the detection of the substrates housed within the container is performed in parallel with the carriage operation of the substrates housed in the container in respect to the substrate stage. Thus, the throughput can be improved compared with the case when the detection of the substrate is performed separately, without any relation with the carriage of the substrate. Consequently, the productivity can be improved, and the production cost of devices such as semiconductors can be reduced.

In this case, when the container is an open/close type container (106) in which an opening (108) is formed only in front and comprises a cover to open/close the opening, the substrate detection unit can detect the substrate housed in the container when the cover is moved to open the cover. In such a case, when the cover is moved to open the container, the substrate detection unit detects the substrate housed in the container. That is, The opening/closing of the cover and detection of the substrate is performed in parallel, therefore, compared with the case of detecting the substrate separately after the operation is completed the throughput can be improved.

With the fifth exposure apparatus according to the present invention, in the case the substrate carriage system (100) comprises a robot (32 or 92) which loads and unloads the substrate in respect to the container, the substrate detection unit may detect the substrate when the robot moves. In such a case, the substrate detection unit can easily detect the substrate when the robot makes access to the substrate in the container to unload the substrate, and the substrate detected can be unloaded from the container by the robot.

In this case, the container the open type container such as the open carrier may be used. Also, the container may be used which houses a plurality of the substrates having a predetermined interval in a vertical direction, the container being an open/close type container (106) in which an opening (108) is formed only in front and comprising a cover to open/close the opening. In the case of the open type container, both the transmittance type and the reflection type photosensors can be used, however, in the case of the open/close type container, it is preferable for the substrate detection unit to comprise a transmittance type photosensor that has access inside the container.

With the fifth exposure apparatus according to the present invention, the substrate detection unit may detect the availability of the substrate in each shelf of the container.

According to the sixth aspect of the present invention, there is provided a sixth exposure apparatus comprising: a substrate stage (WST) on which a substrate (W) subject to exposure is mounted; a substrate carriage system (100) which carries the substrate in respect to the substrate stage; a container mount (104) on which a container (106) housing the substrate is placed, the container being an open/close type container with an opening formed only in front and including a cover (108) to open/close the opening; and an open/close mechanism (112) which opens/closes the cover of the opening, the open/close mechanism being arranged in a chamber where at least a part of the carriage system is housed.

With this apparatus, the open/close mechanism is arranged in a chamber, where at least a part of the carriage system is housed, therefore, the degree of cleanliness within the container can be maintained upon the opening/closing of the container. In the case of using the open type container, the degree of cleanliness of the clean room, need to be set around class 1. Meanwhile, in the case of the open/close type (enclosed type) container, the degree of cleanliness of the clean room does not cause any serious problems even around class 100 to 1000. Accordingly, with the present invention, by reducing the equipment cost and the running cost of the clean room, as a result, the production cost of the devices such as semiconductors can be reduced. In this case, the container mount can be arranged within the chamber, and in such a case, the space required within the chamber can be almost the same as in the case of inline connection with the substrate processing unit and the case of the open type container. That is, an exposure apparatus can be structured to comply with the in line connection to the substrate processing unit and the open/close type container.

With the sixth exposure apparatus according to the present invention, a space to arrange the container which is to be mounted on the container mount, and a space where a mask on which a pattern to be transferred onto a substrate is formed is installed and housed, can be arranged at almost the same height. In such a case, it becomes possible to perform the arrangement of the container and the installation of the mask at the optimum position from the human engineering point of view.

In this case, the space to arrange the container and the space where the mask is installed and housed may be respectively arranged in an independent chamber. In this case, when the container is arranged on only one side of a container arranging space provided respectively on a left side and a right side within the chamber, an operation unit may be arranged on the remaining side of the container arranging space. In such a case, the space required within the chamber space does not have to be increased, and the operation unit can also be arranged at an optimum height from the human engineering point of view.

With the sixth exposure apparatus according to the present invention, the exposure apparatus can further comprise a rotation unit that rotatably drives the container mount. In such a case, the container mount to place the substrate container can be rotatably driven by the rotation unit. Therefore, the direction of the loading/unloading of the container can be decided by in consideration of the work efficiency when the container is loaded/unloaded. Accordingly, the work efficiency of loading/unloading the substrate container can be improved.

With the sixth exposure apparatus according to the present invention, the exposure apparatus may further comprise a driving mechanism that drives the container mount in a direction almost perpendicular to a surface where the container is placed. In such a case, the driving unit can drive the container mount in a direction almost perpendicular to the surface where the container is to be placed, therefore, the container placing position of the container mount can be set at an appropriate position to load/unload the container. Also, the delivering position of the substrate housed in the container which is different from the position to load/unload the container, can be set at a position appropriate to deliver the substrate, therefore, the container arrangement operation and the substrate delivery operation can both be performed efficiently. Thus, the throughput can be improved.

In this case, the exposure apparatus may further comprises a control unit which opens the cover of the container by the open/close mechanism after the container mount is moved by the driving mechanism, the container mount being moved after the container is placed on the container mount. Or, the exposure apparatus may further comprise a control unit which moves the container mount to an unloading position of the container by the driving mechanism after the open/close mechanism closes the cover of the container.

With the sixth exposure apparatus according to the present invention, a connecting portion between the substrate carriage system and the container where the open/close mechanism performs open/close operation of the cover may be arranged in the chamber at a position lower than a delivery position of the container placed on the container mount. In such a case, when the height for arranging the container at the container loading position is set at an appropriate height, for example, in the case of a 12 inch sized wafer, the height is set around 900 mm above the floor from the human engineering point of view, and when the height of connection portion is set at the height of the carriage path of the substrate carriage system, for example, around 600 mm above the floor, which is the arrangement height of the substrate stage, then the container arranging operation and the substrate delivery to the substrate carriage system can be performed at a height appropriate to each operation.

With the sixth exposure apparatus according to the present invention, the exposure apparatus can further comprise a substrate detection unit, which detects the substrate housed in the container when the open/close mechanism performs at least one of an opening operation and a closing operation. In such a case, when either the opening operation or the closing operation is performed, the substrate detection unit detects the substrate housed in the container. That is, the opening/closing of the cover and the detection of the substrate are performed in parallel, therefore it is possible to improve the throughput compared with the case when the detection is performed regardless of the opening/closing of the cover.

In this case, the substrate detection unit may be attached to the open/close mechanism.

With the sixth exposure apparatus according to the present invention, in the case the exposure apparatus comprises the substrate detection unit which detects the substrate housed in the container when the open/close mechanism performs at least one of an opening operation and a closing operation, when the substrate carriage system comprises a carriage unit which loads and unloads the substrate between the container, the substrate detection unit may be arranged on the carriage unit. In such a case, when the cover is opened or closed by the open/close mechanism while the substrate is loaded into the container or being unloaded from the container, detection of the substrate in the container becomes possible with the substrate detection unit. In other words, a total of three operations, that is, the open/close operation of the container, the loading/unloading operation of the substrate, and the detection operation of the substrate, can be performed in parallel.

With the sixth exposure apparatus according to the present invention, the exposure apparatus can further comprise a driving mechanism which moves the container mount on a surface almost parallel with a surface where the container is placed to connect a connection portion of the container and the container to the substrate carriage system arranged in the chamber. In such a case, when the container is placed on the container mount, the driving mechanism moves the container mount on a surface almost parallel with the surface where the container is placed so that the container is connected to the substrate carriage system arranged in the chamber by the connecting portion of the container.

According to the seventh aspect of the present invention, there is provided a seventh exposure apparatus comprising: a substrate stage on which a substrate subject to exposure is mounted; a substrate carriage system which carries the substrate in respect to the substrate stage; a chamber which houses at least a part of the substrate carriage system; wherein the chamber includes at least one of a side surface and an adjacent side surface where an opening is formed through which the substrate is delivered, and the substrate carriage system includes a carriage unit which is capable of using any of the side surface and the adjacent side surface where the opening is formed in the chamber.

With this apparatus, the substrate carriage system comprises a carriage unit which is capable of using any of the side surface and the adjacent side surface where the opening is formed in the chamber. Therefore, it becomes possible to connect a substrate processing unit such as the C/D to any of the side surface and the adjacent side surface, and in connecting the substrate processing unit to either side, the structure of the substrate carriage unit and the like does not have to be modified. That is, an exposure apparatus which is capable of complying to a front inline connection and a right/left inline connection, can be provided.

According to the eighth aspect of the present invention, there is provided an eighth exposure apparatus comprising: a substrate stage on which a substrate subject to exposure is mounted; a container mount on which a container housing the substrate is placed, the container being an open/close type container with an opening formed in front and a door to open/close the opening; a substrate carriage system which carries the substrate housed in the container in respect to the substrate stage; and the substrate carriage system includes an open/close unit which performs open/close operation of the door and a carriage arm which performs loading/unloading of the substrate to the container, wherein the carriage arm is arranged on the open/close unit.

With this apparatus, the carriage arm which is provided in the substrate carriage system performs loading/unloading of the substrate to the container (open/close type container), is arranged on the open/close unit which opens/closes the door of the container. Therefore, space can be saved compared with the open/close unit and carriage arm being separately arranged, and the size of the apparatus in the depth direction can be reduced.

In this case, the open close unit can include an open/close member which opens/closes the door and a driving mechanism which drives the open/close member and the carriage arm, the open close member being driven by the driving mechanism.

The driving mechanism may drive the open/close member and the carriage arm independently, or the driving mechanism may integrally drive the open/close member and the carriage arm. In the latter case, as a matter of course, the open/close member opens or closes the door partly in parallel with the loading/unloading operation of the substrate by the carriage arm, therefore, the time required to take the substrate out of the container or to put the substrate in the container can be reduced.

With the eighth exposure apparatus according to the present invention, the container may be a container that houses only one container, or the container may be a container that houses a plurality of the substrates by a predetermined interval. In the latter case, the driving mechanism can drive the open/close member in a direction moving toward or moving away from the container mount and in the direction of the substrates arranged in the container. The opening operation of the door is a combination of the movement of the door moving away from the container mount and the movement in one direction of the predetermined direction in which the substrates are arranged in the container. And the closing operation of the door is a combination of the movement of the door in the other direction of the predetermined direction in which the substrate are arranged in the container and the movement moving toward the container mount. Therefore, the open/close member can open and close the door without fail.

With the eighth exposure apparatus according to the present invention, in the case when the container is a container that houses a plurality of the substrates by a predetermined interval in a vertical direction, it is preferable for the driving mechanism to drive the open/close member and the carriage arm in a vertical direction. In such a case, the carriage arm can have access to the desirable wafer in the container while the open/close member opens or closes the door.

With the eighth exposure apparatus according to the present invention, the open/close unit may further comprise a substrate detection unit that detects the substrates in the container. In such a case, detection of the substrates in the container becomes possible while the door of the container is being opened or closed.

According to the ninth aspect of the present invention, there is provided a substrate carriage method which loads and unloads a desirable substrate with a carriage arm between an open/close type container housing a substrate in which an opening is formed, the open/close type container comprising a door to open/close the opening, wherein at least a part of an open/close operation of the door and a load/unload operation of the desirable substrate by the carriage arm is performed in parallel in the substrate carriage method.

In this description, the term “at least a part of an open/close operation of the door and a load/unload operation of the desirable substrate by the carriage arm is performed in parallel” describes either one of the following four cases: a. when the opening operation of the door and unloading of the desirable substrate by the carriage arm is at least partially in parallel, b. when the closing operation of the door and the unloading of the desirable substrate by the carriage arm is at least partially in parallel, c. when the opening operation of the door and loading of the desirable substrate by the carriage arm is at least partially in parallel, and d. when the closing operation of the door and the loading of the desirable substrate by the carriage arm is at least partially in parallel.

With this method, as is described above, the opening of the door or the closing of the door and the loading or unloading of the desirable substrate by the carriage arm is performed at least partially in parallel. Therefore, the time for the opening/closing operation of the door and the time for the loading/unloading of the substrate by the carriage arm partially overlap, so the time required to load/unload the substrate in respect to the open/close type container can be reduced, compared with performing the opening/closing operation of the door and the loading/unloading of the substrate separately.

With the substrate carriage method in the present invention, in the case a plurality of the substrates are housed in the container by a predetermined interval, the load/unload operation of the desirable substrate can be performed in a state where the door is opened to at least a position corresponding to the load/unload operation of the desirable substrate. In such a case, the time required until starting the loading or unloading can be reduced, compared with the case when the loading/unloading of the substrate in respect to the container is performed at all times after the container is fully opened. Also, the possibility of dust and small particles entering the container during the loading/unloading of the substrate can be reduced.

With the substrate carriage method in the present invention, in the case a plurality of the substrates are housed in the container by a predetermined interval in a vertical direction, it is preferable for the open/close operation of the door to be performed by moving the door in a vertical direction. In such a case, the carriage arm may be moved in a horizontal direction at a state where the door is opened to at least a position corresponding to the load/unload operation, when the load/unload operation of the desirable substrate is performed. In such a case, the time required until starting the loading or unloading can be reduced, compared with the case when the loading/unloading of the substrate in respect to the container is performed at all times after the container is fully opened. And, the possibility of dust and small particles entering the container during the loading/unloading of the substrate can be reduced.

According to the tenth aspect of the present invention, there is provided a method of making an exposure apparatus used in a lithographic process comprising steps of: providing a substrate stage (WST) on which a substrate (W) subject to exposure is mounted; and providing a substrate carriage system (100) which includes a rotation table rotatably holding the substrate and moves in a predetermined direction, the substrate carriage system carrying the substrate in respect to the substrate stage.

With this method, the third exposure apparatus according to the present invention can be made by mechanically, optically, and electrically combining and adjusting the optical system, the substrate stage, the substrate carriage system including the rotation table and various other components.

With the first method of making an exposure apparatus according to the present invention, the method of making an exposure apparatus may further comprise a step of providing a positional deviation detection unit which detects a positional deviation of the substrate rotating on the rotation table when moving in the predetermined direction.

According to the eleventh aspect of the present invention, there is provided a method of making an exposure apparatus used in a lithographic process comprising steps of: providing a substrate stage (WST) on which a substrate subject to exposure is mounted; providing a substrate carriage system (100) which carries the substrate in respect to the substrate stage; providing a container mount on which a container housing a plurality of the substrate by a predetermined interval in a vertical direction is placed; and providing a driving unit which drives the container mount downward from a first position to a second position prior to starting an exposure process on the substrate housed in the container.

With this method, the fourth exposure apparatus according to the present invention can be made by mechanically, optically, and electrically combining and adjusting the optical system, the substrate stage, the substrate carriage system, the container mount, the driving unit, and various other components.

With the second method of making an exposure apparatus according to the present invention, the method of making an exposure apparatus may further comprise a step of providing a carriage arm which moves in a vertical direction in respect to the container mount so as to make access to the substrate housed in the container after the container mount is lowered to the second position. Or, the method of making an exposure apparatus may further comprise a step of providing a substrate detection unit that detects the substrate housed within the container when the container is being lowered.

In addition, in a lithographic process, when exposure is performed by using said exposure apparatus, devices such as semiconductors can be produced with good productivity and a lower cost. Accordingly, from another aspect of the present invention, there is provided a device manufacturing method that uses the exposure apparatus of the present invention, and a device manufactured by employing the device manufacturing method.

### BRIEF DESCRIPTION OF THE DRAWINGS

FIG. 1 is a schematic view showing the sectional view (a planar sectional view) of an exposure apparatus according to the first embodiment, focusing on the substrate carriage system;

FIG. 2 is a side view showing a neighboring area of the inline I/F load arm along with the robot 32;

FIG. 3 is a side view showing a neighboring area of the load X-axis turntable;

FIG. 4 is a front view showing a neighboring area of the Y guide, in a state where the load Y-axis arm is holding a wafer and the unload Y-axis arm is holding another wafer;

FIG. 5 is a view showing the main body of the exposure apparatus housed in the second chamber 14 along with the control system;

FIG. 6 is a side view showing a neighboring area of the carrier mount;

FIG. 7 is a view that illustrates the relationship between the wafer holder and the unload Y-axis arm at the loading position when the wafer is unloaded;

FIG. 8 is a planar view of an area around the carrier mount that illustrates the wafer detection within the OC when the carrier mount is driven downward;

FIG. 9 is a view that illustrates a modification of the positional deviation detection unit that detects positional deviation of the wafer;

FIG. 10 is a view showing an arrangement of the sensors used in the first stage of pre-alignment of a square-shaped substrate;

FIG. 11 is a side view showing a neighboring area of the peripheral exposure unit;

FIG. 12 is a view that illustrates a modification of the chip in the wafer holder, stage delivery arm and the load Y-axis arm;

FIG. 13 is a view that illustrates a case where the direction in respect to the loading position differ between the starting position and the finishing position of the exposure sequence of the wafer stage WST;

FIG. 14 is a side view showing an area around the carrier mount and illustrates a different method of adjusting the height of the wafer to be accessed to the robot arm;

FIG. 15A is a side view showing an area around the carrier mount and illustrates a structure of the robot arm and the substrate detection sensor that move vertically in integral, with the transmittance type substrate detection sensor attached to the driving portion of the robot via a supporting mount;

FIG. 15B is a planar view showing the area around the carrier mount in FIG. 15A;

FIG. 16A and FIG. 16B, are views that respectively illustrate a modification of the I/F arm;

FIG. 17 is a schematic view showing the sectional view (a planar sectional view) of an exposure apparatus according to the second embodiment, focusing on the substrate carriage system;

FIG. 18 is a side view showing an area around the FOUP mount of the exposure apparatus in FIG. 17;

FIG. 19 is a planar view showing an area around the FOUP mount and illustrates the wafer detection when the front door of the FOUP is open;

FIG. 20 is a view showing the main space arrangement in the first chamber that make up the exposure apparatus of the second embodiment;

FIG. 21A is a side view showing an area around the FOUP mount and illustrates a structure of the robot arm and the substrate detection sensor that move vertically in integral, with the reflection type substrate detection sensor attached to the driving portion of the robot;

FIG. 21B is a planar view showing the area around the carrier mount in FIG. 21A;

FIG. 22A is a side view showing an area around the FOUP mount and illustrates a structure of the robot arm and the substrate detection sensor that move vertically in integral, with the transmittance type substrate detection sensor attached to the driving portion of the robot;

FIG. 22B is a planar view showing the area around the carrier mount in FIG. 22A;

FIG. 23 is a schematic view showing the sectional view (a planar sectional view) of an exposure apparatus that carries two FOUP mounts;

FIG. 24 is a planar view of an area around the carrier mount of an exposure apparatus according to the third embodiment;

FIG. 25 is a side view showing the area around the carrier mount in FIG. 24;

FIG. 26 is a planar view showing an area around the carrier mount of an exposure apparatus to which the carrier mount related to the third embodiment shown in FIG. 24 is applied, and make up a front inline lithographic system;

FIG. 27 is a view that illustrates the carrier mount in FIG. 26 rotated in an angle by 90 degrees;

FIG. 28A is a planar view showing an area around a robot serving as a substrate delivering portion of a left inline type exposure apparatus;

FIG. 28B is a planar view showing an area around a robot serving as a substrate delivering portion of a front inline type exposure apparatus;

FIG. 29 is a schematic view showing the sectional view (a planar sectional view) of an exposure apparatus according to the fourth embodiment, focusing on the substrate carriage system;

FIG. 30 is a side view showing an area around the FOUP mount in FIG. 29;

FIG. 31 is a planar view showing an area around the FOUP mount and illustrates the wafer detection within the FOUP in FIG. 30;

FIG. 32 is a flow chart that illustrates an embodiment of a device manufacturing method according to the present invention;

FIG. 33 is a flow chart showing the processing in step 404 in FIG. 32; and

FIG. 34 is a schematic view showing the sectional view (a planar sectional view) of a conventional exposure apparatus.

### BEST MODE FOR CARRYING OUT THE INVENTION

<<First Embodiment>>

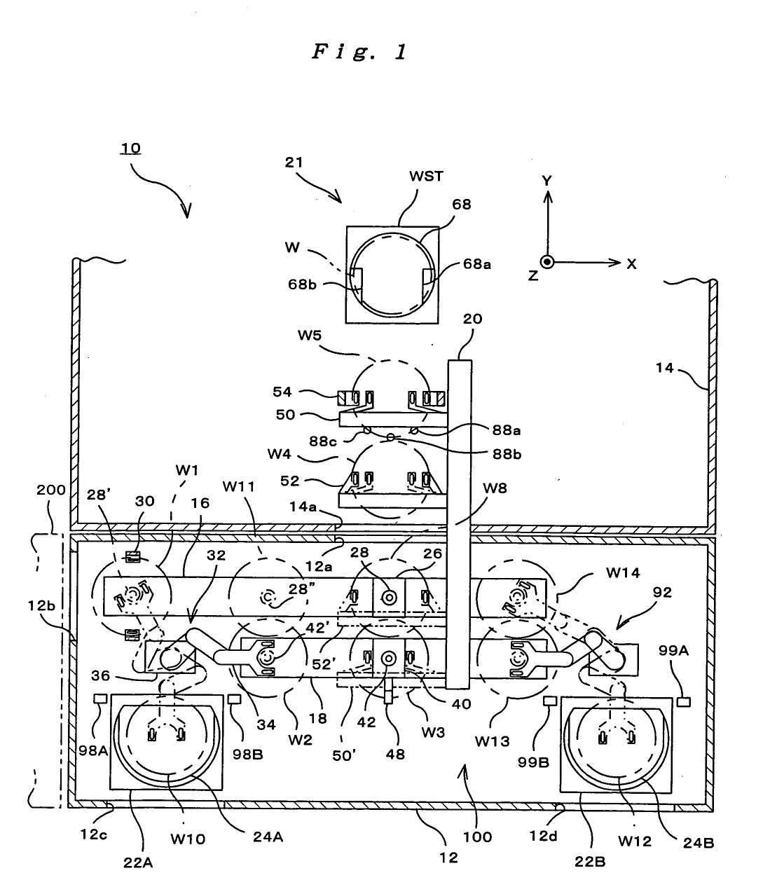

The first embodiment of the present invention will be described below with reference to FIGS. 1 to 8.

FIG. 1 schematically shows the sectional view (a planar sectional view) of an exposure apparatus 10 according to the first embodiment, focusing on the substrate carriage system. The exposure apparatus 10 can be suitably used inline connected with a coater developer (hereinafter referred to as “C/D”). And, in FIG. 1, the portion other than the air conditioning system and the wafer stage WST of the main body of the exposure apparatus is omitted.

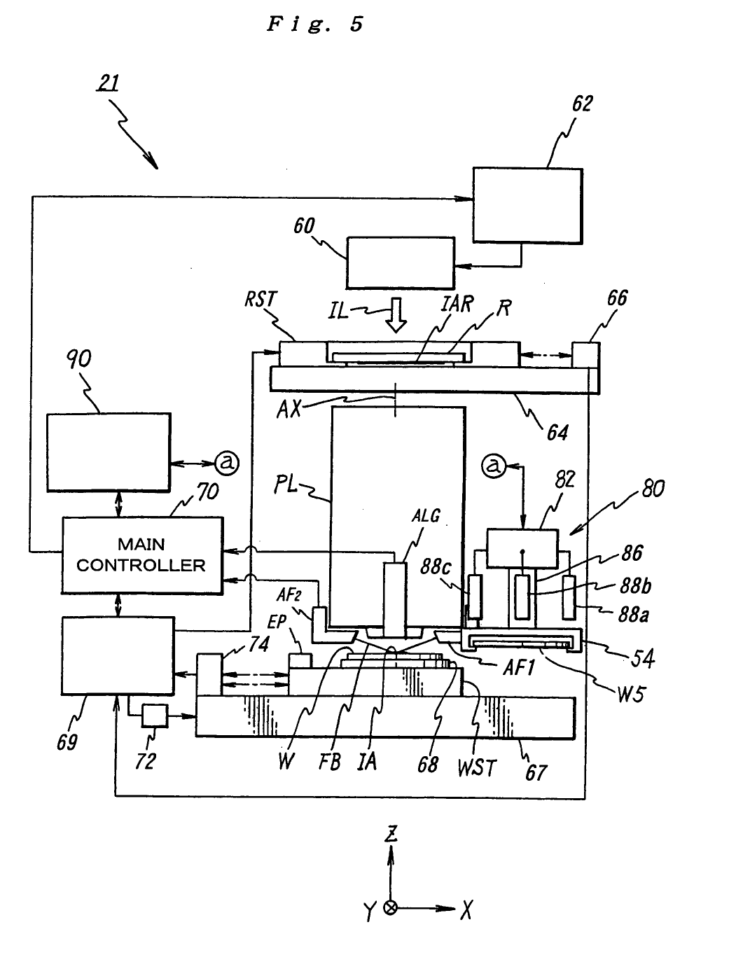

The exposure apparatus 10 comprises a first chamber 12 and a second chamber 14 arranged side by side in the Y direction (in the portrait direction in FIG. 1). Within the first chamber 12, most of the wafer carriage system 100 serving as a substrate carriage system is housed, and in the second chamber 14, the main body 21 of the exposure apparatus (refer to FIG. 5) is housed. The first chamber 12 and the second chamber 14 are arranged inside a clean room.

In actual, the first chamber 12 is a divided chamber, divided into an upper chamber and a lower chamber, and a major part of the wafer carriage system 100 is housed within the lower chamber. Details on exposure apparatus comprising such a divided chamber, are disclosed in, for example, Japanese Patent Laid Open No. 07-240366, and the corresponding U.S. application Ser. No. 08/955,427. As long as the national laws in designated states or elected states, to which this international application is applied, permit, the disclosures cited above are fully incorporated herein by reference.

In the area within the first chamber 12 close to the second chamber 14, the wafer carriage system 100 comprises a first X guide 16, a second X guide 18, and a Y guide 20, serving as carriage guides. The first X guide 16 and the second X guide 18 both extend in the X direction (the left and right direction in FIG. 1), and are arranged along the Y direction at a predetermined interval. The Y guide 20 is located above the X guide (near the surface of FIG. 1 in the depth of field) and extends in the Y direction. Within these guides, the first X guide 16 makes up the second carriage guide (carriage guide for unloading) and the second guide 18 makes up the first carriage guide (carriage guide for loading). The Y guide 20 passes through the opening 12a of the first chamber and the opening 14a of the second chamber, and extends from the side of the first chamber 12 to the side of the second chamber 14.

Also, within the first chamber 12, on both sides in the X direction on the side opposite to the second chamber 14 of the X guide 18, carrier mounts 22A and 22B are arranged, serving as container mounts. On these carrier mounts 22A and 22B, open carriers (hereinafter referred to as “OC”) 24A and 24B, capable of housing a plurality of slices of wafers, are respectively arranged.

The first X guide 16 extends from one side of the X direction (−X side) near the side wall of the first chamber 12 to a position slightly on the −X side than the edge surface of the carrier mount 22B on the −X side. Also, on the upper surface of the X guide 16, a slider 26 which is driven along the X guide 16 by a linear motor and the like (not shown in Fig.) is mounted. And on the upper surface of this slider 26, an unload X axis table 28 is fixed.

Also, above the slider 26 of the first X guide 16, that is, above the moving position of the unload X axis table 28 on the left hand side (see reference 28′ in FIG. 1), an inline interface load arm (hereinafter referred to as “inline I/F load arm”) 30 is arranged, which serves as a delivering portion of the wafer W between the carriage arm (load arm) of the C/D 200 serving as a substrate processing unit.

The second X guide 18 extends from a position slightly on the +X side than the edge surface on the +X side of the carrier mount 22A to a position the same as the first X guide 16. At the position on the −X side (the left-hand side in FIG. 1) of the second guide 18 and facing the carrier mount 22A, a horizontal jointed arm robot (a scalar robot) 32 is arranged.

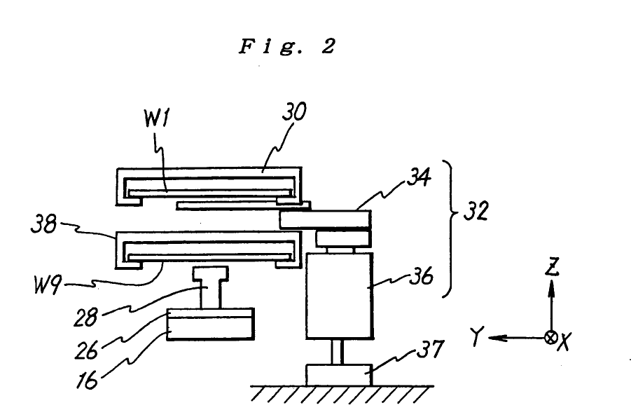

FIG. 2 is a side view (the left-hand side in FIG. 1) of the neighboring area of the horizontal jointed arm robot 32 and the inline I/F load arm 30. As is shown in FIG. 2, the horizontal jointed arm robot 32 (hereinafter referred to as “robot 32” as appropriate) comprises an arm 34 which can freely extend and rotate within the XY plane, and a driving portion 36 which drives the arm 34. And the robot 32 is driven in the vertical direction (Z direction) within a predetermined range by a vertical movement mechanism 37 arranged on the floor of the chamber 12.

Also, in this embodiment, as shown in FIG. 2, an inline interface unload arm (hereinafter referred to as “inline I/F unload arm”) 38, serving as a substrate delivering portion, is arranged directly below the inline I/F load arm 30. That is, the inline I/F load arm 30 and the inline I/F unload arm 38 are arranged in a positional relationship when in a planar view, they overlap each other.

Referring back to FIG. 1, on the upper surface of the second X guide 18, a slider 40 which is driven along the X guide 18 by a linear motor and the like (not shown in Fig.) is mounted. And on the upper surface of this slider 40, a load X-axis turntable 42 is arranged serving as a rotary table.

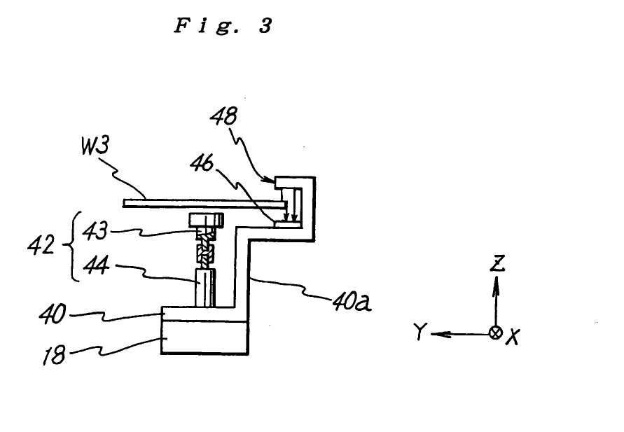

FIG. 3 is a side view (the left-hand side in FIG. 1) of the neighboring area of the load X-axis turntable 42. The load X-axis turntable 42 is fixed on the upper surface of the slider 40, made up of a substrate holding portion 43 which holds the wafer W (referred to as W3 in FIG. 3) as a substrate and a driving unit 44 which rotationally drives the substrate holding portion 43, as is shown in FIG. 3. On the edge in the −Y direction of the slider 40, an L-shaped extended portion 40a is arranged, which extends upward at a predetermined length and the upper end is bent in the −Y direction. And, in the upper portion of this L-shaped extended portion 40a, a wafer edge sensor 48 structured of a light-emitting element (not shown in Fig.) and a photodetection element (for example, a photodiode, a CCD line sensor, and the like) 46 is arranged. The wafer edge sensor 48 is used for the overall positioning of the wafer, which will be described later.

Referring back to FIG. 1, on the Y guide 20, a load Y-axis arm 50 and an unload Y-axis arm 52 are arranged, which serve as substrate carriage arms. These arms move along the Y guide 20, and are driven by the vertical/sliding mechanism (not shown in Fig.) including the movers of the linear motors.

The load Y-axis arm 50 is driven by the vertical/sliding mechanism (not shown in Fig.). It is movable from the edge of the Y guide 20 in the −Y direction around the position 50′ indicated by an imaginary line in FIG. 1, to the predetermined loading position (wafer delivering position) indicated by the solid line 50, and is also vertically movable within a predetermined range. In the neighboring area of the loading position, a stage delivery arm 54 that structures a pre-alignment unit is arranged. This pre-alignment unit will be referred to later in the description. Furthermore, the unload y-axis arm 52 is driven by the vertical/sliding mechanism (not shown in Fig.). It is movable from around the position 52′ indicated by an imaginary line in FIG. 1 to the position of the stage delivery arm 54 along a moving surface lower than that of the load Y-axis arm 50, and is also vertically movable within a predetermined range.

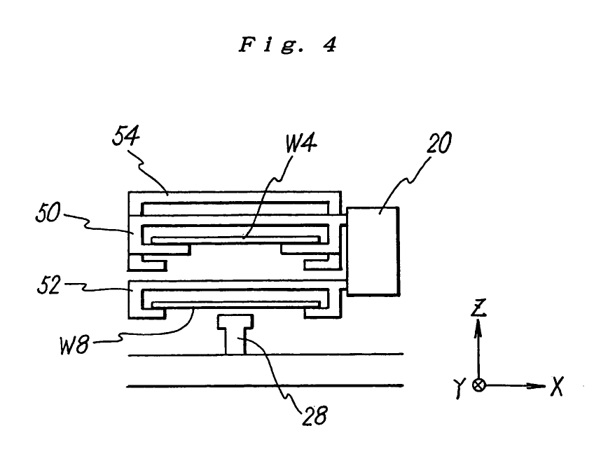

FIG. 4 is a front view of the neighboring area of the Y guide 20, in a state where the load Y-axis arm 50 holds a wafer (indicated as reference W4) and the unload Y-axis arm 52 holds a different wafer (indicated as reference W8). In the state shown in FIG. 4, the load X-axis turntable 42 has moved near to the movement position on the left side.

FIG. 5 shows the main body 21 of the exposure apparatus housed it the second chamber 14, with its control system. The main body 21 of the exposure apparatus transfers a pattern formed on the reticle R as a mask onto a wafer W as a substrate by the step-and-scan method.

The main body 21 of the exposure apparatus comprises: a light source including an illumination system 60; a reticle stage RST to hold the reticle R; a projection optical system PL; a wafer stage WST as a substrate stage on which the wafer W is mounted, and the like.

The illumination system 60 is structured of an exposure light source and an illumination optical system (both of them not shown in Fig.). The arrangement of the illumination optical system includes: a collimator lens; an illumination unifying optical system made up of an optical integrator such as a fly-eye lens or a rod integrator; a relay lend; a variable ND filter; a reticle blind; a relay lens, and the like. The illumination optical system illuminates the slit-shaped illumination area IAR on the reticle R with uniform illuminance by the illumination light IL. As the illumination light IL, for example, an excimer laser light such as a KrF excimer laser beam, an ArF excimer laser beam, and an F₂ laser beam (having a wavelength of 157 nm), a metal vapor laser beam or a harmonic of a YAG laser beam, an emission line (g line or i line) in the ultraviolet range emitted by an ultra-high pressure mercury lamp, and the like, is to be used. The respective driving portions within the illumination system, that is, components such as the variable ND filter and the reticle blind, are controlled by the illumination control unit (exposure controller) 62 in accordance with instructions from the main controller 70.

The reticle stage RST is arranged on a reticle base plate 64, and on the upper surface of reticle stage RST the reticle R is fixed by for example, vacuum chucking. The reticle stage RST, can be finely driven two dimensionally (in the X-axis direction, Y-axis direction being perpendicular to the X-axis direction, and the rotational direction around the Z-axis being orthogonal to the XY plane) within a plane perpendicular to the optical axis (the XY plane) of the illumination optical system (coinciding with the optical axis of the projection optical system PL which will be described later). It also can be driven in a predetermined scanning direction at a designated scanning velocity.

The position of the reticle stage RST is detected at all times with a reticle laser interferometer 66, at for example, a resolution of around 0.5 to 1 nm. The positional information on the reticle stage RST from the interferometer 66 is sent to the main controller 70 via the stage control unit 69. And the stage control unit 69 drives the reticle stage RST via the reticle stage driving portion (not shown in Fig.) based on the positional information of the reticle stage RST, in accordance with instructions from the main controller 70.

The projection optical system PL is arranged under the reticle stage RST as shown in FIG. 5, and the direction of the optical axis AX is to be the Z direction. This system is a reduction optical system, being double telecentric having a predetermined projection magnification, such as a reduction magnification of 1/5 (or 1/4). So when the illumination area IAR of the reticle R is illuminated by the illumination light IL from the illumination system 60, the illumination light IL having passed through the reticle R forms a reduced image (a partially inverted image) of the circuit pattern of the reticle R within the illumination area IAR via the projection optical system PL on the wafer W which is coated with a photoresist.

The wafer stage WST is arranged on the wafer base plate 67 which is arranged under the projection optical system as shown in FIG. 5, and on the wafer stage WST, a wafer holder 68 is mounted. On this wafer holder 68, the wafer W, which has a diameter of 12 inches, is fixed by vacuum chucking with a vacuum chuck (not shown in Fig.). The wafer holder 68 is driven by the driving portion (also not shown in Fig.) capable of being tilted in any direction in respect to the best imaging plane of the projection optical system. It also is capable of being finely driven in the direction of the optical axis AX (the Z direction) of the projection optical system. The wafer holder 68 is also capable of rotational motion around the Z-axis.

The wafer stage WST is driven two dimensionally, in the X-axis direction and in the Y-axis direction by a wafer driving unit 72 made up of a magnetic levitation two-dimensional linear actuator. That is, the wafer stage WST can move not only in the scanning direction (Y direction), but is also capable of moving in the non-scanning direction (X direction) which is perpendicular to the scanning direction. The wafer stage WST has this arrangement so that a plurality of shot areas on the wafer W can be positioned at an exposure area IA which is conjugate with the illumination area IAR. And, it repeats the step-and-scan motion, that is, performing scanning exposure on each shot area on the wafer wand then stepping to the starting position of scanning the next shot area for exposure.

The position of the wafer stage WST is detected at all times with a wafer laser interferometer 74, at for example, a resolution of around 0.5 to 1 nm. The measurement value of the interferometer 74 is sent to the main controller 70 via the stage control unit 69. And the stage control unit 69 drives the wafer stage WST via the wafer stage driving unit 72 based on the positional information of the wafer stage WST, in accordance with instructions from the main controller 70. In addition, on the wafer stage WST, a fiducial plate FP is arranged on which fiducial marks for baseline measurement and other reference marks are formed.

On scanning exposure, operations of each portion, such as the illumination system 60, the reticle stage RST, the wafer stage WST are controlled by the main controller 70 via units such as the illumination control unit 62 and the stage control unit 69.

Furthermore, as shown in FIG. 5, an alignment microscope ALG based on the off axis method is arranged on the side of the projection optical system PL in the main body 21 of the exposure apparatus. The alignment microscope ALG is used to detect the alignment mark (wafer mark) provided on each shot area on the wafer W and the measurement result is sent to the main controller 70.

Also, with the main body 21 of the exposure apparatus, a multiple focal position detection system AF based on an oblique incident light method, is fixed to a holding member (not shown in Fig.) supporting the projection optical system PL. The multiple focal position detection system AF is made up of an irradiation optical system AF₁ and a photodetection optical system AF₂. The irradiation optical system AF₁ supplies a light flux (detecting beam FB) to form a plurality of slit images from an incident direction in respect to the direction of the optical axis AX. And, the photodetection optical system, on the other hand, receives the light flux reflected on the surface of the wafer W respectively via slits. The positional information on the wafer from the multiple focal position detection system AF is sent to the stage control unit 69 via the main controller 70. The stage control unit 69 drives the wafer holder 68 in the Z direction and the tilt direction according to the positional information on the wafer. Details of a focus sensor similar to this multiple focal position detection system AF are disclosed in, for example, Japanese Patent Laid Open No. 06-283403 and the corresponding U.S. Pat. No. 5,448,332. As long as the national laws in designated states or elected states, to which this international application is applied, permit, the disclosures cited above are fully incorporated herein by reference.

In addition, as shown in FIG. 5, the exposure apparatus 10 in this embodiment comprises a pre-alignment unit 80 arranged at the loading position (wafer delivery point) referred to earlier. The pre-alignment unit 80 comprises: a pre-alignment main body 82; a vertical/rotation mechanism 86 arranged under the pre-alignment main body 82 which supports the stage delivery arm 54 and performs vertical and rotational motions; and three CCD cameras 88a, 88b, and 88c, arranged above the stage delivery arm 54. Inside the pre-alignment main body 82, control units including an image processing system to process image signals sent from the CCD cameras 88a, 88b, and 88c, and a control system for the vertical/rotation mechanism 86 are installed.

The CCD cameras 88a, 88b, and 88c, are respectively used to detect the rim of the wafer held by the stage delivery arm 54. The CCD cameras 88a, 88b, and 88c, as is shown in FIG. 1, are arranged at a position where they are capable of picking up the images of the wafer rim including the notch of the 12 inch wafer (indicated as wafer W5 in FIG. 1) held by the stage delivery arm 54. Of the CCD cameras, the CCD cameras 88b positioned in the center is used to detect the notch (a V-shaped chip).

The wafer loader control unit 90 shown in FIG. 5 controls the pre-alignment unit 80. The three CCD cameras 88a, 88b, and 88c of the pre-alignment unit 80 respectively detect the rim of the wafer W (outer shape), and information on the detection results is sent to the wafer loader control unit 90. The wafer loader control unit 90 then obtains the X, Y, and θ errors of the wafer W, and controls the vertical/rotation mechanism 86 so as to correct the θ error. Alternatively, the stage control unit 69 shown in FIG. 5, may control the pre-alignment unit 80 instead of the wafer loader control unit 90.

Information on the X, Y errors obtained during the outer shape measurement of the wafer by the pre-alignment unit 80, is sent to the main controller 70 via the wafer loader control unit 90. The main controller 70 then corrects the errors by adding an offset for the X, Y errors, for example, when performing search alignment operations on the wafer W.

On the upper surface of the wafer holder 68 (wafer mounting surface) which is on the wafer stage WST, as shown in FIG. 1 both edges in the X direction are chipped in a pair, at a predetermined depth. These chips 68a and 68b are extending in the Y direction so that the tip of the hooks of the stage delivery arm 54 and the unload Y-axis arm 52 can be inserted in the Y direction.

The main arrangement portions of the main body 21 of the exposure apparatus, such as the reticle base plate 64, wafer base plate 67, and the projection optical system PL, are held by the same main body frame. This main body frame is held horizontally via the vibration isolation pad (not shown in Fig.) which is arranged on the floor of the second chamber 14.

Furthermore, with the exposure apparatus 10 in this embodiment, as shown in FIG. 1, a horizontal jointed arm robot 92, which is identical to the horizontal jointed arm robot 32 described earlier, is arranged on the +X side of the second X guide 18 at a position facing the carrier mount 22B.

In the lower chamber of the first chamber 12 on the side wall in the −X direction, as shown in FIG. 1, an opening 12b is formed. Through this opening 12b, the wafer is carried into the lower chamber, as well as carried out of the lower chamber, and the C/D 200 serving as the substrate processing unit is inline connected via the opening 12b.

In addition, in the −Y direction in the lower chamber of the first chamber 12, on the side wall, openings 12c and 12D are formed at a position facing the carrier mount 22A and 22B in a planar view. These openings are for delivering the OC24A and 24B.

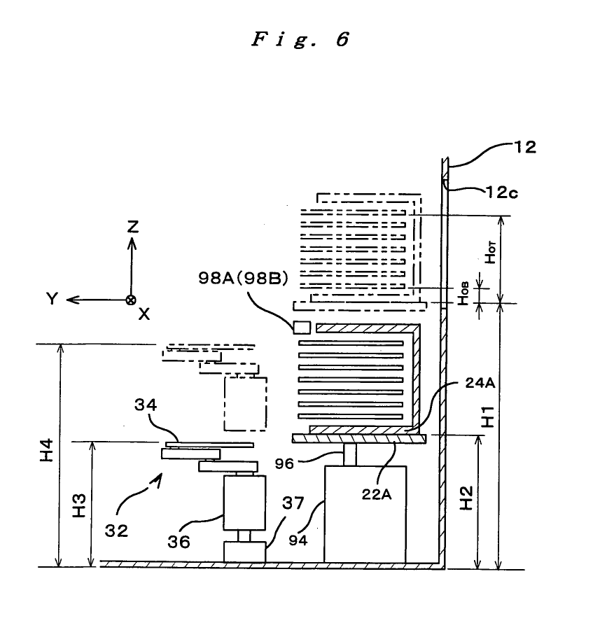

FIG. 6 is a side view of the neighboring area of the carrier mount 22A. As is shown in FIG. 6, the opening 12c of the chamber 12 is formed at a height H1 (H1 in this case is around 900 mm) from the floor up to the area around 1200 mm. The other opening 12d, is also formed around the same height as of the opening 12c.

Also, as is shown in FIG. 6, the carrier mount 22A is fixed on the upper surface of the driving shaft 96, which is vertically moved by a vertical movement mechanism 94 fixed on the floor of the chamber 12. And, close to the edge on the +Y side of the carrier mount 22A at a high position on both ends of the X direction, a light emitting element 98A and a photodetection element 98B are arranged facing each other as is shown in FIG. 1. The light emitting element 98A and the photodetection element 98B are arranged at a height slightly lower that that of the H1 above the floor. Similarly, on the close to the edge on the +Y side of the other carrier mount 22B, at the same height on both ends of the X direction, a light emitting element 99A and a photodetection element 99B are arranged facing each other.

Although it has been omitted in the description above, similar to the wafer holder 68, means for preventing the wafer W from moving during operations, such as a vacuum chuck or an electrostatic clamp, are respectively arranged on the respective arms and tables that hold and carry the wafer W.

The operations of the exposure apparatus 10 having the arrangement described above will be described next, focusing on the wafer carriage sequence. Reference will mainly be made to FIG. 1, and other drawings as appropriate.

First, the operation in the case of exchanging the wafer between the C/D 200 will be described. With the following description, to avoid complication, the on/off operation of the vacuum chuck performed during the delivery will be omitted.

\mathring{1} First, the load arm on the C/D side (not shown in Fig.) holding the wafer W on which the resist coating has been completed, is inserted into the chamber 12 through the opening 12b, and the wafer W is handed over to the inline I/F load arm 30 from the load arm on the C/D side. The shape of the load arm on the C/D side is made so that it does not interfere with the inline I/F load arm 30. And the delivery of the wafer W is performed by, for example, lowering the load arm on the C/D side (or raising the inline I/F load arm 30). The wafer, which has been delivered into the chamber, is indicated in FIG. 1 as W1.

After the delivery of the wafer has been completed, the load arm on the C/D side (not shown in Fig.) withdraws from the chamber 12 via the opening 12b. The wafer loader control unit 90 confirms the withdrawal of the load arm on the C/D side via a sensor (not shown in Fig.), and inserts the arm 34 via the driving portion 36 of the robot 32 under the wafer W which is held by the inline I/F load arm 30. When the insertion is completed, the robot 32 is raised by for example the vertical movement mechanism 37 (or the inline I/F road arm 30 is lowered), and the wafer is delivered from the inline I/F load arm 30 to the arm 34 of the robot 32. FIG. 2 shows the state just before the delivery of the wafer W to the robot 32.

Next, the wafer loader control unit 90 controls the arm 34 of the robot 32 holding the wafer so that it extends and rotates, and carries the wafer W to the position W2 indicated in an imaginary line. During this operation, the wafer loader control unit 90 controls the robot 32, so that the locus of the wafer W and the arm 34 of the robot 32 does not interfere with the inline I/F load arm 30, chamber 12, and the like. At this stage, the load X-axis turntable 42 has moved to the position 42′ indicated by an imaginary line in FIG. 1.

\mathring{2} The wafer loader control unit 90 then drives the arm 34 of the robot 32 downward via the vertical movement unit 37 (or drives the load X-axis turntable 42 upward), and the arm 34 of the robot 32 delivers the wafer W over to the load X-axis turntable 42.

The wafer loader control unit 90 then integrally drives the load X-axis turntable 42 with the slider 40 in the +Z direction, and thewaferwiscarriedtothepositionW3 indicated by an imaginary line. While the wafer W is being carried, the wafer loader control unit 90 rotates the load X-axis turntable 42 via the driving unit 44 (refer to FIG. 3) to rotate the wafer W held by the load X-axis turntable 42. And while the wafer W is being rotated, the wafer loader control unit 90 obtains the direction of the notch of the wafer W and the eccentricity of the wafer W in the XY two-dimensional direction in respect to the center of the load X-axis turntable 42. These are obtained, in accordance with the light amount signal output from the photodetection element 46 structuring the wafer edge sensor 48. A concrete method of obtaining the notch direction and the eccentricity of the wafer W is disclosed in, for example, Japanese Patent Laid Open 10-12709.

The rotation amount of the wafer and the eccentricity of a wafer having an orientation flat formed, can be similarly obtained by using the wafer edge sensor 48.

The wafer loader control unit 90 then controls the rotation angle of the load X-axis turntable 42 so that the direction of the notch obtained in the manner above coincides with a predetermined direction, for example the Y direction. The wafer loader control unit 90 also determines the stopping position of the load X-axis turntable 42 in the X direction movement, in accordance with the X direction component of the eccentricity of the center of the wafer W, and stops the load X-axis turntable 42 at the position. The rotation of the wafer W and the deviation in the X direction is thus corrected by the wafer loader control unit 90.

At the point where the wafer W is carried to the position W3 indicated by the imaginary line, the load Y-axis arm 50 is waiting at a position near the position 50′ which is indicated by an imaginary line. The load Y-axis arm 50 is waiting at a range (for example, near the position indicated W8 in an imaginary line) where it does not interfere with the wafer W which is at the position W3. The wafer loader control unit 90 then drives the load Y-axis arm 50 toward the position 50′, and stops the load Y-axis arm 50 at the position where the center of the wafer W and the center of the hook portion of the load Y-axis arm 50 coincide. By controlling the stopping position of the load Y-axis arm 50, the Y direction component of the eccentricity described earlier is corrected.

In short, as has been described, the wafer loader control unit 90 performs overall positioning (the first stage of pre-alignment) of the wafer W.

When this overall positioning is completed, with instructions from the wafer loader control unit 90, the wafer W is delivered to the load Y-axis arm 50 from the load X-axis turntable 42. The delivery of the wafer W is performed for example, by raising the load Y-axis arm 50 (or by lowering the load X-axis turntable 42).

\mathring{3} After the wafer W has been delivered to the load Y-axis arm 50, the wafer loader control unit 90 moves the load Y-axis arm 50 from the position 50′ indicated by the imaginary line to the loading position indicated by a solid line. Thus, the wafer W is carried to the position W5 indicated by an imaginary line.

However, when the wafer in the previous sequence still remains at the position W5 indicated by the imaginary line, the wafer loader control unit 90 controls the wafer W, in other words, the load Y-axis arm 50 so that it waits at the position W4 indicated by an imaginary line.

And, after the load Y-axis arm 50 begins to move toward the loading position, the wafer loader control unit 90 then moves the load X-axis turntable 42 to the left end of the movement position, that is, the position 42′ indicated by an imaginary line to carry the next wafer.

\mathring{4} When the load y-axis arm 50 arrives at the loading position, the wafer is delivered from the load Y-axis arm 50 to the stage delivery arm 54. This is performed by raising the stage delivery arm 54 (or by lowering the load Y-axis arm 50). FIG. 4 shows the stage just before the wafer W is delivered to the stage delivery arm 54. And after completing the delivery, the wafer loader control unit 90 starts to move the load Y-axis arm 50 back to the position 50′ indicated by an imaginary line, to carry the next wafer. At this stage, the load Y-axis arm 50 can be moved to a position near the position 50′ (for example, near the position indicated W8 in an imaginary line) where it does not interfere with the wafer W positioned at W3.

After confirming that the load Y-axis arm 50 has retreated from the loading position, the wafer loader control unit 90 drives the stage delivery arm 54 holding the wafer W a predetermined amount upward via the vertical/rotation mechanism 86 shown in FIG. 5. Then, the wafer loader control unit 90 detects the rim (outer shape) of the wafer W by using the three CCD cameras 88a, 88b, and 88c that structure the pre-alignment unit 80. And based on the detection result, the wafer loader control unit 90 obtains the X, Y, and θ errors of the wafer W, and controls the vertical/rotation mechanism 86 so as to correct the θ error. This detection of the X, Y, and θ errors of the wafer W (the second stage of pre-alignment) is performed to correct the residual error of the first stage of overall positioning and errors which may have occurred during carriage and delivery operations after the first positioning. Therefore, it is performed with a higher accuracy than before.

In addition, information on the X, Y errors obtained during the outer shape measurement of the wafer by the pre-alignment unit 80, is sent to the main controller 70 via the wafer loader control unit 90. The main controller 70 then corrects the errors by adding an offset for the X, Y errors, for example, when performing search alignment operations on the wafer W. As a matter of course, to correct the X, Y errors, the position of the wafer stage WST may be adjusted at the loading position.

\mathring{5} When the second stage of pre-alignment is being performed, on the wafer stage WST exposure operations (alignment, exposure) on a different wafer which has already been delivered previously onto the wafer stage WST is being performed. During the exposure operations, the unload Y-axis arm 52 is waiting at the loading position, directly under the stage delivery arm 54.

And, the pattern formed on the reticle R is transferred onto each shot area on the wafer W on the wafer stage WST, that is, exposure is completed. Then, the stage control unit 69 moves the wafer stage WST from the exposure completing position to the loading position as shown in FIG. 1 based on instructions from the main controller 70. Thus the wafer W having completed exposure is carried to the unloading position (in other words, the loading position).

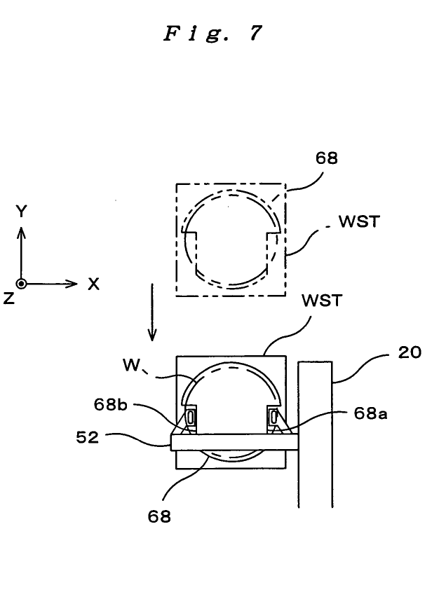

As shown in FIG. 7, when the wafer stage WST moves toward the loading position the hook portions of the unload Y-axis arm 52 which has adsorptive portions on the tip becomes engaged with the chips 68a and 68b.

When the movement of the wafer stage WST is completed, the wafer loader control unit 90 drives the unload Y-axis arm 52 upward a predetermined amount based on instructions from the main controller 70. And the wafer W which has undergone exposure is unloaded from the wafer holder 68 onto the unload Y-axis arm 52.

The wafer loader control unit 90 then drives the unload Y-axis arm 52 until it comes to the position 52′ indicated by an imaginary line. By this operation, the wafer W is carried from the loading position W5 shown by an imaginary line, to the position W8, also shown by an imaginary line.

However, in the case the previous sequence is not fully completed, and the unload X axis table 28 is not yet at the position indicated by a solid line, then the unload Y-axis arm 52 is to wait at the position shown by a solid line.

When the unload Y-axis arm 52 retreats from the loading position, the wafer loader control unit 90 lowers the stage delivery arm 54 via the vertical/rotation mechanism 86. The wafer W, which has not been exposed yet, is then loaded onto the wafer holder 68 from the stage delivery arm 54. When the stage delivery arm 54 is lowered, hook portions of the stage delivery arm 54 which has adsorptive portions on the tip becomes engaged with the chips 68a and 68b.

On confirming that the stage delivery arm 54 is lowered so as to secure a predetermined distance from the back surface of the wafer W, the main controller 70 then instructs the stage control unit 69 to move the wafer stage WST to the starting position of the exposure sequence. The stage control unit 69 then drives the wafer stage WST in the +Y direction and moves it to the starting position (as shown in FIG. 1) of the exposure sequence. After these steps are completed, the exposure sequence (search alignment, fine alignment such as EGA, and exposure) begins on the wafer W held on the wafer holder 68. Since, this exposure sequence is similar to the exposure sequence of the scanning stepper in general, except for the point that the positional deviation measurement of the wafer by photosensors is not performed on the wafer stage, a detailed description will be omitted.

Also, when the wafer stage WST is moved to the starting position of the exposure sequence, the movement of the wafer stage WST is smooth. This is because chips 68a and 68b are formed on the wafer holder 68, which keeps the hook portions of the stage delivery arm 54 from coming into contact with the wafer holder 68.

As is described, in this embodiment, on exchanging the wafer on the wafer holder 68, by efficiently utilizing the high accelerated operation of the wafer stage WST the time consumed when exchanging the wafer can be reduced, thus the throughput can be improved.

Details on the arrangement and operation of portions such as the pre-alignment unit 80, the wafer holder 68, the unload Y-axis arm 52, the stage delivery arm 54, are disclosed in, for example, International Application PCT/JP98/05453. As long as the national laws in designated states or elected states, to which this international application is applied, permit, the disclosure cited above is fully incorporated herein by reference.

After receiving the confirmation signal from the main controller 70 that the wafer stage WST has retreated from the loading position, the wafer loader control unit 90 then drives the stage delivery arm 54 upward to the loading position to carry the next wafer. At this position, the wafer w is delivered from the load Y-axis arm 50 to the stage delivery arm 54.

\mathring{6} Meanwhile, when the wafer w carried comes to the position W8 indicated by an imaginary line, the wafer loader control unit 90 for example lowers the unload Y-axis arm 52 (or raises the unload X axis table 28) so the wafer is passed over from the unload Y-axis arm 52 to the unload X axis table 28.

When this delivery is completed, the wafer loader control unit 90 then moves the unload Y-axis arm 52 to the loading position for the carriage of the next wafer, where it stays until the unloading of the next wafer.

After the wafer loader control unit 90 confirms that the unload Y-axis arm 52 has moved to a position where it does not interfere with the wafer near the opening 12a of the first chamber 12, it then integrally drives the unload X-axis table 28 with the slider 26 to the position 28′ indicated by an imaginary line in FIG. 1. That is, the unload X-axis table 28 with the slider 26 is driven to the wafer delivery position of the inline I/F unload arm 38. Thus, the wafer W is carried from the position W8 indicated by an imaginary line to the position under the position W1 (see FIG. 2, reference W9) in FIG. 1, which is also indicated by an imaginary line. \mathring{7} Next, the wafer loader control unit 90 controls the delivery of the wafer W from the unload X axis table 28 to the inline I/F unload arm 38. The delivery is actually performed by lowering the unload X axis table 28 (or by raising the inline I/F unload arm 38). When this delivery is completed, the wafer loader control unit 90 moves the unload X axis table 28 to the position shown by a solid line in FIG. 1.

Having confirmed that the unload X axis table 28 has retreated from the position 28′ indicated by an imaginary line, the wafer loader control unit 90 then sends the information to the C/D 200. Upon this operation, the unload arm on the C/D side (not shown in Fig.) is inserted into the chamber 12 through the opening 12b, and the wafer W is handed over to the unload arm on the C/D side from the inline I/F unload arm 38. When the wafer W is delivered, the unload arm on the C/D side is shaped so that it does not interfere with the inline I/F unload arm 38. The delivery of the wafer W is performed by, for example, raising the unload arm on the C/D side (or by lowering the inline I/F unload arm 38). As for the unload arm on the C/D side, the same arm as load arm may be used.

After the delivery is completed, the unload arm on the C/D side (not shown in Fig.) holds the wafer W and withdraws outside the chamber 12 through the opening 12b.

Next, the operation sequence of the case when wafers are housed and carried by using the OC24A will be described.

The OC24A, which is carried by the PGV (Personnel Guided Vehicle) or the AGV (Automatic Guided Vehicle) is placed on the carrier mount 22A through the opening 12c of the chamber 12. The OC24A may, of course, be placed on the carrier mount 22A by OHT (Overhead Transportation).

After the OC24A is placed on the carrier mount 22A, the wafer loader control unit 90 drives the carrier mount 22A downward via the vertical movement mechanism 94 by a predetermined amount. In concrete, the driving amount is around 300 mm downward. The reason for this operation will be described next, referring to FIG. 6.

First, when the OC24A is placed on the carrier mount 22A with the PGV, and the like, the height of the carrier mount 22A from the floor H1 is set to around 900 mm above the floor due to restrictions when placing the OC24A from the human engineering point of view. Inside the OC24A, a plurality of shelves, for example 25 shelves, to hold the wafers are arranged. And the height of the wafers shelved from the upper surface of the carrier mount 22A is around 270 mm at the topmost HOT (refer to FIG. 6) and around 30 mm at the bottom HOB. Accordingly, in a state where the carrier mount 22A is fixed, the height necessary to allow access to the wafer shelved in the OC24 is around 930 (900+30) mm to around 1170 (900+270) mm.

Meanwhile, the wafer W taken out of the OC24A is mounted on the load X-axis turntable 42. The height of the load X-axis turntable 42 is set almost the same as of the wafer stage WST, that is, around 600 mm above the floor. This is due to the fact that the height of the wafer stage WST arranged affects the total height of the apparatus, and furthermore directly affects the height of the ceiling of the clean room. Therefore, to keep the clean room equipment cost low, the setting height of the wafer stage WST is required to be maintained as low as possible within the limits of the structure of the apparatus. Also, during the carriage process of the wafer described earlier, where the load X-axis turntable 42 begins to carry the wafer W and loads the wafer onto the wafer stage WST, in regards to height there is hardly any change, except for the respective structuring members performing vertical movement upon delivery of the wafer. Accordingly, the wafer accessing height (H3, in FIG. 6) of the arm 34 of the robot 32 for delivering the wafer to the load X-axis turntable 42 is to be around 600 mm.

Accordingly, in the case the wafer W shelved in the OC24A is take out by the arm 34 of the robot 32 and delivered to the load X-axis turntable 42 while the carrier mount 22A is fixed, the stroke of the arm 34 in the Z direction results in around 570 mm (600 mm−1170 mm). Naturally, the size of the vertical movement mechanism 37 of the robot 32 becomes larger, and securing the space becomes difficult. The throughput also is reduced, since the robot 32 needs to vertically move around 570 mm to access per wafer.

So, with the exposure apparatus 10 in this embodiment, after mounting the OC24A at a position of height H1 on the carrier mount 22A, the height of the OC24A is lowered to the height H2. The vertical movement required afterward, when taking out the wafer from the OC24A or putting in the wafer into the OC24A is performed by the Z direction movement of the robot 32. Furthermore, when the whole process of taking out the wafer and putting in the wafer is completed, the carrier mount 22A is lifted to the carrying position, which is at the height H1. In this manner, with the exposure apparatus 10 in this embodiment, the vertical stroke of the robot 32 is shortened by (H1-H2). If the height H2 is set to around 60 m, then the topmost wafer shelved, is around 870 (600+270) mm. Accordingly, the arm 34 of the robot 32 covers around 600 mm to around 870 mm and only need to perform reciprocal movement with a stroke of 270 mm.

In this case, the vertical movement mechanism 94 of the carrier mount 22A can be arranged directly underneath the carrier mount 22A. In addition, the carrier mount 22A does not have to be lowered each time when making access to the wafer, and only need to be lowered once when the carrier is exchanged. Therefore, influence to throughput is small.

When the carrier mount 22A is lowered, the wafer loader control unit 90 uses the photosensors (substrate detection sensors) made up of the light emitting element 98A and the photodetection element 98B to detect whether wafers are housed in each shelf. The detection result is then stored in a memory (not shown in Fig.). Upon this detection, wafers that cannot be accessed, for example, a wafer that is tilted and housed using two shelves instead of one, may be detected and the error may be notified to the operator.

Next, in accordance with the information stored in memory on whether each shelf houses a wafer, the wafer loader control unit 90 drives the robot 32 upward in correspondence with the height of the wafer to be accessed. That is, the robot arm 32 is raised to a height where the arm 34 of the robot 32 can be inserted into the space between the wafer to be accessed and the obstacle below (a wafer or the bottom of the OC). In this case, the arm 34 of the robot 32 need only to be raised at a maximum of the height H4 (refer to FIG. 6). FIG. 6, for the sake of convenience, is shown with the slices of wafers less than actual, however, in actual the container OC24A has 25 shelves to hold the wafers, and H4 (the 25^{th} shelf counted from below) is the wafer accessing height of the topmost wafer.

Next, after the wafer loader control unit 90 completes the insertion of the arm 34 of the robot 32 into the space below the wafer to be accessed via the driving portion 36, the arm 34 is slightly raised so that the wafer W is mounted on the arm 34. Then the arm 34 of the robot 32 is withdrawn and the wafer W is taken out from the OC24. And, the wafer loader control unit 90 carries the wafer W to the position W2 indicated by an imaginary line in FIG. 1 via the arm 34 of the robot 32 by rotating and extending/folding the arm 34. This carriage is performed so that the locus of the wafer W and of the arm 34 of the robot 32 does not interfere with objects such as the OC itself or other wafers stored within the OC24.

Subsequently, the carriage operation sequence similar to \mathring{2}-\mathring{6} described earlier (in the case of inline connection with C/D) is performed, and the wafer W which has completed exposure is carried to the position W11 shown by an imaginary line in FIG. 1. This position may be in common with the unloading position of the inline operation.

When the wafer W is carried to the position W11 shown by an imaginary line, the wafer loader control unit 90 inserts the arm 34 of the robot 32 under wafer W held by the unload X-axis table 28 positioned at 28″ indicated by an imaginary line. The arm 34 of the robot 32 is then raised a predetermined amount, and the wafer W is passed over to the arm 34 of the robot 32 from the unload X-axis table 28. The wafer loader control unit 90 then carries the wafer W from the position W11 to the position W10 indicated by an imaginary line in FIG. 1 via the arm 34 of the robot 32 by rotating and extending/folding and raising the arm 34. To be specific, the arm 34 of the robot 32 is raised carrying the wafer W to the height where the wafer W is to be housed. Then the arm 34 of the robot 32 is extended and the wafer W is inserted slightly above the shelf where it is to be housed. And after the wafer W is inserted, the arm 34 of the robot 32 is lowered so that the wafer W is delivered on the shelf. Then the arm 34 of the robot 32 is withdrawn, and retreats outside the OC24A.

Finally, when the processing of the wafers stored inside the OC24A is completed in the manner described above, the wafer loader control unit 90 the drives the carrier mount 22A upward from the height H2 to the height H1. And the OC24A waits at the position to be carried by the PGV, the AGV, and the OHT, and the like.

The operation of housing and carrying the wafers by using the other container OC24B is basically similar as with the case of OC24A. The difference, however, is that the wafer carriage operation sequence begins at the position W12 in FIG. 1 indicated by an imaginary line, with the wafer W being carried to the position W13 indicated by an imaginary line, and ends where the wafer W is carried to the position W12 from the position W14 indicated by an imaginary line.

As is described in detail, according to exposure apparatus 10 in the first embodiment, the inline I/F load arm 30, inline I/F unload arm 38 serving as a substrate delivering portion between the wafer carriage arm on the C/D 200 side (the load arm on the C/D side and the unload arm on the C/D side) is arranged inside the chamber 12. Therefore, it is not necessary to arrange an independent inline interface portion between the C/D as in the conventional apparatus. Thus, the space required in the clean room can be reduced, and as a consequence, reduce the equipment cost of the clean room. Furthermore, since the wafer W is delivered directly between the inline I/F load arm 30 and the inline I/F unload arm 38, and the load arm on the C/D side and the unload arm on the C/D side, the number of delivery can be reduced. As a result, dust and the like generated can be reduced.

In addition, the inline I/F load arm 30 and the inline I/F unload arm 38 have a double structure and are arranged vertically. Therefore, the loading side carriage sequence (receiving the wafer from the C/D) and the unloading side carriage sequence (returning the wafer back into the C/D) can be performed independently. So, such a situation can be avoided, where the loading side carriage sequence cannot be executed because the wafers that have completed exposure still remains at the inline I/F portion and the wafers to be newly processed cannot be received.

Furthermore, due to the vertical arrangement of the inline I/F load arm 30 and the inline I/F unload arm 38 the space is saved to an extreme. Consequently, the neighboring space can be efficiently used in ways such as arranging the robot 32 and the OC24A (buffer) which temporarily houses the wafer W.

In addition, with the exposure apparatus 10, the wafer carriage system 100 comprises the load X-axis turntable 42 which holds and moves the wafer in the X direction, and the wafer edge sensor 48 which integrally moves with the load X-axis turntable 42. And during the movement of the load X-axis turntable 42 in the X direction, the wafer loader control unit 90 detects the positional deviation of the wafer W (rotational deviation, central position deviation) being rotated by the turntable 42. That is, in this embodiment, the wafer loader control unit 90 and the wafer edge sensor 48 make up a positional deviation detection unit. Accordingly, the detection time of the positional deviation of the wafer (the detection time of the positional deviation of the wafer for the first stage of pre-alignment) can be completely overlapped with the carriage time of the wafer, thus the throughput is improved. Moreover, since the turntable and the sensor to detect the deviation of the wafer do not have to be arranged off the wafer carriage path, exclusive space is not required, thus, the space efficiency is improved.

Also, since the wafer loader control unit 90 corrects the positional deviation of the wafer detected, in accordance with the output of the wafer edge sensor 48 during the carriage of the wafer (the first stage of pre-alignment), this correction cannot be the cause of reducing the throughput. To be more concrete, the wafer loader control unit 90 corrects the rotation of the wafer W and the X direction component of the eccentricity with the load X-axis turntable 42, by its rotation and its stopping position in the X direction. Whereas, the Y direction component of the eccentricity of the wafer W is corrected with the stopping position of the load Y-axis arm 50, which receives the wafer from the load X-axis turntable 42.

That is, in this embodiment, the wafer loader control unit 90, the load X-axis turntable 42, load Y-axis arm 50 and the driving system make up a position correction system.

And, with the exposure apparatus 10, the wafer loader control unit 90 drives the carrier mount 22A (or 22B) downward via the vertical movement mechanism 94 from the first position (the position of the height H1) to the second position (the height H2) prior to starting the exposure process of the wafers housed in the OC24A (or 24B). That is, in this embodiment, the wafer loader control unit 90 and the vertical movement mechanism 94 make up a driving unit.

In addition, after the carrier mount 22A is lowered to the position having the height H2, the arm 34 of the robot 32 moves vertically to make access to the wafer housed in the OC24A. Therefore, the movement strokes necessary of the arm 34 of the robot 32 when accessing the wafer in the OC24A can be shortened to around 270 mm, even when the position of height H1 is set around 900 mm above the floor, and height H2 is set around 600 mm above the floor. The height 900 mm, is an appropriate height to place the OC24A onto the carrier mount 22a from the human engineering point of view, for example, in the case of a 12 inch sized wafer. And the height 600 mm is the setting height of the wafer stage WST and also is the reference height of the carriage path of the wafer by the wafer carriage system. Furthermore, the carrier mount 22A (or 22B) only need to be driven downward from the height H1 to the height H2 prior to starting the exposure process only once. Accordingly, in the case of using a 12 inch sized wafer, the throughput of wafer carriage can be improved.

Also, when the carrier mount 22A is lowered, the wafer loader control unit 90 uses the substrate detection sensors made up of the light emitting element 98A (or 99A) and the photodetection element 98B (or 99B) to detect whether wafers are housed in each shelf of the OC24A (or 24B). That is, in this embodiment, the wafer loader control unit 90 and the light emitting element 98A (or 99A) and the photodetection element 98B (or 99B) make up a substrate detection unit. And by using this substrate detection unit whether wafers are housed in each shelf of the OC24A (or 24B) can be efficiently detected.

In addition, with the exposure apparatus 10 in the first embodiment, the wafer carriage of the loading side is performed by the load X-axis turntable 42 and the load Y-axis arm 50, and the wafer carriage of the unloading side is performed by the unload Y-axis arm 52 and the unload X-axis table 28. Accordingly, the loading wafer carriage between the C/D (or the OC) and the wafer stage, and the unloading wafer carriage between the C/D (or the OC) and the wafer stage can be performed independently (in other words, simultaneously). So, during the carriage sequence, to be more precise, during the loading carriage sequence, a maximum of 5 slices of wafers (imaginary line: W1, W3, W4, W5 and on the wafer stage WST) can be handled within the apparatus. If the length of the carriage path between the C/D and the wafer stage is constant, the actual throughput is increased when more wafers can be fed into the apparatus. Accordingly, this apparatus is capable of increasing the throughput compared with the conventional apparatus (during the loading carriage sequence, a maximum of only three slices of wafers can be fed into the apparatus).

Also, in this embodiment, the positional deviation detection of the wafer for precise alignment of the wafer W is performed by the wafer alignment unit 80 at the loading position in parallel with the exposure performed on the wafer mounted on the wafer stage WST. For this reason, compared with the case of performing a precise alignment after loading the wafer onto the wafer stage WST, the throughput can be improved.

In the embodiment above, the case is described when the wafer edge sensor 48 is arranged on the extending portion of the slider 40 to where the load X-axis turntable 42 is fixed. However, the present invention is not limited to this, and the wafer edge sensor 48 may be separated from the load X-axis turntable 42, and fixed to the position shown in FIG. 1. And, in this case, the positional deviation detection and the overall positioning (the first stage of pre-alignment) can be performed after the wafer W is carried to the position W3 indicated by an imaginary line.

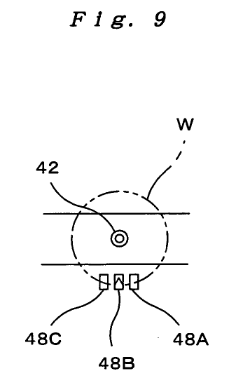

Also, in the embodiment above, the case where the wafer edge sensor 48 comprises one photodetection element is described, however, the present invention is not limited to this. For example, photosensors 48A, 48B, and 48C made up of light emitting elements and photodetection elements can be arranged as shown in FIG. 9. The photosensor 48B located in the center can structure the notch sensor, and the remaining two photosensors 48A and 48C may be arranged symmetrical on both sides of the photosensor 48B. In this case, the first stage of pre-alignment can be performed by: adjusting the rotation angle of the wafer by setting the direction of the notch at a predetermined direction in accordance with the output of the notch sensor 48B; by stopping the load X-axis turntable 42 at a position where the output signal from the photosensors 48A and 48C are equivalent; and by stopping the load Y-axis arm 50 at a position corresponding to the center of the wafer obtained by signals from the photosensors 48A or 48C.

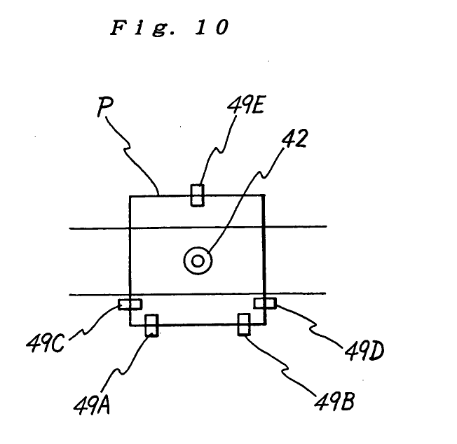

In addition, in the embodiment above, the case when the wafer is used as a substrate is described, however, the present invention is not limited to this. For example, as a substrate a square shaped substrate such as a glass plate used for liquid crystal display panels may be used. The first stage of pre-alignment for such a square-shaped substrate can be performed in the following manner, for example, by using 5 sets of photosensors 49A to 49E, arranged in a positional relationship shown in FIG. 10. That is: adjusting the rotation angle of the substrate by rotating the square-shaped substrate P so that the output signal from the photosensors 48A and 48C are equivalent; correcting the X direction component of the eccentricity by stopping the load X-axis turntable 42 at a position where the output signal from the photosensors 48C and 48D are equivalent; and correcting the Y direction component of the eccentricity by stopping the load Y-axis arm 50 at a position corresponding to the center of the square-shaped substrate P obtained by signals from the photosensors 49A (or 49B) and 49E.

In either cases, when the substrate is the wafer W or the square-shaped substrate P, adjustment of the rotation angle and the detection of center may of course, be performed by the combination of a well known positioning pin and a positioning roller (positioning hammer). In such a case, the center of the wafer W or the square-shaped substrate P after the adjustment of the rotation angle and the detection of the center (positioning) is performed, is located at a constant position. Therefore, the load X-axis turntable 42 and the load Y-axis arm 50 need only to be stopped at their predetermined positions.

Also, in the case of using a square-shaped substrate, the positional deviation detection for precise alignment at the loading position can be similarly performed as described in this embodiment. In this case, however, the pre-alignment unit 80 needs to comprise 5 CCD cameras, and each CCD camera is to be arranged in the same arrangement as of the respective photosensors shown in FIG. 10.

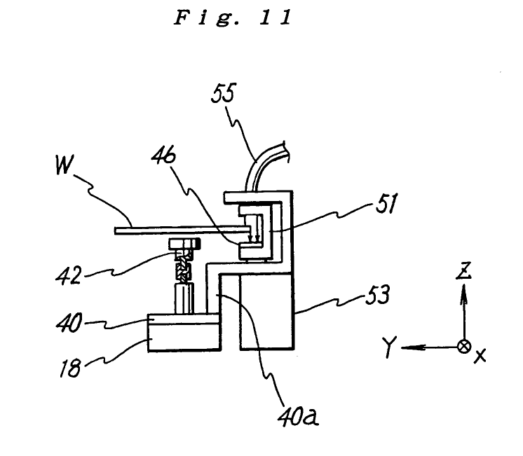

In addition, instead of the wafer edge sensor 48 described in the embodiment above, as shown in FIG. 11, on the extending portion of the slider 40 to where the load X-axis turntable 42 is arranged, a peripheral exposure unit 51 may be arranged. In this case, the preferable structure is to arrange a separate third X guide 53 parallel to the X guide 18, and the peripheral exposure unit 51 integrally moves in the X direction along the third X guide 53 with the extended portion 40a. And, the peripheral exposure unit 51 is also capable of moving in the Y direction in respect to the extended portion 40a. With this structure, peripheral exposure can be performed while the wafer is being carried in the X direction, by the wafer W being rotated by the load X-axis turntable 42 and the resist around the wafer W being sensitized by the exposure light guided via the optical fiber 55. In this case, the peripheral exposure time can partly be overlapped with the wafer carriage time; therefore, it can improve the throughput, as well as reduce the dust being generated caused by the resist coming off. The peripheral exposure unit 51 does not necessarily have to move in the X direction, and being capable of moving in the Y direction in respect to load X-axis turntable 42, is enough.

The details of the structure of the peripheral exposure unit are disclosed in, for example, Japanese Patent Laid Open No. 04-72614, and the corresponding U.S. Pat. No. 5,229,811. As long as the national laws in designated states or elected states, to which this international application is applied, permit, the disclosures cited above are fully incorporated herein by reference.

Also, in the case of arranging the peripheral exposure unit 51, it is preferable to arrange the photodetection element 46 such as a photodiode. With this arrangement, the wafer loader control unit 90 can detect the positional deviation of the wafer W in accordance with the output of the photodetection element 46. And, in accordance with the detection result, the wafer loader control unit 90 is capable of servo controlling the position of the peripheral exposure unit 51 in the Y direction (that is, the radius direction of the wafer W). This allows peripheral exposure on the wafer W to be performed in the same width along the whole circumference.

In this case, the wafer loader control unit 90 can correct the positional deviation of the wafer detected likewise with the embodiment above, while the wafer is being carried.

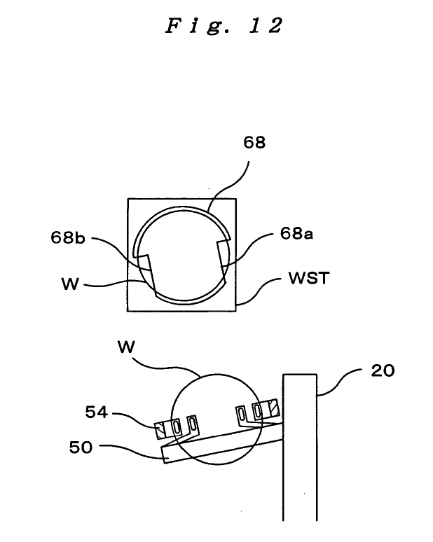

In addition, the embodiment above describes the case when the loading position (the wafer exchanging position) is located in the −Y direction in respect to the completing position of the exposure sequence (in other words, the starting position of the exposure sequence) of the wafer stage WST, as is shown in FIG. 1 and FIG. 7. However, when, for example, the positional relationship between the loading position and the completing position of the exposure sequence of the wafer stage WST becomes as shown in FIG. 12, the shape and the direction of the chips 68a and 68b of the wafer holder 68, the stage delivery arm 54, and the load Y-axis arm 50 need to be arranged as shown in FIG. 12.

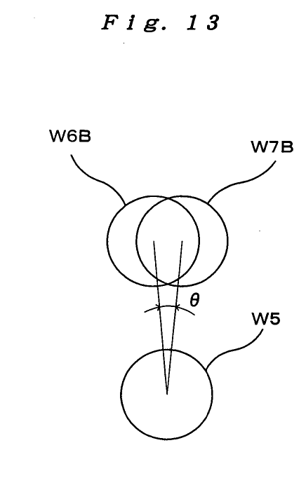

In addition, in the embodiment above, the case where the starting position of the exposure sequence of the wafer stage WST coincides with the completing position of the exposure sequence has been described. And, even if the position differs, when the direction of the starting position of the exposure sequence of the wafer stage WST and the completing position of the exposure sequence is the same in respect to the loading position, the shape of the chips 68a and 68b of the wafer holder 68, the stage delivery arm 54, the load Y-axis arm 50, and the unload Y-axis arm 52 can be as shown in FIG. 1. However, when the direction of the starting position of the exposure sequence of the wafer stage WST and the completing position of the exposure sequence differ in respect to the loading position, and as a result, the line segment formed when connecting the center of the wafer at the loading position (indicated by W5) and the center of the wafer at the completing position of the exposure sequence (indicated by W7B) and the line segment formed when connecting the center of the wafer at the loading position and the starting position of the exposure sequence (indicated by W6B) form an angle of θ as shown in FIG. 13, in order to prevent the unload Y-axis arm 52 and the wafer holder 68 from interfering during wafer unloading and the wafer delivery arm 54 and the wafer loader 68 from interfering during wafer loading, the shape of the chips on the wafer holder 68 need to be set in accordance with the angle θ (increase the chipped area). Accordingly, in order to sufficiently secure the adsorptive area on the wafer holder 68, the positional relationship between the starting position of the exposure sequence of the wafer stage WST and the completing position of the exposure sequence is preferably set so that the angle θ is maintained extremely small.

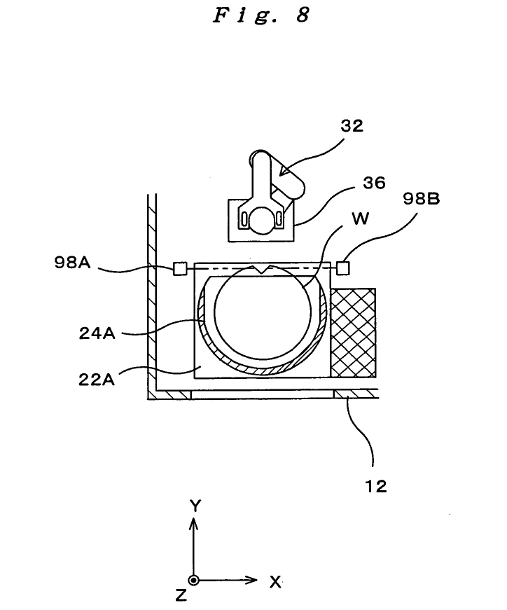

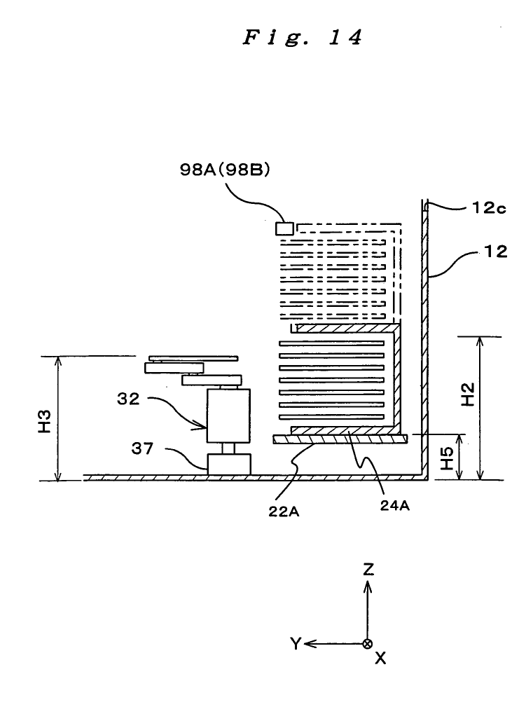

Furthermore, in the embodiment above, the access to the wafer W in the OC24A is performed with the vertical movement of the robot 32. However, the present invention is not limited to this, and for example, the strokes of the robot 32 in the Z direction can be arranged in the range of strokes necessary for delivery of the wafer. And, the operation of adjusting the height of the arm 34 of the robot 32 to the wafer W to be accessed may be performed by the vertical movement of the carrier mount 22A (height H2-height H5), as shown in FIG. 14. In this case, since the vertical movement stroke of the carrier mount 22A is a long stroke (height H1-height H5), so the vertical movement mechanism 94 increases in size. However, on the right hand side of the carrier mount 22A, space indicated in FIG. 8 as the criss-cross hatching portion is available, therefore, the vertical movement mechanism 94 can be arranged in this area.

With the embodiment above, the substrate detection sensor of a transmittance type is used to detect the neighboring area of the peripheral of the wafer. However, the present invention is not limited to this, and the light-emitting element and the photodetection element making up the substrate detection sensor of a transmittance type may be arranged so that the optical axis of the substrate detection sensor passes through the area around the center of the wafer. This arrangement is particularly effective in the case the bending of the wafer due to its weight is a problem, since the bending of the wafer is considered to be the greatest around the center.

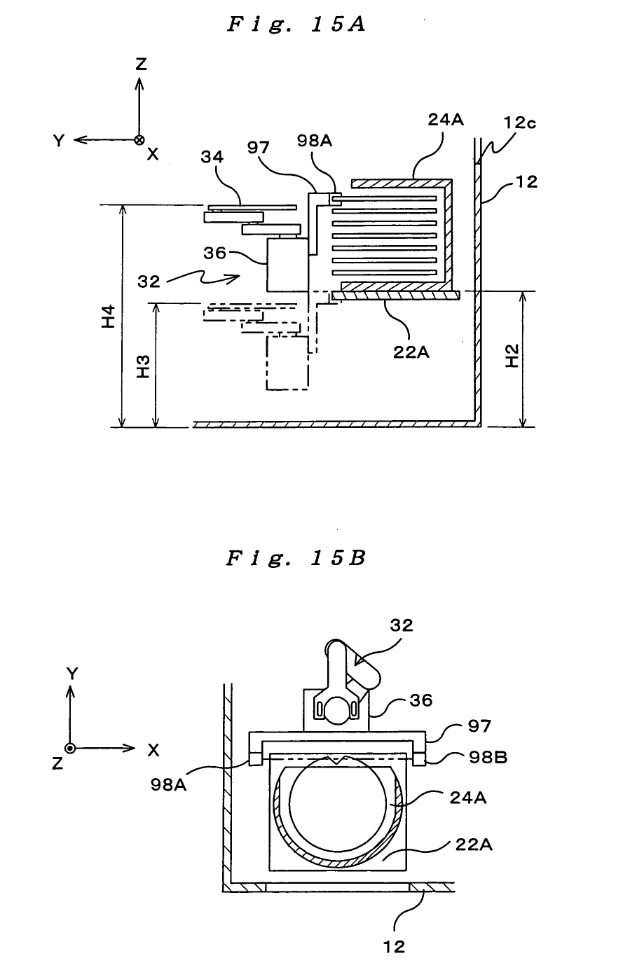

Alternatively, as shown in the side view of FIG. 15A and the planar view of FIG. 15B, the substrate detection sensor of a transmittance type (98A, 98B) maybe attached to the driving portion of the robot 32 via the supporting mount 97. And the substrate detection sensor (98A, 98B) may be arranged so as to move vertically in integral with the robot 32. In this case, the detection height of the substrate detection sensor is to be set to a height so that the wafer can be detected immediately before the arm 34 makes access to the wafer W. And, the information on whether the wafer is housed in each shelf on the OC may be detected and mapped at once, as is described previously, or may be detected each time before making access to the wafer.

In addition, the substrate detection sensor is not limited to a transmittance type, and a reflection type may of course be used. However, when using the substrate detection sensor of the reflection type, there is a possibility that the desired signal strength cannot be obtained when the direction of the wafer notch coincides with the detection direction of the substrate detection sensor. Therefore, it is preferable to use two substrate detection sensors and detect the wafer from two directions.

Also, in the case of using the square-shaped substrates, whether the wafer is housed in each shelf on the OC may be detected by using the transmittance type or reflection type wafer detection sensors, likewise as described above.

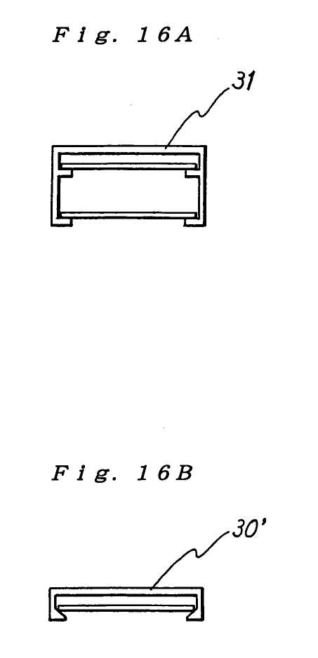

Furthermore, in the embodiment above, the case is described where the inline I/F load arm 30 and the inline I/F unload arm 38 are respectively arranged, in vertical. However, the present invention is not limited to this, and as shown in FIG. 16A, an I/F arm 31 that comprises two hook portions (substrate holding portion) in a vertical structure can be arranged, and can be moved vertically. Or, alternatively, a single I/F arm may be arranged to move vertically between the wafer loading position and the wafer unloading position, by controlling the delivery timing of the load arm on the C/D side and the unload arm on the C/D side.

In addition, since the inline I/F load arm 30 and the inline I/F unload arm 38 perform only vertical movement to deliver the wafer W, means for preventing the wafer from deviating (such as vacuum chucking and electrostatic clamping) may be omitted. In this case, for example, an I/F arm, like the I/Farm 30′ in which the shape of the hook portion is tapered as shown in FIG. 16B, may be used.

The openings 12b, 12c, and 12d form the border between the inside of the chamber 12 in the embodiment above and the outside of the chamber 12 which may have a lower degree of cleanliness than the inside. These openings may comprise downflow air curtains to prevent the external air from pouring into the chamber 12. Or, they may comprise mechanical shutters and the like which opens/closes immediately before or after the delivery of the wafer by the wafer carriage arm on the C/D side, or opens/closes immediately before or after the OC has been brought in/out of the chamber 12.

In addition, as can be seen from FIG. 1, even under the condition of sharing the inline connection with the with the C/D 200, a maximum of two OCs can be loaded in the exposure apparatus 10.

<<Second Embodiment>>

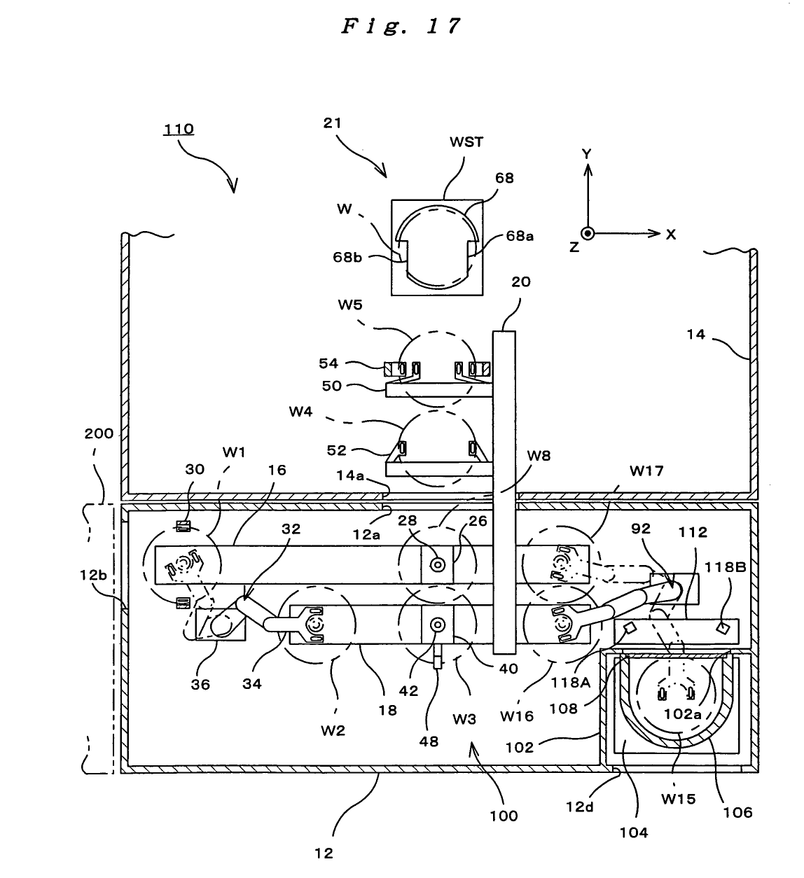

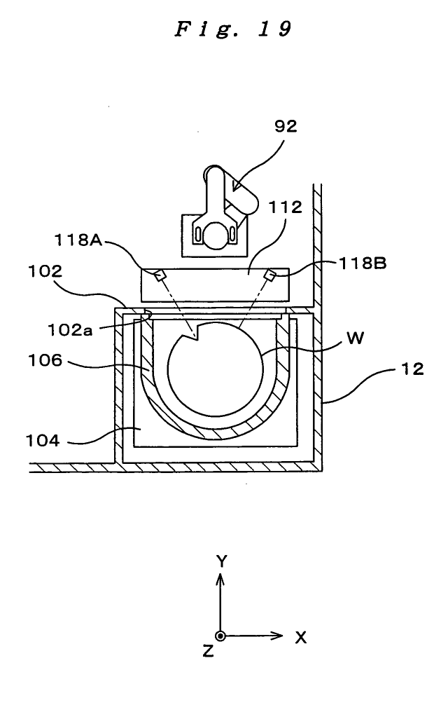

The second embodiment of the present invention will be described below with reference to FIGS. 17 to 20. Structures and components identical or equivalent to those described in the first embodiment are designated with the same reference numerals, and the description thereabout is briefly made or is entirely omitted.

FIG. 17 schematically shows the sectional view (a planar sectional view) of an exposure apparatus 110 according to the second embodiment, focusing on the wafer carriage system 100 serving as the substrate carriage system. The exposure apparatus 110 can be suitably used inline connected with the C/D 200. And, in FIG. 17, the portion other than the air conditioning system and the wafer stage WST of the main body of the exposure apparatus is omitted.

With the exposure apparatus 110, an L shaped partition wall 102 is arranged in a planar view, in the area covering both the +X direction side and the −Y direction side (the right lower side shown in FIG. 17) inside the first chamber 12. It characterizes on the point that within the space enclosed by the partition wall 102 and the side wall of the chamber 12, a Front Opening Unified Pod (hereinafter referred to as “FOUP”) mount 104 serving as a container mount to mount the FOUP is arranged, instead of the carrier mount 22B described in the first embodiment. Also, with the exposure apparatus 110, the FOUP mount 104 is arranged on the right hand side of the chamber 12, that is arranged only on the opposite side of where the C/D 200 is arranged. On the FOUP mount 104, a FOUP 106 is arranged.

The FOUP 106 is an open/close type container (wafer cassette) which can vertically house a plurality of wafers as a substrate in predetermined intervals. It has an opening arranged only on the front side (the surface in the +Y-direction in FIG. 17) and a front door 108 serving as a cover of the opening, and is similar to the carriage container disclosed in, for example, Japanese Patent Laid Open No. 08-279546.

To take out the wafer housed in the FOUP 106, the FOUP 106 is pressured toward an opening 102a of the partition wall 102, and the front door 108 needs to be opened/closed via the opening 102a. Therefore, in this embodiment, an open/close mechanism (opener) 112 of the front door 108 is arranged in the area covering the +Y side of the partition wall 102 and on the +X side of the second guide 18. And due to this arrangement, the location where the robot 92 is arranged is slightly translated in the +Y direction compared with the case in FIG. 1.

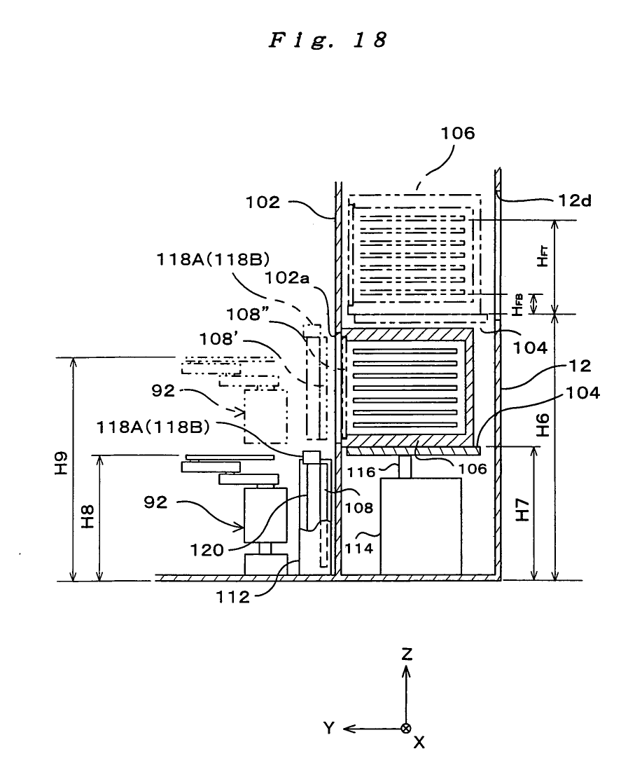

The opening 102a, is formed in the partition wall 102, from a height slightly lower than the height H7 (H7 in this case, is around 600 mm) up to a height slightly lower than the height H6 (H6 is around 900 mm) as is shown in FIG. 18.

In addition, as shown in FIG. 18, inside the FOUP 106, a plurality of shelves, for example, 25 shelves are arranged to hold the wafers. And the height of the wafers shelved from the upper surface of the FOUP mount is around 280 mm at the topmost H_{FT} and around 40 mm at the bottom H_{FB}.

Also, as shown in FIG. 18, the FOUP mount 104 is fixed on the upper surface of the driving shaft 116 which is driven in the vertical direction and the Y direction by the vertical/sliding mechanism 114 fixed to the floor of the chamber 12. This vertical/sliding mechanism 114 is also controlled by the wafer loader control unit 90 (refer to FIG. 5) which is previously described.

Furthermore, within the open/close mechanism 112, an open/close member 120 that vacuum chucks or mechanically connects and becomes engaged with the front door 108 as well as open the key (not shown in Fig) arranged on the front door 108, is housed. And on the upper end of the open/close member 120, a pair of substrate detection sensors of the reflection type, 118A and 118B, are fixed. The details of a similar method to open or close the front door 108 with the open/close mechanism 112 are disclosed in, for example, the Japanese Patent Laid Open No. 08-279546, referred to earlier. In a normal state (when the FOUP is not mounted), the open/close member 120 is fitted into the opening 102a to close the opening 102a so that the inner side of the partition wall 102 is not in an exposed state to the outside. And, in this embodiment, the open/close mechanism 112 is also controlled by the wafer loader control unit 90 (refer to FIG. 5) which is previously described.

Structures other than what is mentioned above, is identical to the exposure apparatus 10 described in the first embodiment.

With the exposure apparatus 110, the wafer carriage operation when exchanging the wafer between the C/D 200 is completely identical with the case in the first embodiment, therefore a detailed description will be omitted.

Next, the operation sequence of the case when wafers are housed and carried by using the FOUP 106 will be described.

The FOUP 106, which is carried by the PGV (Personnel Guided Vehicle) or the AGV (Automatic Guided Vehicle) through the opening 12d of the chamber 12, and is placed on the FOUP mount 104 which is located at a height of H6 (H6 is set to around 900 mm above the floor from the human engineering point of view) above the floor. The FOUP 106 may, of course, be placed on the FOUP mount 104 by OHT (Overhead Transportation).

After the FOUP 106 is placed on the FOUP mount 104, the wafer loader control unit 90 drives the FOUP mount 104 downward via the vertical/sliding mechanism 114 by a predetermined amount. In concrete, the driving amount is H6-H7, that is, around 300 mm downward. The reason for this operation is due to the same reasons as of the first embodiment.

In this case, also, the operation of lowering the FOUP mount 104 is only required once when exchanging the FOUP, and not each time the wafer is accessed. Thus, this operation hardly has any influence on the throughput.

Next, the wafer loader control unit 90 pressures the FOUP 106 toward the partition wall 102 by driving the FOUP mount 104 in the +Y direction via the vertical/sliding mechanism 114. This is performed because the degree of cleanliness within the FOUP 106 has to be maintained at a high level even after the front door 108 is opened. And, by this operation, the inside of the FOUP 106 is not exposed to the space outside the partitioned wall 102 where the degree of cleanliness may be lower than that of the space inside the partitioned wall 102, even after the front door 108 has been opened.

The wafer loader control unit 90 then performs the opening operation of the front door 108. In this operation, by using the open/close member 120 of the open/close mechanism 112, the wafer loader control unit 90 moves the front door of the FOUP 106 from the position 108″ indicated by an imaginary line shown in FIG. 18, in other words, the position where the FOUP 106 is pressured toward the partition wall 102, via the position 108′ also indicated in an imaginary line, to the housing position within the open/close mechanism 112. While the front door 108 is being opened, the wafer loader control unit 90 uses the pair of substrate detection sensors of the reflection type, 118A and 118B, to detect whether each shelf within the FOUP 106 is occupied by a wafer. The detection result is then stored in a memory (not shown in Fig.). Upon this detection, wafers that cannot be accessed, for example, a wafer that is tilted and housed using two shelves instead of one, may be detected and the error may be notified to the operator.

Next, the wafer loader control unit 90 drives the robot 92 upward in accordance to the height of the wafer to be accessed, based on the information stored in memory of the wafer availability in each shelf. That is, the arm of the robot 92 is raised to a height where the arm can be inserted into the space between the wafer to be accessed and the obstacle below (a wafer or the bottom of the FOUP). In this case, the arm of the robot 92 need only to be raised at a maximum of the height H9 (refer to FIG. 18).

And then, the wafer loader control unit 90 takes the wafer W out from inside the FOUP 106 with the robot 92, likewise with the case of taking out the wafer from the OC in the first embodiment. And the wafer W is carried to the position W16 indicated by an imaginary line in FIG. 17 by the robot 92. This carriage is performed so that the locus of the wafer W and of the arm of the robot 92 does not interfere with objects such as other wafers stored within the FOUP 106. Furthermore, in the case of taking out the wafer W from the FOUP 106 using the robot 92, the height of the topmost wafer shelved in the FOUP 106, is around (600+280)=880 mm. Accordingly, the arm of the robot 92 needs to cover around 600 mm to around 880 mm, and only need to perform reciprocal movement with a stroke around 280 mm.

Subsequently, the carriage operation sequence similar to \mathring{2}-\mathring{6} in the case of inline connection with C/D as in the first embodiment is performed, and the wafer W which has completed exposure is carried to the position W17 shown by an imaginary line in FIG. 17.

When the wafer W is carried to the position W17 shown by an imaginary line, the wafer loader control unit 90 shelves the wafer into the FOUP 106 with the arm of the robot 92, as is with the delivery of the wafer to the OC in the first embodiment.

The wafer carriage and the exposure sequence is repeatedly performed on the all the wafers housed in the FOUP 106. And at the point where the entire processing of the wafer within the FOUP 106 has been completed, the wafer loader unit 90 closes the front door 108 of the FOUP 106 in a reversed process as of the opening via the open/close mechanism 112. After this operation is completed, the wafer loader control unit 90 drives the FOUP mount 104 from the height H7 to H6, and the FOUP mount 104 waits at this position to be carried by the PGV, the AGV, and the OHT, and the like.

According to the exposure apparatus 110 in the second embodiment, other than being able to obtain the same effect as of the exposure apparatus 10 in the first embodiment, the FOUP mount 104 on which the FOUP is placed, and the open/close mechanism 112 of the front door 108 of the FOUP 106 is arranged within the lower chamber 12 where most of the wafer carriage system 100 is housed. Therefore, as can be seen when comparing FIG. 1 and FIG. 17, the space that is required within the chamber 12 is the same compared with the case of the first embodiment. That is, an apparatus with inline connection using the FOUP can be arranged, without increasing the footprint of the apparatus in the case of inline connection using the OC.

To describe this differently, since the FOUP mount 104 to place the FOUP 106 is arranged on the side opposite to the connecting portion with the C/D 200 of the wafer carriage system 100, the open/close mechanism 112 to open the front door 108 of the FOUP 106 can be arranged in front of the FOUP mount 104. Therefore, it can be said, that arranging the FOUP within the same chamber space becomes possible, as is with the case of arranging the OC in the chamber.

In addition, with the exposure apparatus 110, when the wafer loader control unit 90 opens the front door 108 of the FOUP 106 by the open/close mechanism 112 and moves the front door 108 integrally downward with the open/close member 120, the pair of the reflection type substrate detection sensors, 118A and 118B, are used to detect whether the wafers are available in each shelf. That is, in the second embodiment, the wafer loader control unit 90 and the reflection type substrate detection sensors 118A and 118B make up a substrate detection unit. And by this substrate detection unit, the opening/closing of the front door 108 and the detection of the wafer are performed in parallel, therefore, compared with the case when the wafer housed in the FOUP 106 is detected after the opening/closing of the front door 106, the throughput can be improved. Also, in this case, the wafer availability in the shelves of the FOUP 106 can be efficiently detected.

Furthermore, during the operation of closing the front door 108 of the FOUP 106, detection of the wafers (substrate) housed in the FOUP 106 may be performed, in order to confirm whether the desired wafers are all housed or not.

Also, with the exposure apparatus 110 in the second embodiment, as can be seen from FIG. 17, even when further having an inline connection with the C/D, an open space equal to the space necessary to arrange the FOUP 106 is available on the side opposite to where the FOUP 106 (the FOUP mount 104) is arranged within the chamber 12. This space, estimating from the size of the FOUP 104 for 12 inch sized wafers, is around 400 mm in the depth direction (Y direction) and around 600 mm in the width direction (X direction).

The height measurement necessary to arrange the FOUP within the chamber is, the FOUP mount 104 to place the FOUP 106 the height H6 (refer to FIG. 18) above the floor, which is around 900 mm, the height of the FOUP 106 itself around 350 mm, and the open space above the FOUP 106 around 200 mm, that makes the height necessary to arrange the FOUP a total of around 1450 mm above the floor. Accordingly, on the side opposite to where the FOUP 106 (the FOUP mount 104) is arranged within the chamber 12, an open space with a volume around 600 mm×400 mm×1450 mm is available.

Thus, with the exposure apparatus 110, in this free space, an operation unit of the whole exposure apparatus is arranged. According to the SEMIS8-95 guideline, the height of the home key of the keyboard is around 1000 mm above the floor, and the upper edge of the touch screen monitor (arranged in an upright posture) is under around 1400 mm above the floor, which are both within the range of the space available. Accordingly, with this apparatus, a FOUP can be loaded without enlarging the size of the apparatus compared with the apparatus loading the OC, and the operation unit is arranged at the optimum height, from the viewpoint of the front side of the apparatus as well as the human engineering point of view.

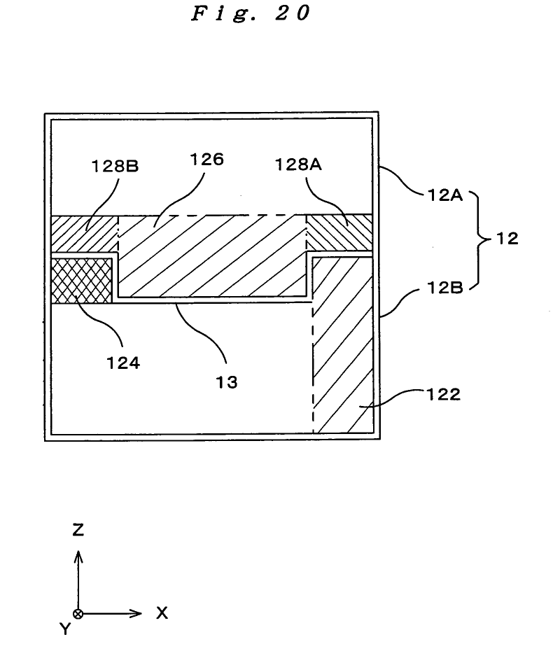

FIG. 20 shows the main space arrangement in the first chamber 12 which structure the exposure apparatus 110 in the second embodiment. As is shown in FIG. 20 with the exposure apparatus 110, the chamber 12 is divided into the upper chamber 12A and the lower chamber 12B by the partition wall 13. This partition wall 13, is set with the height of the central portion lower in the X direction, compared to that of both sides. And, in the space 122 which is located on the +X side and indicated by the slanted lines having a width of around 600 mm×depth around 400×height around 1450 mm, the space to arrange the FOUP 106 is set. And, within the space which is located on the −X side (width around 600 mm, depth around 400 mm, and height around 1450 mm), in the area above around 1000 mm from the floor and over indicated by the criss-cross portion 124, the operation unit of the exposure apparatus is arranged.

In addition, with the exposure apparatus 110, the space 126 shown by rough slanted lines which is in the center of the upper chamber 12 is used for installing and housing the reticle. That is, with the exposure apparatus 110, the space where the loading and unloading of the FOUP 106 is performed and the space where the reticle is installed and housed is set around the same height (the position in the Z direction). Therefore, similarly with setting the FOUP 106, the reticle can be installed under the conditions close to the optimum condition from the human engineering point of view. As the height possible to install the reticle, a height of around 1100 mm to 1650 mm above the floor can be secured which is the same range as of the conventional 8 inch sized wafer in the case of using OC. And, this can sufficiently secure the number of reticles to be installed. The details of the mechanism of the installation and housing of the reticle are disclosed in, for example, Japanese Patent Laid Open 07-130607 and the corresponding U.S. Pat. No. 5,442,163. As long as the national laws in designated states or elected states, to which this international application is applied, permit, the disclosures cited above are fully incorporated herein by reference.

Also, as a mechanism to install and house the reticle, the FOUP and the open/close mechanism to install and house the wafer in this embodiment may be used.

In addition, to house the reticle, the space further above the space 126 may also be used.

In this case, the space 128A, which is above the space 122 where the FOUP is arranged inside the upper chamber 12A, and the space 128B, which is above the space 124 where the operation unit is installed, may be used to install and house the reticle.

Also, the space arrangement within the chamber as described above, and shown in FIG. 20, can likewise be employed in the first embodiment, in the case of using one OC being arranged within the lower chamber of the first chamber 12.

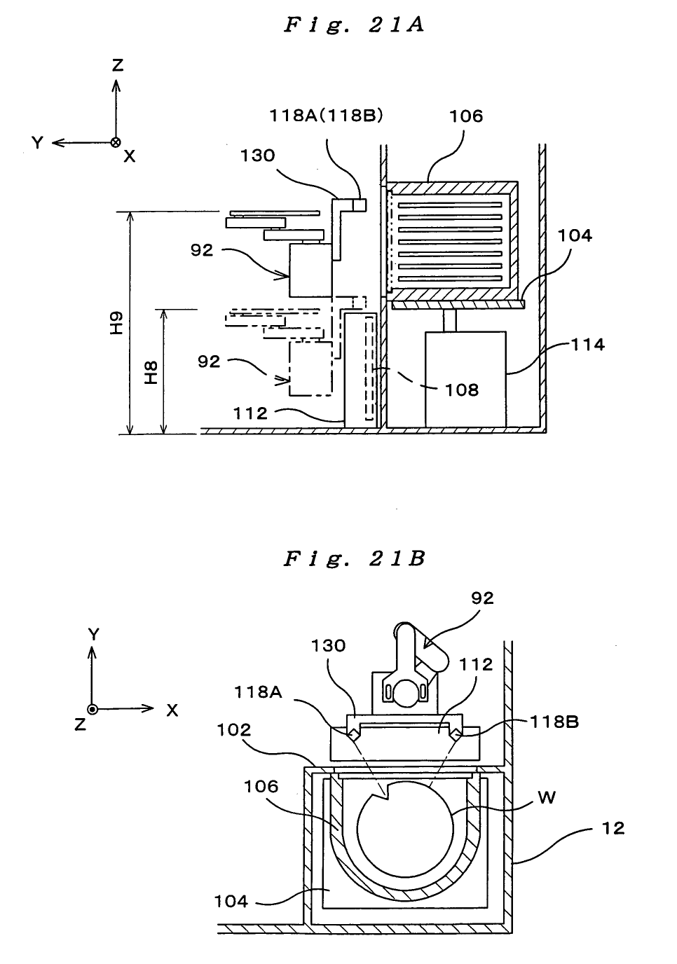

Furthermore, with the second embodiment above, the case has been described where the reflection type substrate detection sensors, 118A and 118B, are arranged on the upper portion of the open/close member 120 which make up the open/close mechanism 112 of the front door 108 of the FOUP 106. And on lowering the front door 108 upon opening, the substrate detection sensors 118A and 118B detect the availability of wafers in each shelf inside the FOUP. However, the present invention is not limited to this, and for example, as shown in FIGS. 21A and 21B, the reflection type substrate detection sensors, 118A and 118B, may be attached to the driving portion of the robot 92 via the sensor supporting mount 130. And the reflection type substrate detection sensors, 118A and 118B, may be made to move vertically in integral with the robot 92. In this case, the substrate detection sensors 118A and 118B are preferably arranged at a height in which the wafers can be detected immediately before the arm of the robot 92 makes access to the wafers in the FOUP 106. With this arrangement, the wafer loader control unit 90 can easily detect the wafer availability and take out the wafer, by using the substrate detection sensors 118A and 118B when (immediately before) the arm of the robot 92 accesses the wafer inside the FOUP 106 to take out the wafer.

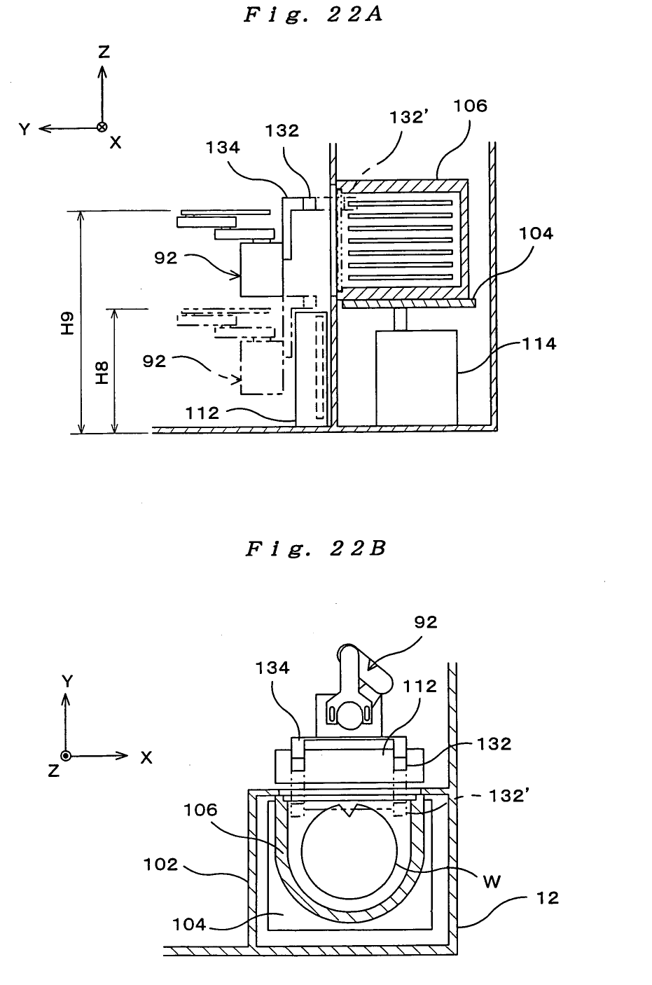

Alternatively, as shown in FIGS. 22A and 22B, a transmittance type substrate detection sensor (transmittance type photosensor) 132, may be attached to the driving portion of the robot 92 via the sensor supporting mount 130. And the substrate detection sensor 132 may be made to move vertically in integral with the robot 92. In this case, the substrate detection sensor 132 is preferably arranged at a height in which the wafers can be detected immediately before the arm of the robot 92 makes access to the wafers in the FOUP 106. And it is also preferably arranged so that it is capable of being relatively driven in the Y direction by a driving system not shown. With this arrangement, the wafer loader control unit 90 can vertically move the robot 92 in a state where the substrate detection sensor 132 is withdrawn at a position in the Y direction shown by a solid line in FIG. 22A. And when the wafer availability is detected, the driving system (not shown in Fig.) may drive the substrate detection sensor 132 so that it is inserted into the FOUP 106, at a position 132′, indicated by an imaginary line. Thus, the wafer availability may be detected immediately before making access to the wafer based on the output of the substrate detection sensor 132.

In addition, with the second embodiment described above, from the viewpoint of improving the throughput, the opening/closing of the front door is performed only when exchanging the FOUP. However, the present invention is not limited to this, and the open/close operation may be performed at predetermined intervals. For example, in the case when the time of the front door 108 opened is preferably reduced to a minimum, the open/close operation may be performed each time the wafer is accessed. That is, the operation sequence of performing the open/close operation two times (once when loading and once when unloading) per wafer may be employed.

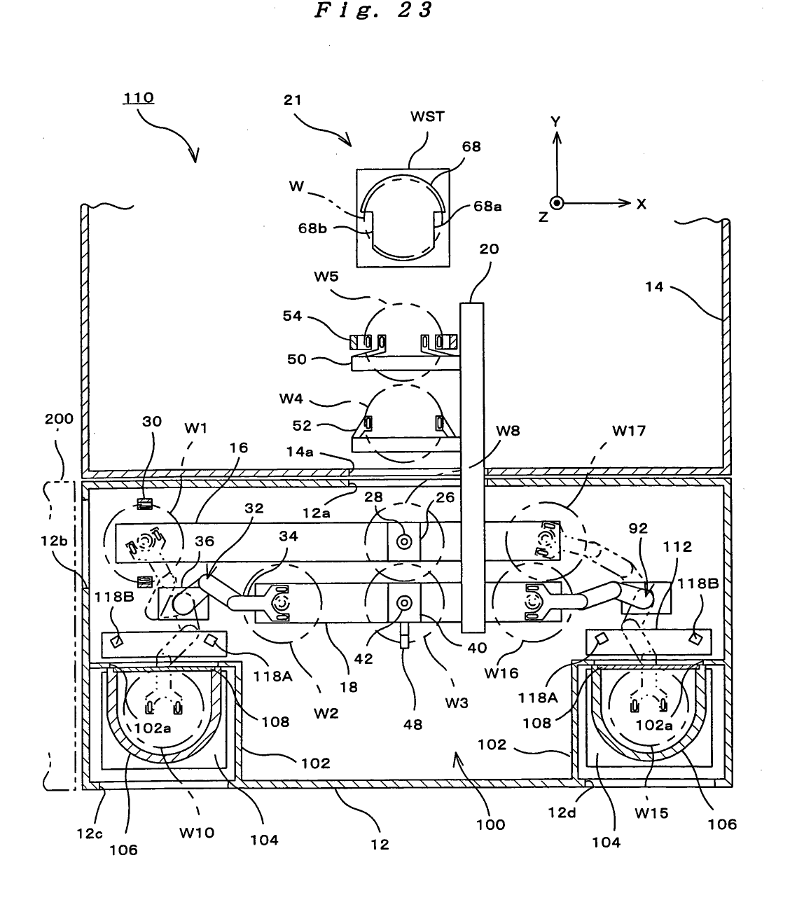

In addition, with the second embodiment described above, the case has been described where one FOUP is arranged within the lower chamber of the first chamber 12. However, by expanding the length in the Y direction of the first chamber 12, a structure can be made to arrange a FOUP 106 up to a maximum of two, as shown in FIG. 23. In this case, the carriage sequence to house the carry the wafer of the FOUP 106 arranged on the left hand side, is the same as the sequence described in the first embodiment, except for the open/close operation of the front door.

As can be seen when comparing FIG. 1 which shows the schematic view of the exposure apparatus 10 in the first embodiment to FIG. 17 (or FIG. 23) which shows the schematic view of the exposure apparatus 110 in the second embodiment, the carrier mount 22B and FOUP 104 serving as container mounts are arranged on the opposite side of the C/D 200 within the first chamber 12, which houses the connecting portion of the C/D 200 to the wafer carriage system 100. And the edges of the second X guide 18 serving as a first carriage guide and the first guide 16 serving as a second carriage guide, are set at positions where they do not reach the front area of the OC24B and the FOUP 106. The first carriage guide is used to carry wafers from the C/D 200, the OC24B and the FOUP 106 mounted on the carrier mount 22B, and the FOUP mount 104 which have not yet completed exposure to the wafer stage WST. Whereas, the second carriage guide is used to carry wafers to the C/D 200, the OC24B and the FOUP 106 which have completed exposure on the carrier mount 22B side and the FOUP mount 104 side. Therefore, in either cases of using the OC or the FOUP, the robot 92 and the like can be arranged in front of the OC24B and FOUP 106. Accordingly, for example, on in line connection with the C/D, using the OC, and using the FOUP, it can be seen that the arrangement of the wafer carriage system and almost all of the carriage sequence (excluding the open/close operation of the front door) can all be shared. Thus, it can be relatively simple to modify an apparatus arranged for the OC into an apparatus arrange for the FOUP.

In addition, the first chamber 12 and the second chamber 14 described in the first and second embodiments, are an example, and the present invention is of course, not limited to this. That is, the wafer carriage system (the substrate carriage system), and the main body of the exposure apparatus can be housed in a single chamber, or alternatively, the first chamber and second chamber and the C/D can be arranged in the X direction. Accordingly, the arrangement of the carriage guide of the substrate carriage system can be modified as appropriate.

<Third Embodiment>

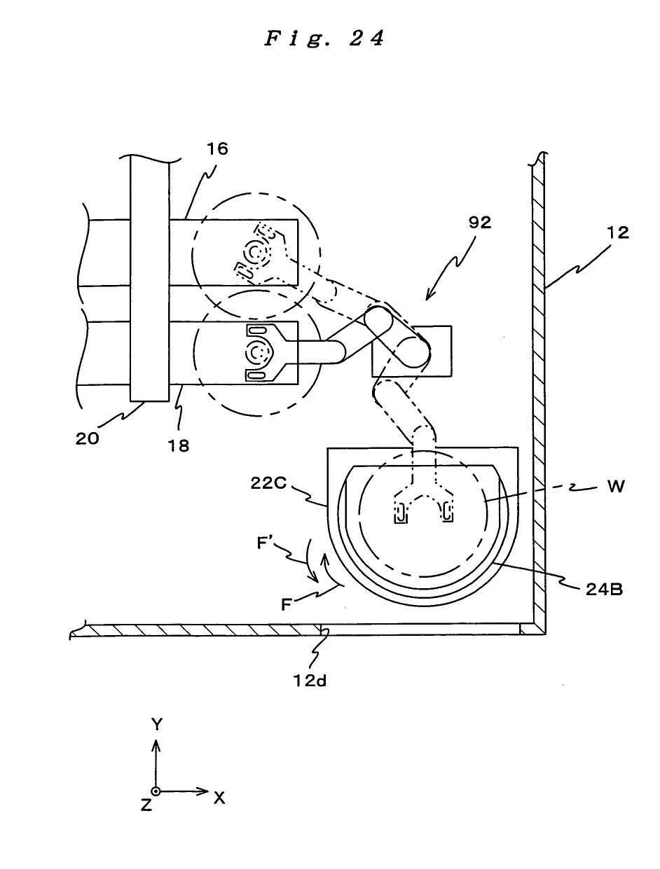

The third embodiment of the present invention will be described below with reference to FIGS. 24 to 27. Structures and components identical or equivalent to those described in the first embodiment are designated with the same reference numerals, and the description thereabout is briefly made or is entirely omitted.

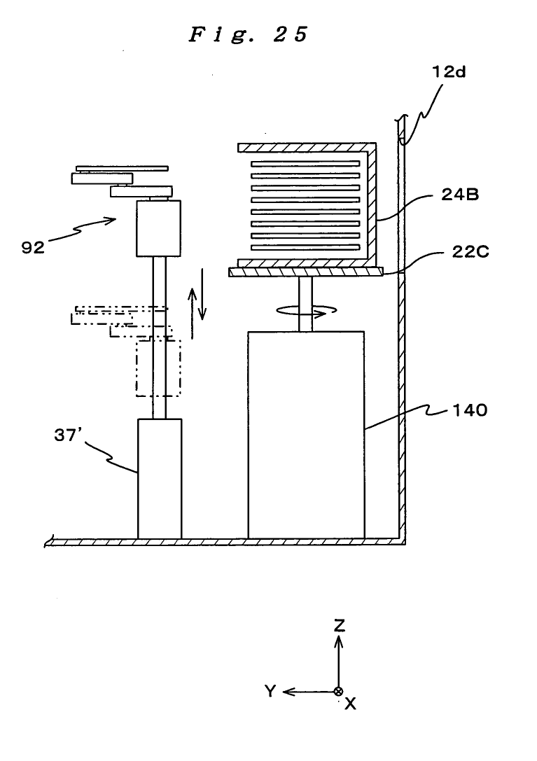

With the exposure apparatus in the third embodiment, instead of the carrier mount 22B described in the first embodiment, a carrier mount 22C which side facing the side wall in the −Y direction is almost a semicircular shape, is arranged. The apparatus is characterized on the point that the carrier mount 22C is arranged within the chamber 12 near the corner, and that a rotation unit 140 to rotate the carrier mount 22C in the F and F′ directions is arranged under the carrier mount 22C. The F and F′ directions, are the clockwise direction and the counter-clockwise direction, as shown in FIG. 24. Structures of other portions are identical to the first embodiment described earlier. The substrate detection sensor is omitted in FIG. 24 and FIG. 25.

In the third embodiment, the robot 92 is driven by the vertical movement mechanism 37′, which is identical to the vertical movement mechanism 37 and is driven in the vertical direction within a range of predetermined strokes.

With the exposure apparatus in the third embodiment having this arrangement, in addition to being able to obtain the effect as is described in the first embodiment, the carrier mount 22C on which the OC24B as a substrate container is placed, can be rotatably driven. Therefore, the loading/unloading direction of the OC24B to the carrier mount 22C can be set in accordance with the free space outside the chamber of the clean room where the exposure apparatus is set, and on consideration of the work efficiency of the loading/unloading. Accordingly, both the space efficiency of the clean room and the work efficiency of loading/unloading the substrate container can be improved at the same time.

Meanwhile, in a lithographic system where a substrate processing unit such as the C/D is connected inline to the exposure apparatus, other than the left inline (right inline) where the C/D is connected to the left (right) side of the exposure apparatus as in the first embodiment, there is a front inline where the C/D is arranged in front of the exposure apparatus.

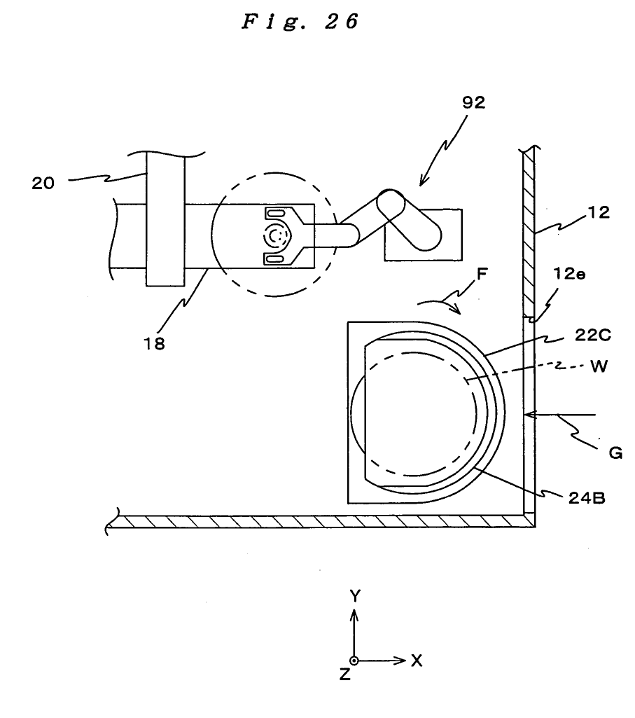

FIG. 26 is a planar view of the neighboring area of the carrier mount 22C, showing the carrier mount 22C, the robot 92, and the like arranged within the chamber 12 of the exposure apparatus that structure the front inline lithographic system. In the case of the exposure apparatus shown in FIG. 26, since the C/D (not shown in Fig.) is arranged on the front side (−Y side) of the chamber 12, it is difficult to build a path for the guided vehicles such as the PGV or AGV. So, with the apparatus in FIG. 26, an opening 12e is arranged in the right side wall to load/unload the OC24B onto the carrier mount 22C, and the OC24B is loaded via the opening 12e from the right side of the apparatus as shown by the arrow G.

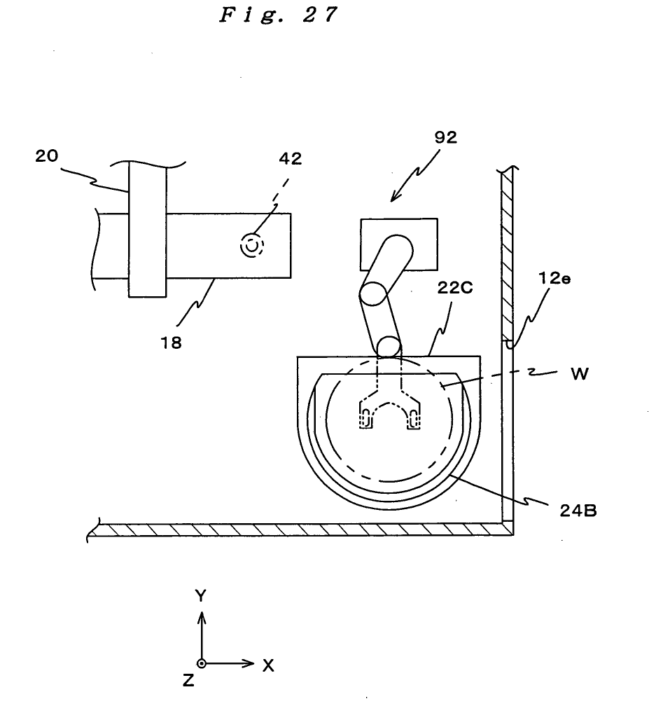

And after the OC24B is delivered onto the carrier mount 22C, the rotation unit 140 is rotated in the arrow F direction at an angle of 90 degrees. By this operation, the wafer loader control unit 90 can use the arm of the robot 92 and have smooth access to the wafer W stored in the OC24B, as shown in FIG. 27.

Thus, the exposure apparatus comprising the carrier mount 22C that has the rotation unit 140, can be made to comply with the left inline, the right inline, and the front inline without hardly changing any structural portions of the wafer carriage system 100. However, the interface portion with the C/D requires modification to some extent, so that the wafers can be exchanged between the C/D. For example, the carrier mount 22A arranged on the left side in the chamber 12, can be removed and replaced by an inline I/F arm.

Furthermore, with the third embodiment described above, the case where the carrier mount is used as a container mount is described. However, the present invention is not limited to this, and a FOUP mount can be used in place of a container mount. In this case, the FOUP mount may be rotatably structured. For example, to the driving system 114 which drives the FOUP mount 104in the Z direction and Y direction previously described referring to FIG. 18, a mechanism to rotate the FOUP mount 104 can be added. By structuring the carrier mount (FOUP mount) rotatable, the wafer carriage system 100 can be made to comply with the left inline, the right inline, and the front inline, without hardly any changes in its structure.

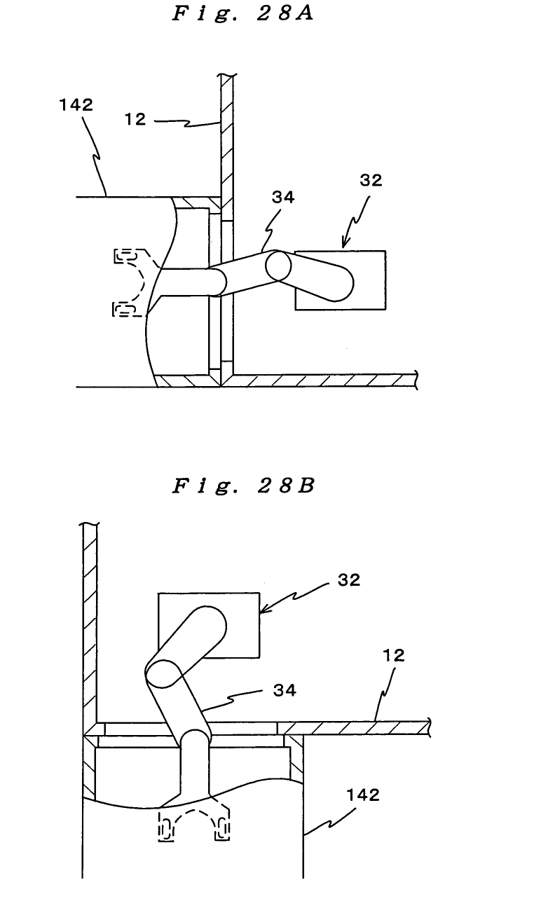

Furthermore, with the first, second, and third embodiment, the case is described where the C/D 200 is directly connected to the chamber 12 by using the inline I/F load arm and the inline I/F unload arm as a substrate delivering portion. However, the connection to the C/D 200 can be made via the inline interface portion. In this case, as shown in FIGS. 28A and 28B, a robot 32 having an arm 34 that freely rotates and expands may be arranged within the corner portion of the chamber 12 on the side where the C/D is to be connected. And the robot 32 may make up the substrate delivering portion, which delivers the wafer between the C/D 200 via the inline interface portion 142. In such a case, even when the inline interface portion 142 is connected to the side of the chamber 12 as in FIG. 28A or to the front as in FIG. 28B, the wafer carriage system 100 and the substrate delivering portion, in short, the structure of the robot 32, can comply without any changes. Furthermore, in this case, the C/D 200 can be connected to the front side (or the sides) of the chamber 12 without going through the inline interface portion 142.

In addition, if an opening to be connected to the C/D 200 and a detachable member to open and close the opening are respectively arranged in the front and the sides of the chamber 12 of the exposure apparatus, then the C/D 200 can be connected to the front and the sides. Likewise, if an opening to make access to the carrier mount (FOUP mount) and a detachable member to open and close the opening are respectively arranged in the front side and the sides of the chamber 12 of the exposure apparatus, the carrier mount (FOUP mount) can be used in common, regardless of the connecting position of the C/D 200.

<<Fourth Embodiment>>

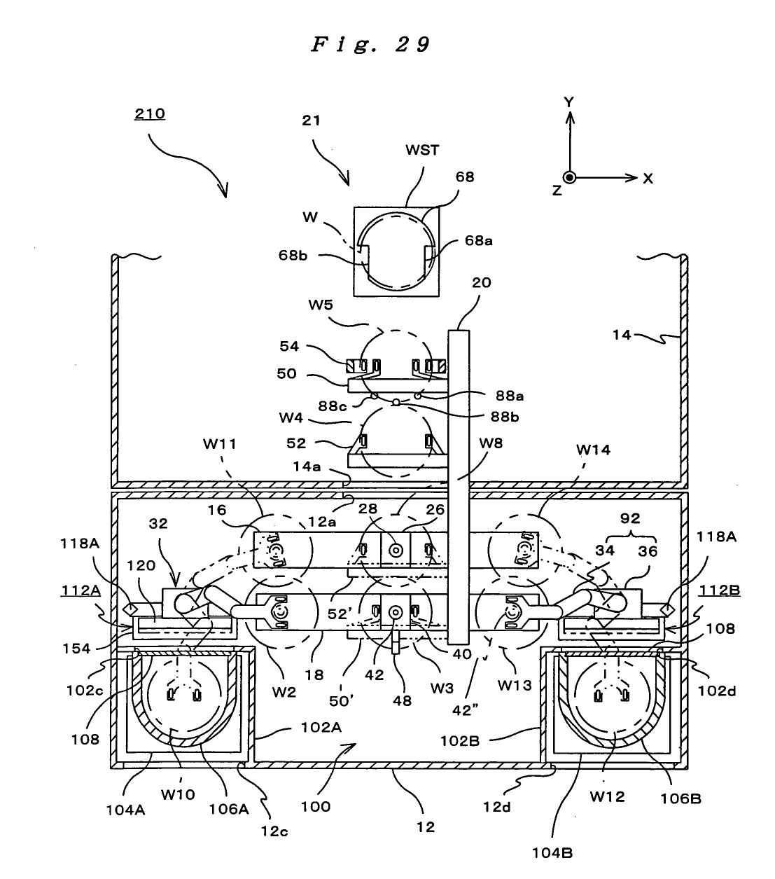

The fourth embodiment of the present invention will be described below with reference to FIGS. 29 to 31. Structures and components identical or equivalent to those described in the first and second embodiments are designated with the same reference numerals, and the description thereabout is briefly made or is entirely omitted.

FIG. 29 schematically shows the sectional view (a planar sectional view) of an exposure apparatus 210 according to the fourth embodiment, focusing on the substrate carriage system. In FIG. 29, the portions such as the air conditioning system are omitted, and, in the main body 21 of the exposure apparatus, only the wafer stage WST is illustrated.

The exposure apparatus 210 differs from the exposure apparatus in the first and second embodiment on the point that it is a so-called stand-alone specification. Therefore, the arrangement of the wafer carriage system differs slightly from the exposure apparatus 10 in the first embodiment. With the exposure apparatus 210, the edge of the first X guide 16 in the −X direction is slightly off at a position on the +X side in respect to the edge of the FOUP mount 104A on one side of the X direction (+X direction). The FOUP mount 104 is arranged on the left side in FIG. 29. Also, the inline I/F load arm and the like are not arranged in the exposure apparatus 210.

Also, with the exposure apparatus 210, two FOUP mounts 104A and 104B are arranged as container mounts inside the chamber 12, and accordingly, two L shaped partition walls 102A and 102B are formed within the chamber 12. FOUP mount 104A and 104B, which differ from the FOUP mount 104 previously described, slide in the Y direction, but cannot be driven vertically. Therefore, the height of the opening 102c and 102d formed in each of the partition walls 102A and 102B differ from that of the second embodiment.

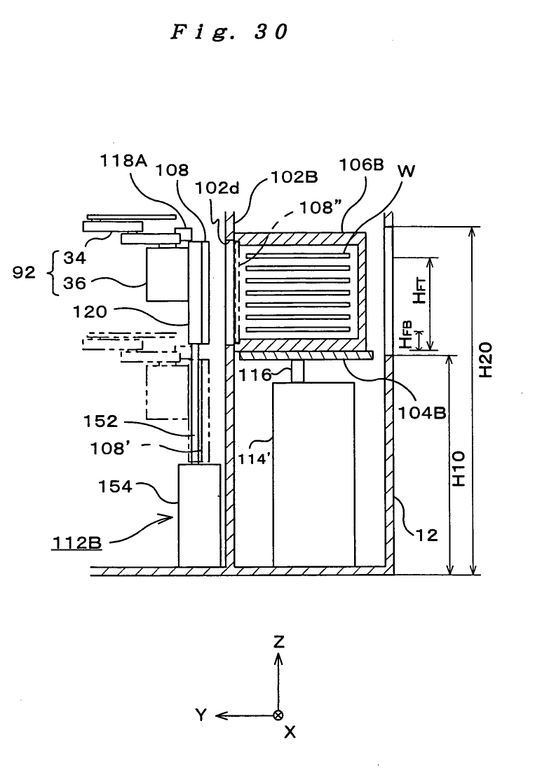

That is, as shown in FIG. 30, the opening 102d is formed in the partition wall 102B from a height H10 (H10, here is around 900 mm) above the floor up to around a height slightly lower than the height H20 (H20 is around 1200 mm). The opening 102c, similarly with the opening 102d, is formed in the partition wall 102A from a height H10 above the floor up to around a height slightly lower than the height H20.

Furthermore, with the exposure apparatus 210, instead of an open/close mechanism 112 of the front door of the FOUP described earlier, a pair of open/close units 112A and 112B (openers) is arranged.

More particularly, as shown in FIG. 29, these open/close units 112A and 112B (openers) are arranged at positions which cover the +Y side of the partition wall 102A and 102B and on one end and the other end in the X axis direction of the second X guide 18.

On the other hand, as shown in FIG. 30, the FOUP mount 104B is fixed on the upper surface of the driving shaft 116 which is driven in the Y direction by the slide mechanism 114′ fixed on the floor of the chamber 12. The wafer loader control unit 90, described earlier controls the slide mechanism 114′. Alternatively, the stage control unit 69 may of course control the slide mechanism 114′. The other FOUP mount 104A also has a structure identical to that of the FOUP mount 104B.

The open/close unit 112B, being one of the pair, comprises an open/close member 120 that vacuum chucks or mechanically connects and becomes engaged with the front door 108 as well as opens the key (not shown in Fig) arranged on the front door 108, as in shown FIG. 30. It also comprises a driving shaft 152 to where the open/close member 120 is attached, and a vertical/sliding mechanism 154 that drives the driving shaft 152 in the vertical and Y-axis direction, in other words, in the direction moving closer or withdrawing from the FOUP mount 104B.

Details of the method similar to the open/close operation of the open/close unit 112B are disclosed in, for example, the Japanese Patent Laid Open No. 08-279546, referred to earlier. In a normal state (when the FOUP is not set), the open/close member 120 is fitted into the opening 102d to close the opening 102d so that the inner side of the partition wall 102 is not in an exposed state to the outside.

Furthermore, in this embodiment, a horizontal jointed arm robot (a scalar robot) 92, is integrally arranged on the back of the open/close member 120 that makes up the open/close unit 112B. The horizontal jointed arm robot (hereinafter referred to as “robot” as appropriate) 92, comprises an arm 34 which freely extends and rotates within the XY plane, serving as a carriage arm, and a driving portion 36 that drives the arm 34. In this embodiment, the driving portion 36 is attached to the open/close member 120. In this case, the arm 34 is positioned so that it is a predetermined distance (the minimum distance required so that access to the wafers within the FOUP 106B is possible) above the open/close member 120.

In this embodiment, the robot 92 (that is, the arm 34) is integrally driven with the open/close member 120 in the vertical direction and in the Y-axis direction, by the vertical/sliding mechanism 154.

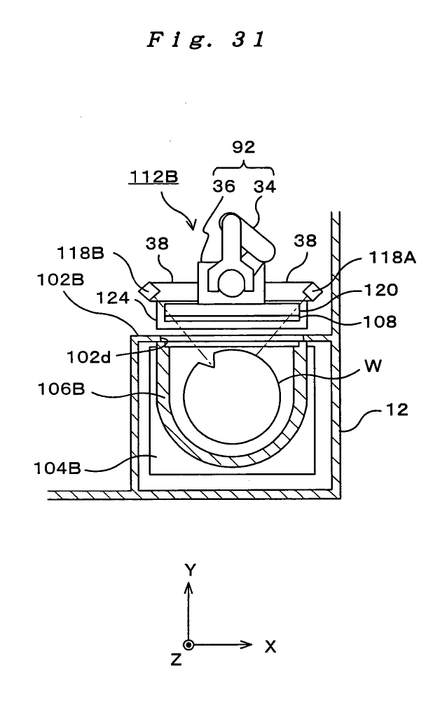

Furthermore, a pair of substrate detection sensors 118A and 118B of the reflection type is respectively fixed to the driving portion 36 of the robot 92 via a pair of supporting members 38, as is shown in the planar view in FIG. 31.

The other open/close unit 112A, likewise with the open/close unit 112B, comprises an open/close member 120, a driving shaft (not shown in Fig.) to where the open/close member 120 is attached, and a vertical/sliding mechanism 154 that drives the driving shaft 152 in the vertical and Y-axis direction, in other words, in the direction moving closer or withdrawing from the FOUP mount 104A. Also, similar to the description above, the robot 32 is integrally attached to the open/close member 120, and is integrally driven with the open/close member 120 in the vertical direction and in the Y-axis direction, by the vertical/sliding mechanism 154. Furthermore, on the driving portion of the robot 32, a pair of substrate detection sensors, 118A and 118B, of the reflection type, is respectively fixed via the supporting members (refer to FIG. 29).

The other portions of the main body 21 of the exposure apparatus, and structures of the other portions, are similar to the first and second embodiment, described above. Accordingly, the wafer carriage sequence is basically the same as of the case when the OC is used to house and carry the wafer in the first embodiment. Likewise, the open/close operation sequence of the front door of the FOUP is similar as of the case when the FOUP is used to house and carry the wafer in the second embodiment.

However, as is described earlier, this embodiment differs on the point such as, the open/close operation of the front door 108 of the FOUP 104A and 104B is performed at the height where the FOUP 106A and 106B are positioned on the FOUP mount 104A and 104B. It also differs on the point in which the front door 108 moves vertically together during the open/close operation of the front door 108 or when accessing to the wafers inside the FOUP 106A and 106B.

According to the exposure apparatus 210 in this embodiment, as is obvious from FIG. 29 and the descriptions so far, the exposure apparatus 210 can be used as an apparatus employing the OC without any modifications. This is because, in this embodiment, the robot 32 and 92 are arranged on the open/close unit 112A and 112B, and moreover, the open/close member 120 is arranged at a position where it does not interfere with the rotation and extension of the arm 34. This consequently allows the arm 34 of the robot 32 and 92 to take out the wafer housed in the OC placed on the container mount, and also allow the wafer to be returned inside the OC. In addition, it is because the wafer carriage sequence when employing the OC is the same when employing the FOUP, excluding the point of the open/close operation of the front door 108.

Also, with the exposure apparatus 210 in this embodiment, the open/close member 120 that performs open/close operation of the front door 108 of the FOUP 106A and 106B and the robot 32 and 92 having the arm 34, are integrally driven by the vertical/sliding mechanism 154 via the driving shaft 152 in the vertical direction and in the Y-axis direction. Accordingly, when taking out the wafer from the FOUP 106A and 106B, or putting back the wafer into the FOUP 106A and FOUP 106B, the following parallel operations can be simultaneously performed.

That is, the opening operation of the front door 108 is a combination of lowering the front door and moving it in the +Y direction. Whereas, the closing operation of the front door 108 is a combination of raising the front door and moving it in the −Y direction. Accordingly, for example, when the front door is closed and a wafer is to be taken out of the FOUP 106A and 106B, the arm 34 can be inserted into the FOUP 106A and 106B while the front door is being opened (downward movement). The arm 34 is then slightly moved upward with the robot 32, 92 and the open/close member 120 so as to mount the wafer on the arm 34. And by withdrawing the arm 34 holding the wafer from the FOUP 106A and 106B and moving downward in parallel for a predetermined period of time, it becomes possible to take out the wafer W while performing the opening operation of the front door 108. The velocity of the front door 108 (and the robot 32 and 92) moving downward during the predetermined period of time, is set to an extent where the arm 34 withdrawing does not interfere with the obstacle below the wafer which is taken out (a neighboring wafer housed below or the bottom wall inside the FOUP 106A and 106B, to be more specific). It is preferable from the viewpoint of improving the throughput, that this velocity is set at a maximum speed in which the arm 34 does not come into contact with the obstacle below in consideration of the time required to take out the wafer.

And, when the arm 34 holding the wafer withdraws completely from the FOUP 106A and 106B, the arm 34 performs the remaining operation (including the downward movement of the robot 32 and 92, in other words the front door 108) to carry the wafer to the position W13 and W2 in FIG. 29, shown by an imaginary line.

In addition, for example, on putting the wafer into the FOUP 106A and 106B, while the front door 108 is being closed by driving the robot 32, 92 and the open/close member 120 upward, the arm 34 holding the wafer is inserted into the FOUP 106A and 106B. The robot 32, 92 and the open/close member 120 is then driven slightly downward, and the wafer is housed into the predetermined shelf. Then the front door 108 is driven upward a predetermined period of time, and in parallel with this operation, the arm 34 is withdrawn completely from the FOUP, allowing the wafer to be put in while closing the front door 108. The velocity of the front door 108 (and the robot 32 and 92) moving upward during the predetermined period of time, is set to an extent where the arm 34 withdrawing does not interfere with the obstacle above the wafer which is put in (a neighboring wafer housed above or the upper wall inside the FOUP 106A and 106B, to be more specific). It is preferable from the viewpoint of improving the throughput, that this velocity is set at a maximum speed in which the arm 34 does not come into contact with the obstacle above in consideration of the time required for the arm 34 to withdraw.

As is described, in this embodiment, the open/close operation of the front door 108 of the FOUP 106A and 106B is partially performed in parallel with the operation of taking out or putting back a desired wafer with the arm 34. So the time required opening or closing the front door 108 and the time required taking out or putting in the wafer partially overlap. Therefore, compared with the case when the open/close operation of the front door 108 is performed temporally separate with the operation of taking out or putting back the wafer, the time required taking out or putting in the wafer into the FOUP 106A and 106B can be reduced.

Furthermore, an arrangement different from this embodiment is possible. For example, the open/close member and the arm of the robot can be driven independently and the driving portion 36 of the robot 32 and 92 may vertically move the arm 34. That is, the driving mechanism of the open/close member 120 and the arm 34 can be made up of the vertical/sliding mechanism 154 and the driving portion 36. In such a case, parallel operations become possible, such as, when taking out a wafer from the FOUP 106A and 106B, the front door 108 can start to close while taking out the wafer with the arm 34. And, when putting in a wafer into the FOUP 106A and 106B, the wafer can be put in with the arm 34 while the front door 108 is being opened.

Also, with the exposure apparatus 210 in this embodiment, the open/close member that is engaged with the front door 108 performs vertical movement, in integral with the robot 32 and 92. So, naturally, when taking out or putting in the wafer the front door 108 is opened (not always fully opened) to a position corresponding to the wafer being taken out or put in, and the arm 34 is moved in the horizontal direction to take out or put in the wafer. Therefore, the time required to start taking out the wafer or the time required to start putting in the wafer, and the possibility of dust and small particles generated by the vertical movement of the robot from entering the FOUP 106A and 106B can be reduced, compared with the case when the FOUP 106A and 106B are fully opened at all times when the wafer is taken out or put in into the FOUP 106A and 106B.

In addition, according to this embodiment, the arm 34 provided in the wafer carriage system 100 serving as a carriage arm which performs delivery of the wafer into and out of the FOUP 106A and 106B, is attached respectively to the open/close unit 112A and 112B performing open/close operation of the front door 108. Therefore, as is obvious in FIG. 29, the space consumed can be reduced compared to when the open/close unit and the carriage arm are arranged separately. Thus, the size in the depth direction can be reduced, and it becomes possible to employ the most appropriate layout, and at the same time to greatly improve the space efficiency of the clean room.

Also, with the exposure apparatus 210 according to this embodiment, when the wafer loader control unit 90 (or the stage control unit 69) is to take out the wafer shelved at the very bottom of the FOUP 106A and 106B, and the front door 108 is opened by the open/close unit 112A and 112B, the reflection type substrate detection sensor 118A and 118B is moved downward integrally with the open/close member and the front door 108. During this operation, the wafer loader control 90 uses the reflection type substrate detection sensor 118A and 118B to detect the availability of wafers in each shelf of the FOUP 106A and 106B. That is, in this embodiment, the wafer loader control unit 90 and the reflection type substrate detection sensor 118A and 118B make up a substrate detection unit, and this substrate detection unit detects the availability of the wafers in parallel with the front door 108 being opened. Thus, the throughput can be improved compared with the case when the wafers in the FOUP 106A and 106B are detected after the front door 108 has been fully opened.

Furthermore, with the fourth embodiment above, the case is described where a wafer is used as a substrate, however the present invention is not limited to this, and as the substrate a square-shaped substrate such as a glass plate used for liquid crystal display panels can be used.

That is, the present invention is applicable, even in the case when an open/close type container which houses a plurality of square-shaped substrates is arranged inside the chamber of the exposure apparatus for liquid crystal displays to improve the degree of cleanliness. In the case of the exposure apparatus for liquid crystal displays, depending on the apparatus the mask and the square-shaped substrate are held perpendicular upon exposure, so in correspondence with this apparatus a plurality of square-shaped substrates may be housed in the container with predetermined intervals in the horizontal direction. In such a case, the driving mechanism to drive the open/close member of the container in the direction moving toward or moving away from the container and in the direction of the square-shaped substrates shelved in the container can be arranged on the open/close unit of the door. With this arrangement, the substrate carriage method related to the present invention can be suitably applied, likewise with the embodiment described above.

Furthermore, the operation sequence of performing the open/close operation of FOUP with the open/close member 120 and a part of the carriage operation with the carriage arm 34 in parallel can also be employed in the second embodiment. That is, in the fourth embodiment, the vertical/sliding mechanism 154 functions also as the driving unit of the open/close member 120 of the FOUP and the carriage arm 34. However, even in the case of having a separate mechanism, as in the second embodiment, the operation sequence of the open/close operation of FOUP with the open/close member 120 and a part of the carriage operation with the carriage arm 34 can be performed in parallel, and thus the throughput can be improved.

Furthermore, in the first to fourth embodiment, the case is described when the main body 21 of the exposure apparatus performs scanning exposure based on the step-and-scan method, that is, the case when the present invention is applied to the scanning stepper. However, the scope of the present invention applied is not limited to this. For example, the present invention can be applied to: a static type exposure apparatus which transfers a reticle pattern onto a wafer based on the step-and-repeat method; an optical exposure apparatus such as a proximity exposure apparatus which transfers a mask pattern onto a substrate by closely arranging the mask and substrate without using a projection optical system; an EB exposure apparatus; an X-ray exposure apparatus; and other types of exposure apparatus comprising a stage to hold a substrate, regardless of the method of exposure and the type of apparatus. In addition, the usage of the exposure apparatus may be widely applied, for example to an exposure apparatus to manufacture a pick up device (such as a CCD) or a thin-film magnetic head, and is not limited to the exposure apparatus to manufacture a semiconductor device or the exposure apparatus for a liquid crystal display which transfers a liquid crystal display device pattern onto a square-shaped glass plate. Also, the projection optical system is not limited to a reduction system, and an equal magnifying system as well as an enlarged system may be used.

Furthermore, as the light source of the exposure apparatus, cases of using a g line (436 nm), an i line (365 nm), a KrF excimer laser beam (248), an ArF excimer laser beam (193 nm), and an F₂ laser beam (157 nm), were exemplified. However, the present invention is not limited to this, and a charged particle beam such as an X-ray or an electron beam may be used. For example, in the case of using an electron beam, as the electron gun a thermionic emission type lanthanum hexaboride (LaB₆) or a tantalum (Ta) can be used. However, an appropriate arrangement of the projection optical system or glass material is required, depending on the light source. For example, when using a far ultraviolet light such as an excimer laser beam, materials such as quartz or fluorite having transmittance to the far ultraviolet light is used as the glass material for the projection optical system. And in the case of using an F₂ laser beam or an X-ray, the projection optical system is to be an optical system of a reflection refraction system or a reflection system. For example, with an EUV exposure apparatus, an all reflection type optical system is used as well as a reflective type reticle. Also, in the case of using an electron beam, as the optical system an electron optical system made up of an electron lens and deflection units can be used. Needless to say, the optical path of the electron beams is to be maintained at a vacuumed state.

With the embodiment above, the wafer stage and the reticle stage are driven by a magnetic levitation two-dimensional linear actuator, however, the present invention is not limited to this. As a stage driving system, a linear motor may be used, which details are disclosed in, U.S. Pat. No. 5,623,853 and U.S. Pat. No. 5,528,118. In such a case, a linear motor of an air levitation type by air bearings or a magnetic levitation type by the Lorentz force or a reactance force can be used. As long as the national laws in designated states or elected states, to which this international application is applied, permit, the disclosures cited above are fully incorporated herein by reference.

Also, the stage may be of a type to move along a guide, or a guideless type, which does not require a guide.

Furthermore, the reaction force generated by the movement of the wafer stage may be released to the floor (ground) using a frame member, as is disclosed, for example, in Japanese Patent Laid Open No. 08-166475 and the corresponding U.S. Pat. No. 5,528,118. As long as the national laws in designated states or elected states, to which this international application is applied, permit, the disclosures cited above are fully incorporated herein by reference.

In addition, the reaction force generated by the movement of the reticle stage may be released to the floor (ground) using a frame member, as is disclosed, for example, in Japanese Patent Laid Open No. 08-330224 and the corresponding U.S. patent application Ser. No. 08/416,558. As long as the national laws in designated states or elected states, to which this international application is applied, permit, the disclosures cited above are fully incorporated herein by reference.

In addition, the reaction force generated by the movement of the stage may be removed by relatively moving the mover and stator of the electromagnetic motor which drives the stage in opposite directions in respect to the base plate, as is disclosed, for example, in Japanese Patent Laid Open No. 08-63231 and the corresponding U.S. patent application Ser. No. 09/260,544. As long as the national laws in designated states or elected states, to which this international application is applied, permit, the disclosures cited above are fully incorporated herein by reference.

The exposure apparatus in each embodiment described above, is made by assembling various subsystems including elements defined in the claims of the present application so as to keep a predetermined mechanical precision, electrical precision, and optical precision. In order to ensure these areas of precision, various optical systems, various mechanical systems, and various electrical systems are adjusted to attain a predetermined optical precision, mechanical precision, and electrical precision, respectively, prior to and after the assembly. The process of incorporating various subsystems into an exposure apparatus includes mechanical connection of various subsystems, by wiring electrical circuits, piping pressure circuits, and the like. Obviously, before the process of incorporating various subsystems into an exposure apparatus, the process of assembling the respective subsystem is performed. After the process of assembling various subsystems into the exposure apparatus, total adjustment is performed to ensure preciseness in the overall exposure apparatus. The exposure apparatus is preferably made in a clean room in which temperature, degree of cleanliness, and the like are controlled.

The embodiments above are described using an exposure apparatus. However, in regard to the substrate carriage method using the inline connection, the open carrier, and the FOUP, and the substrate carriage apparatus, the present invention is suitably applied not only to an exposure apparatus but also other device manufacturing apparatus such as an inspection apparatus.

<<Device Manufacturing Method>>

A device manufacturing method using the lithographic system (exposure apparatus) described above in a lithographic process will be described next in detail.

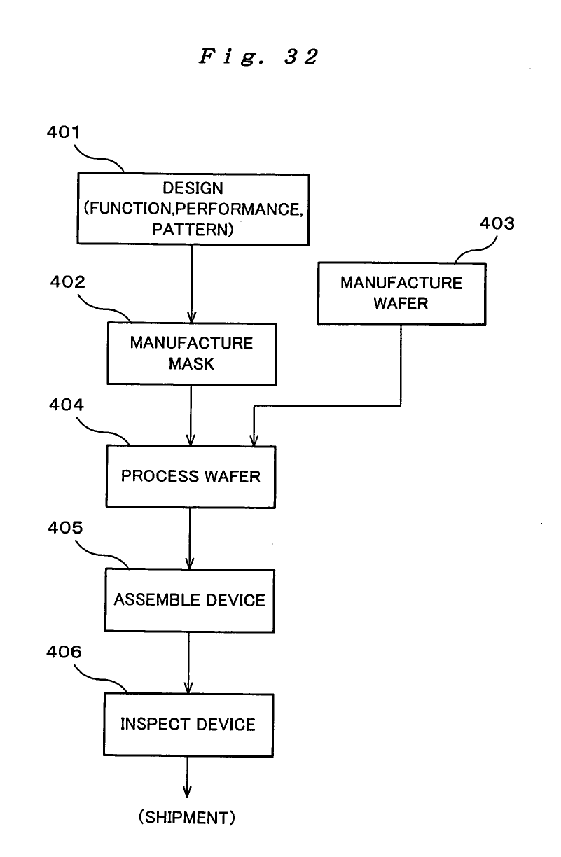

FIG. 32 is a flow chart showing an example of manufacturing a device (a semiconductor chip such as an IC or LSI, a liquid crystal panel, a CCD, a thin magnetic head, a micromachine, or the like). As shown in FIG. 32, in step 401 (design step), function/performance is designed for a device (e.g., circuit design for a semiconductor device) and a pattern to implement the function is designed. In step 402 (mask manufacturing step), a mask on which the designed circuit pattern is formed is manufactured. Instep 403 (wafer manufacturing step), a wafer is manufacturing by using a silicon material or the like.

In step 404 (wafer processing step), an actual circuit and the like are formed on the wafer by lithography or the like using the mask and wafer prepared in steps 401 to 403, as will be described later. In step 405 (device assembly step), a device is assembled by using the wafer processed in step 404. Step 405 includes processes such as dicing, bonding, and packaging (chip encapsulation).

Finally, in step 406 (inspection step), a test on the operation of the device, durability test, and the like are performed. After these steps, the device is completed and shipped out.

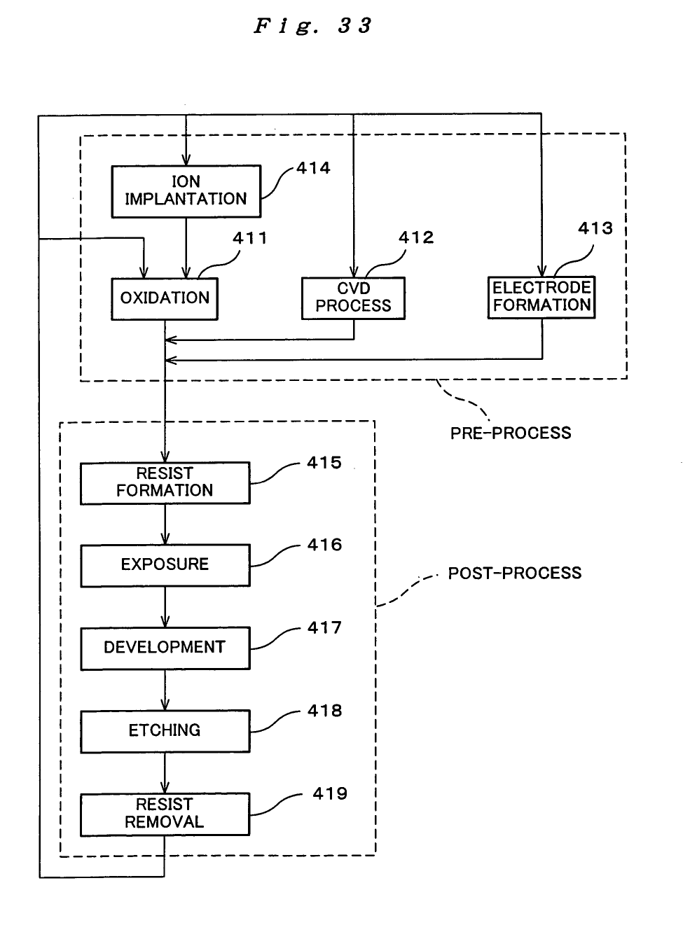

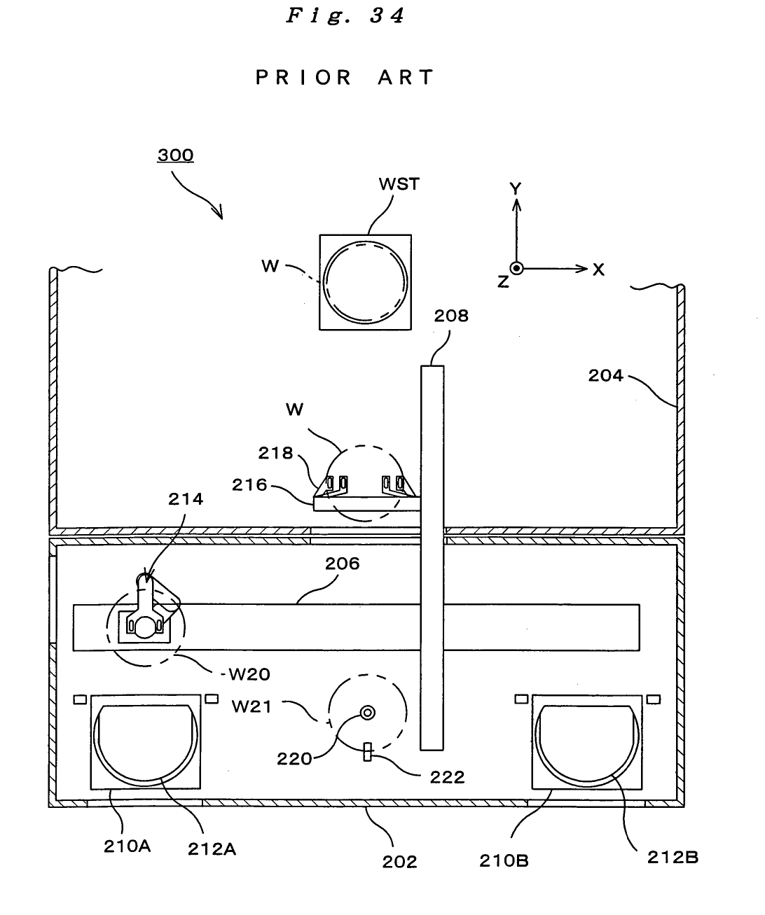

FIG. 33 is a flow chart showing a detailed example of step 404 described above in manufacturing the semiconductor device. Referring to FIG. 33, in step 411 (oxidation step), the surface of the wafer is oxidized. In step 412 (CVD step), an insulating film is formed on the wafer surface. In step 413 (electrode formation step), an electrode is formed on the wafer by vapor deposition. In step 414 (ion implantation step), ions are implanted into the wafer. Steps 411 to 414 described above constitute a pre-process for the respective steps in the wafer process and are selectively executed in accordance with the processing required in the respective steps.

When the above pre-process is completed in the respective steps in the wafer process, a post-process is executed as follows. In this post-process, first, in step 415 (resist formation step), the wafer is coated with a photosensitive agent. Next, as in step 416, the circuit pattern on the mask is transcribed onto the wafer by the above exposure apparatus and method. Then, in step 417 (developing step), the exposed wafer is developed. In step 418 (etching step), an exposed member on a portion other than a portion where the resist is left is removed by etching. Finally, in step 419 (resist removing step), the unnecessary resist after the etching is removed.

By repeatedly performing these pre-process and post-process, multiple circuit patterns are formed on the wafer.

As described above, by using the device manufacturing method of this embodiment, the exposure apparatus and exposure method described in each embodiment above are used in the exposure process (step 416). This makes it possible to manufacture devices such as semiconductor devices at a lower cost.

### INDUSTRIAL APPLICABILITY

As is described, the exposure apparatus related to the present invention is suitable to transfer a circuit pattern of a microdevice such as an integrated circuit onto a substrate in a lithographic process. In addition, the device manufacturing method related to the present invention is suited to manufacture a device having a fine pattern.

What is claimed is:

1. An exposure apparatus that is inline connected with a substrate processing unit, said exposure apparatus comprising in its interior a substrate delivering portion which performs delivery of a substrate between said substrate processing unit.

2. An exposure apparatus according to claim 1, wherein said substrate delivering portion performs delivery of said substrate between a substrate carriage arm of said substrate processing unit.

3. An exposure apparatus according to claim 2, wherein said substrate delivering portion includes at least an inline interface load arm which performs delivery of said substrate to be exposed between said substrate carriage arm.

4. An exposure apparatus according to claim 3, wherein said substrate delivering portion further includes an inline interface unload arm which performs delivery of said substrate having completed exposure between said substrate carriage arm.

5. An exposure apparatus according to claim 4, wherein said inline interface unload arm is arranged almost directly below said inline interface load arm.

6. An exposure apparatus according to claim 1, said exposure apparatus further comprising:
a substrate stage on which a substrate subject to exposure is mounted; and
a substrate carriage system which carries said substrate in respect to said substrate stage, wherein
said substrate delivering portion is arranged within a chamber where a connecting portion of said substrate processing unit in said substrate carriage system is housed.

7. An exposure apparatus according to claim 6, wherein said substrate delivering portion is a robot arranged in a cornered portion of said chamber on a side where said substrate processing unit is to be connected, and comprises an arm that rotates and extends/folds freely.

8. An exposure apparatus that is inline connected with a substrate processing unit, said exposure apparatus comprising:
a substrate stage on which a substrate subject to exposure is mounted;
a substrate carriage system which carries said substrate in respect to said substrate stage; and
a container mount arranged on an opposite side of said substrate processing unit in a chamber where a connecting portion of said substrate processing unit to said substrate carriage system is housed, said container mount being a mount to place a substrate container which houses said substrate.

9. An exposure apparatus according to claim 8, wherein said substrate carriage system includes
a first carriage guide which guides said substrate to be exposed respectively from said substrate processing unit and said container placed on said container mount toward said substrate stage, and
a second carriage guide which guides said substrate having completed exposure respectively to said substrate processing unit and said container, wherein
an edge of said first carriage guide and said second carriage guide arranged on a side of said container mount is set out of reach to the front area of the container mount.

10. An exposure apparatus according to one of claims 8 and 9, wherein said container mount is a mount to place an open type container.

11. An exposure apparatus according to one of claims 8 and 9, wherein said container mount is a mount to place an open/close type container which houses a plurality of substrates having a predetermined interval in a vertical direction, said open/close type container in which an opening is formed only in front comprising a cover to open/close said opening.

12. An exposure apparatus according to claim 8, wherein said exposure apparatus further comprises a rotation unit that rotatably drives said container mount.

13. An exposure apparatus according to any one of claims 1, 2, 3, 4, 5, 6, 7, 8, 9, and 12, wherein said substrate processing unit is a coater developer.

14. An exposure apparatus that transfers a predetermined pattern onto a substrate, said exposure apparatus comprising:
a substrate stage on which a substrate subject to exposure is mounted;
a rotation table which rotatably holds said substrate and moves in a predetermined direction, said rotation table making up a part of a substrate carriage system which carries said substrate in respect to said substrate stage.

15. An exposure apparatus according to claim 14, wherein said exposure apparatus further comprises a positional deviation detection unit which detects a positional deviation of said substrate rotating on said rotation table when moving in said predetermined direction.

16. An exposure apparatus according to claim 14, wherein said exposure apparatus further comprises a peripheral exposure unit which is integrally arranged movable in said predetermined direction with said rotation table, said peripheral exposure unit exposing a peripheral of said substrate rotating on said rotation table.

17. An exposure apparatus according to claim 16, wherein said peripheral exposure unit exposes said peripheral of said substrate rotating on said rotation table when moving in said predetermined direction.

18. An exposure apparatus according to claim 16, wherein said peripheral exposure unit includes a positional deviation detection function that detects a positional deviation of said substrate.

19. An exposure apparatus according to one of claims 15 and 18, wherein said substrate carriage system further comprises a position correction system which corrects said positional deviation of said substrate detected while said substrate is being carried.

20. An exposure apparatus according to claim 19, wherein
said substrate carriage system comprises a substrate carriage arm which receives said substrate from said rotation table and moves in a direction perpendicular to a moving direction of said rotation table, said moving direction being said predetermined direction, and
said position correction system corrects said positional deviation of said substrate in a two dimensional direction, by correcting a position of said rotation table and by correcting a position of said substrate carriage arm.

21. An exposure apparatus according to claim 20, wherein said position correction system corrects said positional deviation of said substrate in a rotational direction by rotating said rotation table.

22. An exposure apparatus comprising:
a substrate stage on which a substrate subject to exposure is mounted;
a substrate carriage system which carries said substrate in respect to said substrate stage;
a container mount on which a container housing said substrate is placed; and
a driving unit which drives said container mount downward from a first position to a second position prior to starting an exposure process on said substrate housed in said container.

23. An exposure apparatus according to claim 22, wherein said exposure apparatus further comprises a carriage arm which moves in a vertical direction in respect to said container mount so as to make access to said substrate housed in said container after said container mount is lowered to said second position.

24. An exposure apparatus according to claim 22, wherein said exposure apparatus further comprises a substrate detection unit that detects said substrate housed within said container when said container mount is being lowered.

25. An exposure apparatus comprising:
a substrate stage on which a substrate subject to exposure is mounted;
a container mount on which a container housing said substrate is placed;
a substrate carriage system which carries said substrate between said substrate stage and said container; and
a substrate detection unit which relatively moves in respect to said container mount and detects said substrate housed within said container during a carriage sequence of said substrate by said substrate carriage system.

26. An exposure apparatus according to claim 25, wherein
said container is an open/close type container in which an opening is formed only in front and comprises a cover to open/close said opening, and
said substrate detection unit detects said substrate housed in said container when said cover is moved to open said cover.

27. An exposure apparatus according to claim 25, wherein said substrate carriage system comprises a robot which loads and unloads said substrate in respect to said container, and said substrate detection unit detects said substrate when said robot moves.

28. An exposure apparatus according to claim 27, wherein said container houses a plurality of said substrates having a predetermined interval in a vertical direction, said container being an open/close type container in which an opening is formed only in front and comprising a cover to open/close said opening.

29. An exposure apparatus according to claim 28, wherein said substrate detection unit comprises a transmittance type photosensor that has access inside said container.

30. An exposure apparatus according to anyone of claims 25 to 29, wherein said substrate detection unit detects an availability of said substrate in each shelf of said container.

31. An exposure apparatus comprising:
a substrate stage on which a substrate subject to exposure is mounted;
a substrate carriage system which carries said substrate in respect to said substrate stage;
a container mount on which a container housing said substrate is placed, said container being an open/close type container with an opening formed only in front and including a cover to open/close said opening; and
an open/close mechanism which opens/closes said cover of said opening, said open/close mechanism being arranged in a chamber where at least a part of said carriage system is housed.

32. An exposure apparatus according to claim 31, wherein a space to arrange said container which is to be mounted on said container mount, and a space where a mask on which a pattern to be transferred onto a substrate is formed is installed and housed, are arranged at almost a same height.

33. An exposure apparatus according to claim 32, wherein said space to arrange said container and said space where said mask is installed and housed are respectively arranged in an independent chamber.

34. An exposure apparatus according to claim 33, wherein said container is arranged on only one side of a container arranging space provided respectively on a left side and a right side within said chamber, and an operation unit arranged on a remaining side of said container arranging space.

35. An exposure apparatus according to claim 31, wherein said exposure apparatus further comprises a rotation unit that rotatably drives said container mount.

36. An exposure apparatus according to claim 31, wherein said exposure apparatus further comprises a driving mechanism that drives said container mount in a direction almost perpendicular to a surface where said container is placed.

37. An exposure apparatus according to claim 36, wherein said exposure apparatus further comprises a control unit which opens said cover of said container by said open/close mechanism after said container mount is moved by said driving mechanism, said container mount being moved after said container is placed on said container mount.

38. An exposure apparatus according to claim 36, wherein said exposure apparatus further comprises a control unit which moves said container mount to an unloading position of said container by said driving mechanism after said open/close mechanism closes said cover of said container.

39. An exposure apparatus according to claim 31, wherein a connecting portion between said substrate carriage system and said container where said open/close mechanism performs open/close operation of said cover is arranged in said chamber at a position lower than a delivery position of said container placed on said container mount.

40. An exposure apparatus according to claim 31, wherein said exposure apparatus further comprises a substrate detection unit which detects said substrate housed in said container when said open/close mechanism performs at least one of an opening operation and a closing operation.

41. An exposure apparatus according to claim 40, wherein said substrate detection unit is attached to said open/close mechanism.

42. An exposure apparatus according to claim 40, wherein
said substrate carriage system comprises a carriage unit which loads and unloads said substrate between said container, and
said substrate detection unit is arranged on said carriage unit.

43. An exposure apparatus according to claim 31, wherein said exposure apparatus further comprises a driving mechanism which moves said container mount on a surface almost parallel with a surface where said container is placed to connect a connection portion of said container and said container to said substrate carriage system arranged in said chamber.

44. An exposure apparatus comprising:
a substrate stage on which a substrate subject to exposure is mounted;
a substrate carriage system which carries said substrate in respect to said substrate stage;
a chamber which houses at least a part of said substrate carriage system; wherein
said chamber includes at least one of a side surface and an adjacent side surface where an opening is formed through which said substrate is delivered, and
said substrate carriage system includes a carriage unit which is capable of using any of said side surface and said adjacent side surface where said opening is formed in said chamber.

45. An exposure apparatus comprising:
a substrate stage on which a substrate subject to exposure is mounted;
a container mount on which a container housing said substrate is placed, said container being an open/close type container with an opening formed in front and a door to open/close said opening;
a substrate carriage system which carries said substrate housed in said container in respect to said substrate stage; and
said substrate carriage system includes an open/close unit which performs open/close operation of said door and a carriage arm which performs loading/unloading of said substrate to said container, wherein
said carriage arm is arranged on said open/close unit.

46. An exposure apparatus according to claim 45, wherein said open close unit includes an open/close member which opens/closes said door and a driving mechanism which drives said open/close member and said carriage arm, said open close member being driven by said driving mechanism.

47. An exposure apparatus according to claim 46, wherein said driving mechanism integrally drives said open/close member and said carriage arm.

48. An exposure apparatus according to claim 46, wherein said container is a container that houses a plurality of said substrates by a predetermined interval.

49. An exposure apparatus according to claim 48, wherein said driving mechanism drives said open/close member in any one of a direction moving toward and moving away from said container mount and in a direction said substrates arranged in said container.

50. An exposure apparatus according toclaim 48, wherein
said container is a container that houses a plurality of said substrates by a predetermined interval in a vertical direction, and
said driving mechanism drives said open/close member and said carriage arm in a vertical direction.

51. An exposure apparatus according to any one of claims 45 to 50, wherein said open/close unit further comprises a substrate detection unit that detects said substrates in said container.

52. A substrate carriage method which loads and unloads a desirable substrate with a carriage arm between an open/close type container housing a substrate in which an opening is formed, said open/close type container comprising a door to open/close said opening, wherein at least a part of an open/close operation of said door and a load/unload operation of said desirable substrate by said carriage arm is performed in parallel in said substrate carriage method.

53. A substrate carriage method according to claim 52, wherein a plurality of said substrates are housed in said container by a predetermined interval, and said load/unload operation of said desirable substrate is performed in a state where said door is opened to at least a position corresponding to said load/unload operation of said desirable substrate.

54. A substrate carriage method according to claim 52, wherein a plurality of said substrates are housed in said container by a predetermined interval in a vertical direction, and said open/close operation of said door is performed by moving said door in a vertical direction.

55. A substrate carriage method according to claim 54, wherein said carriage arm is moved in a horizontal direction at a state where said door is opened to at least a position corresponding to said load/unload operation, when said load/unload operation of said desirable substrate is performed.

56. A method of making an exposure apparatus used in a lithographic process comprising steps of:
providing a substrate stage on which a substrate subject to exposure is mounted; and
providing a substrate carriage system which includes a rotation table rotatably holding said substrate and moves in a predetermined direction, said substrate carriage system carrying said substrate in respect to said substrate stage.

57. A method of making an exposure apparatus according to claim 56, wherein said method of making an exposure apparatus further comprises a step of providing a positional deviation detection unit which detects a positional deviation of said substrate rotating on said rotation table when moving in said predetermined direction.

58. A method of making an exposure apparatus used in a lithographic process comprising steps of:
providing a substrate stage on which a substrate subject to exposure is mounted;
providing a substrate carriage system which carries said substrate in respect to said substrate stage;
providing a container mount on which a container housing a plurality of said substrate by a predetermined interval in a vertical direction is placed; and
providing a driving unit which drives said container mount downward from a first position to a second position prior to starting an exposure process on said substrate housed in said container.

59. A method of making an exposure apparatus according to claim 58, wherein said method of making an exposure apparatus further comprises a step of providing a carriage arm which moves in a vertical direction in respect to said container mount so as to make access to said substrate housed in said container after said container mount is lowered to said second position.

60. A method of making an exposure apparatus according to claim 58, wherein said method of making an exposure apparatus further comprises a step of providing a substrate detection unit that detects said substrate housed within said container when said container is being lowered.

61. A device manufacturing method including a lithographic process, wherein exposure is performed by using said exposure apparatus according to any one of claims 1, 8, 14, 22, 25, 31, 44, and 45 in said lithographic process.

62. A device manufactured by using said device manufacturing method in claim 61.
